(19) United States
(12) Patent Application Publication
(10) Pub. No.: US 2025/0263333 A1
(43) Pub. Date: Aug. 21, 2025

(54) SUBSTRATE, NATIVELY COLORED GLASS HOUSING, AND METHODS OF CHEMICALLY STRENGTHENING THE SAME

(71) Applicant: CORNING INCORPORATED, CORNING, NY (US)

(72) Inventors: Xiaoju Guo, Pittsford, NY (US); Yuhui Jin, Painted Post, NY (US); Wei Sun, Painted Post, NY (US); Ljerka Ukrainczyk, Ithaca, NY (US); Xue Wang, Painted Post, NY (US)

(21) Appl. No.: 19/057,260

(22) Filed: Feb. 19, 2025

Related U.S. Application Data
(63) Continuation of application No. PCT/US2025/016197, filed on Feb. 17, 2025.
(60) Provisional application No. 63/555,949, filed on Feb. 21, 2024.

(51) Int. Cl. C03C 21/00

(52) U.S. Cl. CPC C03C 21/002

(57) ABSTRACT

Methods of chemically strengthening a substrate includes contacting a surface of the substrate with a molten salt solution maintained at a temperature from 350° C. to 530° C. for from 10 minutes to 8 hours. The molten salt solution includes one or more of from greater than 0.5 wt % to 10 wt % of a nitrite salt, from 2.0 wt % to 10 wt % of a sulfate salt, from 1.0 wt % to 8.0 wt % of a salt of an alkaline earth metal, or combinations thereof. The substrate has a copper concentration of about 0.01 wt % or more of 100 wt % of the substrate. The substrate has a compressive stress region with a maximum compressive stress of 400 MegaPascals or more. The surface of the substrate can be substantially free of a copper containing salt. In aspects, a reflectance haze of the surface can be 2% or less.

This application claims priority to International Patent Application No. PCT/US2025/016197 filed on Feb. 17, 2025, which claims priority to U.S. Provisional Application No. 63/555,949 filed on Feb. 21, 2024, the contents of each of which are relied upon and incorporated herein by reference in their entireties.

### FIELD

The present disclosure relates generally to substrates, natively colored glass housings, and methods of chemically strengthening the same and, more particularly, to substrates including copper, natively colored glass housings including the same, and methods of chemically strengthening the same.

### BACKGROUND

Glass-based substrates are commonly used, for example, in display devices, e.g., liquid crystal displays (LCDs), electrophoretic displays (EPD), organic light-emitting diode displays (OLEDs), plasma display panels (PDPs), or the like.

There is a desire to use colored glass articles and natively colored glass housings for use in consumer electronic devices, for example, to be mounted on displays. Displays and covers should have good impact and puncture resistance. Consequently, there is a need to develop colored glass articles and natively colored glass housings for use in consumer electronic devices that have low minimum bend radii, good impact resistance, and good puncture resistance.

### SUMMARY

There are set forth herein glass articles and natively colored glass housings including the same that contain copper (e.g., greater than 0.01 wt %, from 0.3 wt % to 5.0 wt %, or from 0.06 wt % to 3.0 wt %) that can be chemically strengthened with low reflectance haze (e.g., 2.0 wt % or less) and/or without copper-containing deposits on the surface. Producing glass articles and natively colored glass housings without copper-containing deposits on the surface and/or low reflectance haze can be more aesthetically pleasing to a user of a consumer electronic device (than hazy articles or articles with copper-containing deposits).

The glass-based material of the glass article can provide good dimensional stability, good impact resistance, good crack resistance, good puncture resistance, and/or good flexural strength. The glass article can include a compressive stress region (e.g., be chemically strengthened), which can provide improved crack resistance, puncture resistance, impact resistance, and/or improved flexural strength. Minimizing the combination of R₂O, CaO, MgO, and ZnO in the glass composition may provide the resultant colored glass article with a desirable dielectric constant, for example when the colored glass article is used as a portion of a housing for an electronic device. Providing a dielectric constant for frequencies from 10 GHz to 60 GHz from 5.6 to 6.4 can allow wireless communication through the glass article. Providing a glass article comprising a glass-based material and/or a ceramic-based material can have good dimensional stability, reduced incidence of mechanical instabilities, and/or good impact and puncture resistance.

Methods of the present disclosure comprise chemically strengthening the copper-containing glass article with a molten salt solution including a nitrite salt and/or a sulfate salt (that can be used in combination with nitrate salts and/or other alkali metal salts). Providing a molten salt solution with a concentration of the nitrite salt, based on a total weight of the molten salt solution, can be in a range from 0.5 wt % to 10 wt %, from 1.0 wt % to 5 wt %, or from 2.0 wt % to 5 wt % can achieve a glass article (containing copper) that has a surface substantially free of copper-containing salt in accordance with the methods of the presence disclosure. The results shown in FIG. 12 demonstrate that providing greater than 2.0 wt % (e.g., from greater than 2.0 wt % to 10 wt %, from 2.5 wt % to 8 wt %, or from 3.0 wt % to 5.0 wt %) of the sulfate salt reduces the amount of copper-containing salt on the surface (and/or the area of the surface covered by the copper-containing salt) at the end of chemical strengthening the glass article with the molten salt solution. The results shown in FIG. 13 demonstrate that providing greater than 2.0 wt % (e.g., from greater than 2.0 wt % to 10 wt %, from 2.5 wt % to 8 wt %, or from 3.0 wt % to 5.0 wt %) of the sulfate salt can produce glass articles that are substantially free and/or free of copper-containing salt on the surface (and/or substantially none of the surface covered by the copper-containing salt) after rinsing following the chemical strengthening of the glass article with the molten salt solution.

Without wishing to be bound by theory, it is believed that copper ions in the glass article can predominately be in the 2+ oxidation state, and that the copper ions are reduced to the 1+ oxidation state before diffusing out of the glass article since ions with a 1+ oxidation state have greater mobility than ions with a 2+ oxidation state in the glass article. Providing the nitrite salt can preserve the copper ions (outside of the glass article) in the 1+ oxidation state at a surface of the glass article and/or in the molten salt solution. In aspects, during contact with the molten salt solution, a copper-containing salt can be formed at the surface of the glass article, where the copper-containing salt has copper in a 1+ oxidation state. At the first major surface of the glass article, the copper ion in the 1+ oxidation state can be oxidized by nitrate ions in the molten salt solution to form a CuO precipitate. It is believed that this reaction is largely irreversible in the molten salt solution, and CuO is insoluble in water, which makes it hard to remove CuO precipitates in a subsequent rinsing step. Alternatively, when the molten salt solution comprises a nitrite salt (e.g., producing nitrite ions), a complex of copper oxide(s) (e.g., Cu(I)₂O and/or Cu(II)O) and/or copper nitrate (e.g., Cu(I)NO₃) can be formed between the copper and the nitrite ions and optionally nitrate ions; and it is believed that the complex is more readily dissolved in a rinsing step than CuO such that the amount of copper-containing salt on the glass article can be reduced and/or removed (e.g., eliminated) after a rinsing step. Similarly, the presence of the nitrite salt (e.g., producing nitrite ions) can form other copper-containing salts that preserve the copper ion in the 1+ oxidation state, for example, nitrite in combination with another anion (e.g., phosphate) can form copper phosphate with copper in the 1+ oxidation state (Cu(I)₃PO₄) that is more readily dissolved in water than CuO or copper phosphate with copper in the 2+ oxidation state (Cu(II)₃(PO₄)₂) such that the copper-containing salt in the 1+ oxidation state (e.g., Cu(I)₃PO₄) can be removed in a subsequent rinsing step Consequently, providing the nitrite salt in the molten salt solution can facilitate the production of glass articles with reduced and/or no copper-containing salt on the surface and/or low haze.

Providing a molten salt solution with a concentration of the sulfate salt, based on a total weight of the molten salt solution, can be in a range from 2.0 wt % to 10 wt %, from 2.5 wt % to 8 wt %, or from 3.0 wt % to 5 wt % can achieve a glass article (containing copper) that has a surface substantially free of copper-containing salt in accordance with the methods of the presence disclosure. The results shown in FIG. 14 demonstrate that providing 0.5 wt % or more (e.g., from greater than 0.5 wt % to 10 wt %, from 1.0 wt % to 5 wt %, or from 2.0 wt % to 5.0 wt %) of the nitrite salt reduces the amount of copper-containing salt on the surface (and/or the area of the surface covered by the copper-containing salt) at the end of chemical strengthening the glass article with the molten salt solution. The results shown in FIG. 15 demonstrate that providing greater than 0.5 wt % (e.g., from greater than 0.5 wt % to 10 wt %, from 1.0 wt % to 5.0 wt %, or 2.0 wt % to 5.0 wt %) of the nitrite salt can produce glass articles that are substantially free and/or free of copper-containing salt on the surface (and/or substantially none of the surface covered by the copper-containing salt) after rinsing following the chemical strengthening of the glass article with the molten salt solution.

Providing the sulfate salt can form copper sulfate that is more easily dissolved in the molten salt solution and/or subsequent rinsing. In aspects, as discussed above, during contact with the molten salt solution, a copper-containing salt can be formed at the surface of the glass article. As discussed above, copper ions in the 2+ oxidation state in the glass article can be reduced to the to the 1+ oxidation state followed by diffusion (e.g., ion exchange) of the copper ion in the 1+ oxidation state out of the glass article towards the molten salt solution while an alkali metal ion (e.g., sodium, potassium) diffuses into the glass article. At the first major surface of the glass article, the copper ion in the 1+ oxidation state can be oxidized by nitrate ions in the molten salt solution to form a CuO precipitate. It is believed that this reaction is largely irreversible in the molten salt solution, and CuO is insoluble in water, which makes it hard to remove CuO precipitates in a subsequent rinsing step. Alternatively, when the molten salt solution comprises a sulfate salt (e.g., producing sulfate ions), copper sulfate (CuSO₄) can be formed between the copper and sulfate ions. It is believed that copper sulfate is more readily dissolved in the molten salt solution and in a subsequent rinsing step than CuO such that the amount of copper-containing salt on the glass article can be reduced and/or removed (e.g., eliminated) after the chemical strengthening and/or after a subsequent rinsing step. Consequently, providing the sulfate salt in the molten salt solution can facilitate the production of glass articles with reduced and/or no copper-containing salt on the surface and/or low haze.

In aspects, subsequent rinsing of the chemically strengthened glass article can remove copper-containing salts formed in the chemical strengthening of the glass article when the molten salt solution comprises a nitrite salt and/or a sulfate salt. In further aspects, the first major surface of the glass article can be substantially free of the copper-containing salt after the rinsing (or even after the chemical strengthening in some aspects). Also, as discussed above, the reflectance haze of the first major surface (after the rinsing or even after the chemically strengthening in some aspects) can be within any of the corresponding ranges discussed above (e.g., 2% or less, from 0.01% to 2%, from 0.05% to 2%, from 0.1% to 1%, from 0.1% to 0.8%, from 0.2% to 0.5%, or any range or subrange therebetween). In further aspects, the rinsing can remove copper-containing salts with copper in the 1+ oxidation state and/or other salts (e.g., copper sulfate). For example, the copper oxide (CuO) with copper in the 2+ oxidation state (e.g., formed in the absence of a nitrite salt and/or a sulfate salt) is not dissolved or otherwise removed by the rinsing. Likewise, copper phosphate with copper in the 2+ oxidation state (e.g., Cu(II)₃(PO₄)₂) is not readily removed by rinsing. However, the complex including copper ions in the 1+ oxidation state (e.g., formed in the presence of a nitrite salt in the molten salt solution) can be dissolved and/or otherwise removed by the rinsing. Similarly, copper sulfate (e.g., CuSO₄) (e.g., formed in the presence of a sulfate salt) can be dissolved and/or otherwise removed by the rinsing.

Methods of the present disclosure can comprise chemically strengthening the copper-containing glass article with a molten salt solution including a salt of an alkaline earth metal (in addition to salts of alkali earth metals), which can reduce formation of copper-containing residue on the surface of the copper-containing glass article. Without wishing to be bound by theory, it is believed that the alkaline earth metal can be exchanged into a near-surface portion of the copper-containing glass article, where the alkaline earth metal can inhibit diffusion of copper therethrough. As demonstrated in the examples herein, an amount of the salt of the alkaline earth metal from 1.0 wt % to 8.0 wt % (e.g., from 2.0 wt % to 4.0 wt %) can significantly reduce or entirely eliminate the formation of copper-containing residues on the surface of the glass article that can be detected with the naked eye.

Some example aspects of the disclosure are described below with the understanding that any of the features of the various aspects may be used alone or in combination with one another.

Aspect 1. A method of chemically strengthening a substrate comprising: contacting a surface of the substrate with a molten salt solution maintained at a temperature from about 350° C. to about 530° C. for a first period of time from about 10 minutes to about 8 hours, the molten salt solution comprises, based on a total weight of the molten salt solution, one or more of: from greater than 0.5 wt % to 10 wt % of a nitrite salt; from 2.0 wt % to 10 wt % of a sulfate salt; or combinations thereof, wherein the substrate comprises a glass-based material or a ceramic-based material, and the substrate comprises a copper concentration of about 0.01 wt % or more of 100 wt % of the substrate.

Aspect 2. The method of aspect 1, wherein the molten salt solution comprises from greater than 0.5 wt % to 10 wt % of the sulfate salt.

Aspect 3. A method of chemically strengthening a substrate comprising: contacting a surface of the substrate with a molten salt solution maintained at a temperature from about 350° C. to about 530° C. for a first period of time from about 10 minutes to about 8 hours, the molten salt solution comprises, based on a total weight of the molten salt solution, from greater than 0.5 wt % to 10 wt % of a nitrite salt, wherein the substrate comprises a glass-based material or a ceramic-based material, and the substrate comprises a copper concentration of about 0.01 wt % or more of 100 wt % of the substrate.

Aspect 4. The method of any one of aspects 1-3, wherein the nitrite salt comprises an alkali metal nitrite.

Aspect 5. The method of aspect 4, wherein the nitrite salt comprises sodium nitrite.

Aspect 6. The method of any one of aspects 1-3, wherein the nitrite salt comprises an alkaline earth metal nitrite.

Aspect 7. The method of aspect 6, wherein the nitrate salt comprises calcium nitrite.

Aspect 8. The method of any one of aspects 1-7, wherein a concentration of the nitrite salt in the molten salt solution is from 1.0 wt % to 5 wt %.

Aspect 9. The method of aspect 8, wherein the concentration of the nitrite salt in the molten salt solution is from 2.0 wt % to 5 wt %.

Aspect 10. The method of any one of aspects 2-9, wherein the contacting the surface of the substrate with the molten salt solution produces a copper-containing salt at the surface of the substrate, and the copper-containing salt has copper in a 1+ oxidation state.

Aspect 11. The method of aspect 1, wherein the molten salt solution comprises from 2.0 wt % to 10 wt % of the sulfate salt.

Aspect 12. A method of chemically strengthening a substrate comprising: contacting a surface of the substrate with a molten salt solution maintained at a temperature from about 350° C. to about 530° C. for a first period of time from about 10 minutes to about 8 hours, the molten salt solution comprises, based on a total weight of the molten salt solution, from 2.0 wt % to 10 wt % of a sulfate salt, wherein the substrate comprises a glass-based material or a ceramic-based material, and the substrate comprises a copper concentration of about 0.01 wt % or more of 100 wt % of the substrate.

Aspect 13. The method of any one of aspects 11-12, wherein the sulfate salt comprises an alkali metal sulfate.

Aspect 14. The method of aspect 13, wherein the sulfate salt comprises sodium sulfate.

Aspect 15. The method of any one of aspects 11-14, wherein a concentration of the sulfate salt in the molten salt solution is from 2.5 wt % to 8 wt %.

Aspect 16. The method of aspect 15, wherein the concentration of the sulfate salt in the molten salt solution is from 3.0 wt % to 5 wt %.

Aspect 17. The method of any one of aspects 11-16, wherein the contacting the surface of the substrate with the molten salt solution produces copper sulfate at the surface of the substrate.

Aspect 18. The method of any one of aspects 1-17, wherein, after contacting the surface of the substrate with the molten salt solution, the substrate comprises a compressive stress region extending from the surface to a depth of compression, a maximum compressive stress of the compressive stress region is 400 MegaPascals or more.

Aspect 19. The method of any one of aspects 1-18, wherein the molten salt solution comprises: from 85 wt % to about 92 wt % of a potassium salt; from 8 wt % to about 15 wt % of a sodium salt; and from 0 wt % to about 1 wt % silicic acid, wherein at least a portion of the potassium salt or the sodium salt comprises the nitrite salt or the sulfate salt.

Aspect 20. The method of any one of aspects 10 or 17, further comprising rinsing the substrate, wherein the rinsing removes copper sulfate or copper salt with copper in a 1+ oxidation state from the surface of the substrate.

Aspect 21. The method of any one of aspects 1-19, further comprising rinsing the substrate, wherein the rinsing removes a copper-containing salt at the surface of the substrate formed during the contacting the surface of the substrate with the molten salt solution.

Aspect 22. The method of any one of aspects 20-21, wherein the rinsing comprises contacting the substrate with water or an alkaline detergent solution.

Aspect 23. The method of any one of aspects 20-21, wherein the rinsing comprises the contacting the substrate with an aqueous solution comprising a temperature from 20° C. to 40° C. for a period of time from 5 minutes to 1 hour.

Aspect 24. The method of any one of aspects 18-23, wherein, after the rinsing, the surface of the substrate is substantially free of copper-containing salt.

Aspect 25. The method of any one of aspects 1-24, wherein, after the contacting the surface of the substrate with the molten salt solution, a majority of the surface is free of copper-containing salt.

Aspect 26. The method of any one of aspects 18-25, wherein, after the rinsing, a reflectance haze of the surface of the substrate is 2% or less.

Aspect 27. The method of any one of aspects 1-25, wherein, after the contacting the surface of the substrate with the molten salt solution, a reflectance haze of the surface of the substrate is 2% or less.

Aspect 28. The method of any one of aspects 1-27, wherein the substrate exhibits a CIE L* value of about 50 or more, an absolute value of a CIE a* value of the substrate is about 0.1 or more, and an absolute of the CIE b* value of the substrate is about 0.1 or more.

Aspect 29. The method of aspect 28, wherein the CIE a* value is from about −15 to −1.

Aspect 30. The method of any one of aspects 28-29, wherein the CIE b* value is from about 1.5 to about 5.

Aspect 31. The method of any one of aspects 28-30, wherein the CIE L* value is from about 80 to 96.

Aspect 32. The method of any one of aspects 1-31, wherein the copper concentration in the substrate is from 0.03 wt % to 5.0 wt %.

Aspect 33. The method of aspect 32, wherein the copper concentration in the substrate is from 0.06 wt % to 3.0 wt %.

Aspect 34. The method of any one of aspects 1-33, wherein the substrate comprises a thickness from 10 micrometers to 5 millimeters.

Aspect 35. The method of aspect 34, wherein the thickness is from 400 micrometers to 3 millimeters.

Aspect 36. The method of any one of aspects 1-35, wherein the substrate comprises a dielectric constant at frequencies from 10 GigaHertz to 60 GigaHertz of from about 5.6 to about 6.4.

Aspect 37. The method of any one of aspects 1-36, wherein the substrate exhibits a fracture toughness of 0.60 MPa-m^{1/2} or more, and a Young's modulus from about 50 GigaPascals to about 100 GigaPascals.

Aspect 38. A natively colored glass housing for an electronic device comprising: the substrate produced by the method of any one of aspects 31-37; circuitry comprising an antenna that transmits signals within a range of 26 GHz to 300 GHz; the substrate at least partially surrounding the circuitry; and a structure formed as an integral portion of the substrate, wherein the structure comprises a perimeter demarcating a second thickness of the structure that differs from the thickness of the substrate by at least 150 μm, wherein the antenna is positioned and oriented such that the signals are transmitted through the structure of the substrate.

Aspect 39. A method of chemically strengthening a substrate comprising: contacting a surface of the substrate with a molten salt solution maintained at a temperature from 350° C. to 530° C. for a first period of time from 10 minutes to 8 hours, the molten salt solution comprises, based on a total weight of the molten salt solution, 1.0 wt % to 8.0 wt % of an alkaline earth metal salt, wherein the substrate comprises a glass-based material or a ceramic-based material, and the substrate comprises a copper concentration of about 0.01 wt % or more of 100 wt % of the substrate.

Aspect 40. The method of aspect 39, wherein the amount of the alkaline earth metal salt is from 2.0 wt % to 4.0 wt %.

Aspect 41. The method of any one of aspects 39-40, wherein the alkaline earth metal salt is or comprises a calcium salt.

Aspect 42. The method of aspect 41, wherein the calcium salt is or comprises anhydrous calcium nitrate.

Aspect 43. The method of any one of aspects 39-42, wherein the amount of the alkaline earth metal salt is from 4.0 wt % to 6.0 wt %.

Aspect 44. The method of any one of aspects 39-43 wherein the alkaline earth metal salt is or comprises a magnesium salt.

Aspect 45. The method of any one of aspects 39-44, wherein, after contacting the surface of the substrate with the molten salt solution, the substrate comprises a compressive stress region extending from the surface to a depth of compression, a maximum compressive stress of the compressive stress region is 400 MegaPascals or more.

Aspect 46. The method of any one of aspects 38-45, wherein the molten salt solution comprises: from 85 wt % to 92 wt % of a potassium salt; from 8 wt % to 14 wt % of a sodium salt; and from 0 wt % to 1 wt % silicic acid, wherein at least a portion of the potassium salt or the sodium salt comprises the nitrite salt or the sulfate salt.

Aspect 47. The method of any one of aspects 39-46, wherein, after the contacting, a majority of the surface is free of copper-containing salt.

Aspect 48. The method of any one of aspects 39-46, wherein, after the contacting, the surface of the substrate is substantially free of copper-containing salt.

Aspect 49. The method of any one of aspects 39-48, wherein, after the contacting, a reflectance haze of the surface of the substrate is 2% or less.

Aspect 50. The method of any one of aspects 39-49, wherein, after the, a reflectance haze of the surface of the substrate is 2% or less.

Aspect 51. The method of any one of aspects 39-50, wherein the substrate exhibits a CIE L* value of 50 or more, an absolute value of a CIE a* value of the substrate is 0.1 or more, and an absolute of the CIE b* value of the substrate is 0.1 or more.

Aspect 52. The method of any one of aspects 39-51, wherein the copper concentration in the substrate is from 0.03 wt % to 5.0 wt %.

Aspect 53. The method of aspect 52, wherein the copper concentration in the substrate is from 0.06 wt % to 3.0 wt %.

Aspect 54. The method of any one of aspects 39-53, wherein the substrate comprises a thickness from 10 micrometers to 5 millimeters.

Aspect 55. The method of aspect 54, wherein the thickness is from 400 micrometers to 3 millimeters.

Aspect 56. The method of any one of aspects 39-55, wherein the substrate comprises a dielectric constant at frequencies from 10 GigaHertz to 60 GigaHertz of from 5.6 to 6.4.

Aspect 57. The method of any one of aspects 39-56, wherein the substrate exhibits a fracture toughness of 0.60 MPa-m^{1/2} or more, and a Young's modulus from 50 GigaPascals to 100 GigaPascals.

Aspect 58. A natively colored glass housing for an electronic device comprising: the substrate produced by the method of any one of aspects 1-37 or 39-57 inclusive; circuitry comprising an antenna that transmits signals within a range of 26 GHz to 300 GHz; the substrate at least partially surrounding the circuitry; and a structure formed as an integral portion of the substrate, wherein the structure comprises a perimeter demarcating a second thickness of the structure that differs from the thickness of the substrate by at least 150 μm, wherein the antenna is positioned and oriented such that the signals are transmitted through the structure of the glass sheet of the panel of the housing.

Aspect 59. A natively colored glass housing for a consumer electronic device, the housing comprising: the substrate produced by the method of any one of aspects 1-37 or 39-57 inclusive; and a reflector layer disposed on the substrate, the reflector layer is opaque and has a CIE L* value >70, wherein a total transmittance of at least one 10 nm band within the wavelength range of 380 nm to 750 nm through the first thickness is from 3% to 80%.

Aspect 60. A consumer electronic product, comprising: a housing comprising a front surface, a back surface, and a side surface; electrical components at least partially within the housing, the electrical components comprising a controller, a memory, and a display, the display at or adjacent the front surface of the housing; and a cover substrate disposed over the display, wherein at least one of a portion of the housing comprises the substrate produced by the method of any one of aspects 1-37 or 39-57.

Aspect 61. A substrate comprising: a thickness defined between a first major surface and a second major surface opposite the first major surface, the substrate comprises a glass-based material or a ceramic-based material, and the substrate comprises a copper concentration of about 0.01 wt % or more of 100 wt % of the substrate; and a compressive stress region extending from the surface to a depth of compression, a maximum compressive stress of the compressive stress region is 400 MegaPascals or more, wherein the first major surface of the substrate is substantially free of copper-containing salt.

Aspect 62. A substrate comprising: a thickness defined between a first major surface and a second major surface opposite the first major surface, the substrate comprises a glass-based material or a ceramic-based material, and the substrate comprises a copper concentration of about 0.01 wt % or more of 100 wt % of the substrate; and a compressive stress region extending from the surface to a depth of compression, a maximum compressive stress of the compressive stress region is 400 MegaPascals or more, wherein the first major surface of the substrate exhibits a reflectance haze of 2% or less.

Aspect 63. The substrate of any one of aspects 61-62, wherein the substrate exhibits a CIE L* value of about 50 or more, an absolute value of a CIE a* value of the substrate is about 0.1 or more, and an absolute of the CIE b* value of the substrate is about 0.1 or more.

Aspect 64. The substrate of aspect 63, wherein the CIE a* value is from about −15 to −1.

Aspect 65. The substrate of any one of aspects 63-64, wherein the CIE b* value is from about 1.5 to about 5.

Aspect 66. The substrate of any one of aspects 63-65, wherein the CIE L* value is from about 80 to 96.

Aspect 67. The substrate of any one of aspects 61-66, wherein the copper concentration in the substrate is from 0.03 wt % to 5.0 wt %.

Aspect 68. The substrate of aspect 67, wherein the copper concentration in the substrate is from 0.06 wt % to 3.0 wt %.

Aspect 69. The substrate of any one of aspects 61-68, wherein the substrate thickness is from 10 micrometers to 5 millimeters.

Aspect 70. The substrate of aspect 69, wherein the substrate thickness is from 400 micrometers to 3 millimeters.

Aspect 71. The substrate of any one of aspects 61-70, wherein the substrate comprises a dielectric constant at frequencies from 10 GigaHertz to 60 GigaHertz of from about 5.6 to about 6.4.

Aspect 72. The substrate of any one of aspects 61-71, wherein the substrate exhibits a fracture toughness of 0.60 MPa-m^{1/2} or more, and a Young's modulus from about 50 GigaPascals to about 100 GigaPascals.

Aspect 73. A natively colored glass housing for an electronic device comprising: the substrate of any one of aspects 69-70; circuitry comprising an antenna that transmits signals within a range of 26 GHz to 300 GHz; the substrate at least partially surrounding the circuitry; and a structure formed as an integral portion of the substrate, wherein the structure comprises a perimeter demarcating a second thickness of the structure that differs from the thickness of the substrate by at least 150 μm, wherein the antenna is positioned and oriented such that the signals are transmitted through the structure of the substrate.

Aspect 74. A natively colored glass housing for a consumer electronic device, the housing comprising: the substrate of any one of aspects 69-70; and a reflector layer disposed on the substrate, the reflector layer is opaque and has a CIE L* value >70, wherein a total transmittance of at least one 10 nm band within the wavelength range of 380 nm to 750 nm through the first thickness is from 3% to 80%.

Aspect 75. A consumer electronic product, comprising: a housing comprising a front surface, a back surface, and a side surface; electrical components at least partially within the housing, the electrical components comprising a controller, a memory, and a display, the display at or adjacent the front surface of the housing; and a cover substrate disposed over the display, wherein at least one of a portion of the housing comprises the substrate of any one of aspects 61-72.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic plan view of an example consumer electronic device according to aspects;

FIG. 2 is a schematic perspective view of the example consumer electronic device of FIG. 1;

FIG. 3 is a schematic back view of the example consumer electronic device of FIG. 1;

FIG. 4 is a simplified conceptual view of the device of FIG. 3 in a slightly exploded cross-section taken along line 4-4 of FIG. 3;

FIG. 4A shows an enlarged view 4A of FIG. 4;

FIG. 4B shows an enlarged view 4B of FIG. 4;

FIG. 5 is a cross-sectional view of a natively colored glass housing including a glass article in accordance with aspects of the disclosure;

FIG. 6 is a flow chart illustrating example methods of chemically strengthening a substrate in accordance with aspects of the disclosure;

FIG. 7 schematically illustrates a step in a method of chemically strengthening a substrate comprising contacting a surface of the substrate with a molten salt solution;

FIG. 8 shows an enlarged view 8 of FIG. 7;

FIG. 9 schematically illustrates a step in methods comprising rinsing the substrate;

FIG. 10 schematically illustrates chemical reactions that can occur between the substrate and the molten salt solution;

FIG. 11 schematically illustrates the options for copper-containing deposits during the rinsing;

FIG. 12 schematically shows surfaces of glass-based substrates after being contacted with a molten salt solution containing different amounts of sodium sulfate in a step in a method of chemically strengthening a substrate;

FIG. 13 schematically shows surfaces of glass-based substrates from FIG. 12 after being rinsed with water in a step in a method of chemically strengthening a substrate;

FIG. 14 schematically shows surfaces of glass-based substrates after being contacted with a molten salt solution containing different amounts of sodium nitrite in a step in a method of chemically strengthening a substrate;

FIG. 15 schematically shows surfaces of glass-based substrates from FIG. 14 after being rinsed with water in a step in a method of chemically strengthening a substrate;

FIG. 16 schematically shows surfaces of glass-based substrates after being contacted with a molten salt solution containing different amounts of calcium nitrate (Ca(NO₃)₂) in a step in a method of chemically strengthening a substrate;

FIG. 17 schematically shows surfaces of glass-based substrates after being contacted with a molten salt solution containing different amounts of calcium nitrate (Ca(NO₃)₂) in a step in a method of chemically strengthening a substrate;

FIG. 18 schematically illustrates a concentration profile of copper in a copper-containing substrate after being chemically strengthened;

FIG. 19 schematically illustrates a concentration profile of calcium in a copper-containing substrate after being chemically strengthened;

FIG. 20 schematically illustrates a mechanism of the alkaline earth metal in the molten salt solution on the surface of the substrate; and

FIG. 21 schematically shows surfaces of glass-based substrates after being contacted with a molten salt solution containing different amounts of magnesium nitrate (Mg(NO₃)₂) in a step in a method of chemically strengthening a substrate.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, claims may encompass many different aspects of various aspects and should not be construed as limited to the aspects set forth herein.

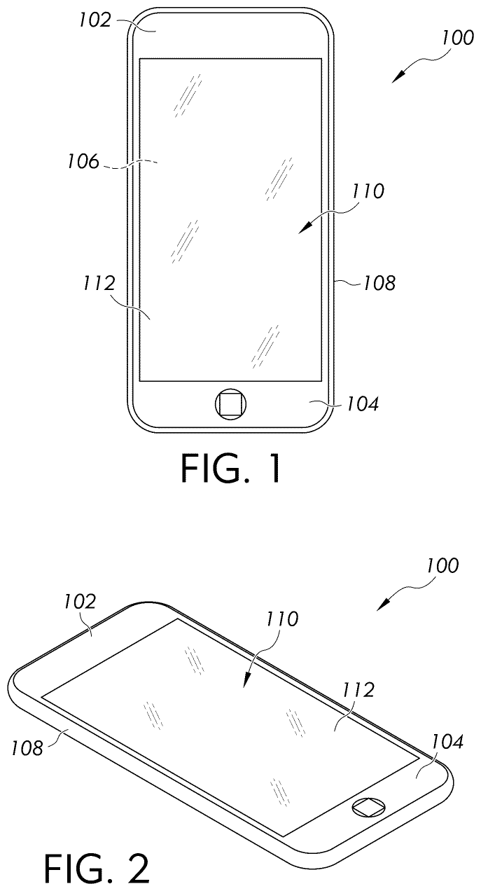

FIGS. 1-5 illustrate schematic views of a natively colored glass housing 322 and/or 500 including a glass article 511 and/or a consumer electronic device 100 and 310 (e.g., display devices), for example, those shown in FIGS. 1-4, including the same in accordance with aspects of the disclosure. Unless otherwise noted, a discussion of features of aspects of one natively colored glass housing and/or consumer electronic device can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

Aspects of the disclosure can comprise a consumer electronic product. The consumer electronic product can comprise a front surface, a back surface, and a side surface. The consumer electronic product can further comprise electrical components at least partially within the housing. The electrical components can comprise a controller, a memory, and a display. The display can be at or adjacent to the front surface of the housing. The display can comprise a liquid crystal display (LCD), an electrophoretic display (EPD), an organic light-emitting diode (OLED) display, or a plasma display panel (PDP). The consumer electronic product can comprise a cover substrate disposed over the display. In aspects, at least one of a portion of the housing or the cover substrate comprises the consumer electronic device discussed throughout the disclosure. The consumer electronic product can comprise a portable electronic device, for example, a smartphone, a tablet, a wearable device, or a laptop.

The glass articles and natively colored glass housings disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the glass articles and/or natively colored glass housings disclosed herein is shown in FIGS. 1-2. Specifically, FIGS. 1-2 show a consumer electronic device 100 including a housing 102 having front 104, back 106, and a side surface 108. Although not shown, the consumer electronic device can comprise electrical components that are at least partially inside or entirely within the housing. For example, electrical components include at least a controller, a memory, and a display. As shown in FIGS. 1-2, the display 110 can be at or adjacent to the front surface of the housing 102. The consumer electronic device can comprise a cover substrate 112 at or over the front surface of the housing 102 such that it is over the display 110. In aspects, at least a portion of the housing 102 may include the glass article and/or the natively colored glass housing disclosed herein.

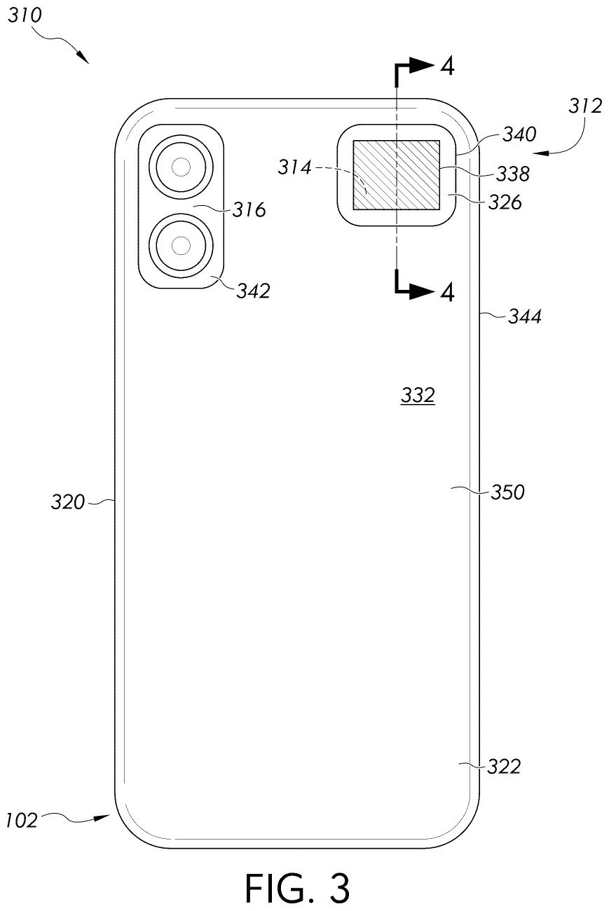

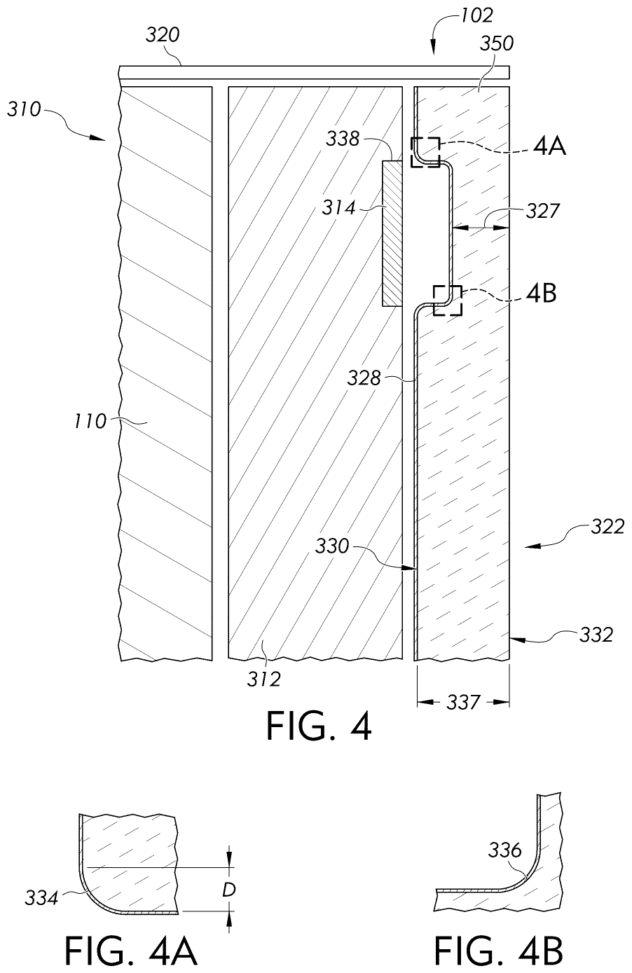

Referring to FIGS. 3-4, a consumer electronic device 310 (i.e., electronic device with wireless signal communication capability; e.g., broadband communicating device, cellular phone, smartphone, control panel, console, dashboard, tablet, handheld computer, electronic tool) includes circuitry 312 (see FIG. 4). The consumer electronic device 100 shown in FIGS. 1-2 is an example of the consumer electronic device 310. In aspects, the circuitry 312 includes an antenna 314. The circuitry 312 may further include other components, for example a camera 316 (FIG. 3), printed circuit board, processor, memory, display 110 (FIGS. 1-2), battery, connector port, and other componentry.

In aspects, the antenna 314 can comprise a patterned metal wire or layer, or other such device (e.g., transceiver, receiver, transmitter, antenna array, communication module) configured to transmit and/or receive communication signals at or over a frequency range. A surface area of the antenna is defined as an area within a perimeter 338 surrounding the antenna. In further aspects, the surface area of the antenna can be 25 cm² or less, 15 cm² or less, 10 cm² or less, 100 μm² or more, 1 mm² or more, 25 mm² or more, or 100 mm² or more. In further aspects, the antenna 314 can be configured for wireless communication (e.g., transmitting, receiving, operating, and/or otherwise communicating) with transmission of signals at a frequency of 100 MHz or more, 1 GHz or more, 10 GHz or more, 24 GHz or more, 24.25 GHz or more, GHz or more, 26 GHz or more, 28 GHz or more, 100 GHz or less, 60 GHz or less, 50 GHz or less, 47 GHz or less, or 40 GHz or less. For example, the antenna may operate in a frequency range from 26 GHz to 40 GHz or from 60 GHz to 80 GHz. Communication at a frequency greater than 26 GHz may be particularly benefited from the present disclosure because such signals may be more inhibited by transmission through solid materials, and may accordingly be improved greatly by use of a housing 102 incorporating the structure 326 described herein. As such, the antenna 314 can be positioned and/or oriented such that signals are transmitted through the structure 326 (e.g., directly facing the structure 326, the structure 326 may overlay at least a portion of the antenna 314). In further aspects, a minimum distance between the antenna 314 to a portion of the glass article defining the structure 326 can be 5 mm or less, 3 mm or less, 2 mm or less, or 0.6 mm or less. Alternatively, the antenna 314 and the portion of the glass article defining the structure 326 may be in direct contact or separated only by a thickness of the coating 328.

In aspects, as shown in FIGS. 3-4, the consumer electronic device 310 includes a housing 102 (e.g., frame 320, natively colored glass housing 322, and/or glass article 350) enclosing some or all of the circuitry 312. The housing 102 may include a frame 320, for example a metallic (e.g., aluminum, steel) sidewall, a natively colored glass housing 322 (e.g., back), and a display 110 (e.g., see FIGS. 1-2). The housing 102 may include alternative structures as well, for example a panel integral with the frame 320 forming a back with sidewalls within which circuitry 312 and other components may be located, and/or such as having the housing 102 integrated with a keyboard, touch panel, or other features in addition to or instead of the display.

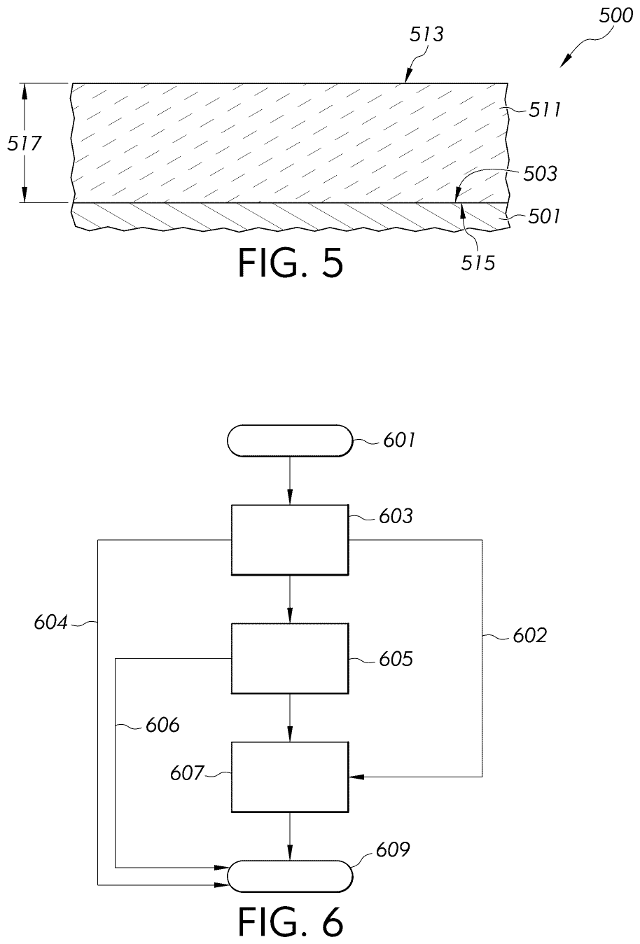

In aspects, as shown in FIGS. 3-4, the natively colored glass housing 322 may comprise (e.g., include, mostly consist of by weight or volume, be) a glass article 350. The glass article 350 may be flat, may have curved edges, may be bowed, or otherwise. As shown in FIG. 4, The natively colored glass housing 322 may include layer(s) 328, for example a scratch-resistant coating, an anti-reflective, or other coatings on a surface of the glass article 350 (e.g., first major surface 332, second major surface 330 of the glass article 350), and may further include decorative ink and/or other layers on a surface thereof as well. For example, the coating 328 on the second major surface 330 of the glass article can comprise any of the aspects and/or be the same as the reflector 501 discussed below with reference to FIG. 5. Conceivably, although not shown, the natively colored glass housing may simply consist of a sheet of glass, where layers, coatings, etc. are unneeded for the corresponding device.

In aspects, as shown in FIG. 4, the glass article 350 includes a structure 326. The structure 326 may be an integral portion of the glass article 350 such that glass of the glass article 350 continuously extends throughout the glass article 350, including defining the structure 326. For example, the structure 326 may be a recess, trench, bump, plateau, or other feature formed in or on the glass article 350. The glass article 350 may have more than one such structure 326. Such a structure may be formed in many conceivable ways, for example, by etching away a portion of the glass article 350, milling away a portion of the glass article 350, pressing the glass of the glass article 350 in a mold, welding additional glass onto the glass article 350. As such, glass forming the structure 326 may have the same composition as the glass of the glass article 350 outside of the structure 326. The glass of the structure 326 may also share a common microstructure with the glass of the glass article 350 outside of the structure 326, such as having the same types and distributions of crystals, for example if the glass is a glass-ceramic, and/or the same types and distributions of colorants. In aspects, as shown in FIG. 4, the structure 326 is formed as a recess relative to a major surface (e.g., second major surface 330) of the glass article 350. As used herein, the “major surfaces” of the glass article 350 sheet are sides of the sheet having the most surface area (e.g., front and back sides). A major surface may be surrounded by edges of a sheet that extend between the major surfaces. For a more complex body, major surfaces may be surfaces thereof have areas defined by perimeters of edges, where the major surfaces have surface areas substantially greater than other surfaces of the body (e.g., sidewalls), for example at least 50% greater.

In aspects, as shown in FIG. 4, the glass article 350 comprises a substrate thickness 337, which is defined as an average distance between the second major surface 330 and the first major surface 332 opposite the first major surface excluding any portion of the glass article 350 including the structure 326 described above. In further aspects, the substrate thickness 337 can be within one or more of the ranges discussed below for the substrate thickness 517 with reference to FIG. 5. In further aspects, the substrate thickness 337 can be substantially uniform across the second major surface 330 and/or more than 50% of the glass article can comprise a local thickness within 10% of the substrate thickness 337.

In aspects, as shown in FIGS. 3-4, the structure 326 comprises a perimeter 340 on a major surface (e.g., second major surface 330) of the glass article 350, where the perimeter 340 demarcates a second thickness 327 of the structure 326 that differs from the substrate thickness 337, for example, by 50 μm or more, by 100 μm or more, by 150 μm or more, by 200 μm or more, by 300 μm or more, by 500 μm or more (e.g., located at corner 336 as shown in FIG. 4B). For example, the second thickness 327 of the structure 326 may be 600 μm or less, 500 μm or less, or 400 μm or less, while the substrate thickness 337 of the glass article 350 may be 600 μm or more, 700 μm or more, 800 μm or more (or any of the ranges described herein for the substrate thickness 517). Alternatively, although not shown, the second thickness 327 may be greater than the substrate thickness 337 by 50 μm or more, by 100 μm or more, by 150 μm or more, by 200 μm or more, by 300 μm or more, by 500 μm or more. As shown in FIGS. 3-4, the perimeter 340 forms a closed loop on the major surface (e.g., second major surface 330), where a shape of the perimeter 340 may be rectilinear, curved, or curvilinear and can comprise any shape (e.g., square, blocky, ziggurat-shaped with rectangular rows of diminishing length overlaying one another, triangular, oval, or even more complex geometries). For example, the perimeter 340 of the structure 326 may be shaped as a silhouette of a logo and/or registered trademark or other recognizable design or shape. As used herein, a surface area of the structure is defined as the surface area within the perimeter of the structure projected onto the first major surface of the glass article. In aspects, a surface area of the structure 326 may be 100 cm² or less, 50 cm² or less, 25 cm² or less, 25 μm² or more, 100 μm² or more, 1 mm² or more, 25 mm² or more, or 4 cm² or more. In aspects, the glass article can comprise a housing of a communicating device and the glass article may have more than one such structure, as shown in FIG. 3, where the structure 326 overlays the antenna 314 while another structure 342 forms a portion of a camera or sensor encasement (e.g., camera 316). In further aspects, the structure 326 and/or 342 can overlay at least a portion and/or all of the surface area corresponding to the antenna 314 and/or the camera 316.

Forming the structure 326 and/or 342 in a middle or interior portion of the glass article 350, spaced inward from outside edges 344 of the glass article 350 (see, FIG. 3) may help mitigate structural weaknesses or stress concentrations of the glass article 350 that may be associated forming the structure 326 and/or 342. Forming edges or corners 334 and/or 336 (see FIGS. 4A-4B) or the perimeter 340 of the structure 326 with a geometry that reduces stress concentrations at the edges or corners 334 and/or 336 may also help strengthen the glass article 350 when forming the structure 326. Such a geometry may include rounding or dulling vertices or corners 334 and/or 336 of the structure 326, as may be done through etching or localized melting/heating (e.g., with a laser). For example, the glass article 350 may smoothly transition between the substrate thickness 337 and the second thickness 327 at corner 334 and/or 336 over a distance “D” (see FIG. 4A) from 5 μm to 700 μm, from 10 μm to 500 μm, from 20 μm to 500 μm, from 100 μm to 500 μm, or any range or subrange therebetween, as measured in a direction perpendicular to a direction of the substrate thickness 337.

Throughout the disclosure, CIE color coordinates are with reference to the CIELAB 1976 color space established by the International Commission on Illumination (CIE). Unless otherwise indicated, CIE color coordinates are measured in transmission through the glass article using an F02 illuminant and an observer angle of 10°. The CIELAB 1976 color space expresses color as three values: L* for the lightness from black (0) to white (100), a* from green (−) to red (+), and b* from blue (−) to yellow (+).

In aspects, the CIE L* value can be 50 or more with an absolute value of the CIE a* value of 0.1 or more (e.g., 0.3 or more, or 1.0 or more) and an absolute value of the CIE b* value of 0.1 or more (e.g., 0.2 or more, 0.5 or more, 1.0 or more, or 1.5 or more). In aspects, the glass article 350 and/or 511 can comprise a CIE L* value of 50 or more, 60 or more, 65 or more 70 or more, 75 or more, 80 or more, 85 or more, 90 or more, 96 or less, 92 or less, 90 or less, 88 or less, 85 or less, 82 or less, 80 or less, 75 or less, 70 or less, 65 or less, or 55 or less. In aspects, the glass article 350 and/or 511 can comprise a CIE L* value from 50 to 96, from 60 to 92, from 70 to 90, from 75 to 88, from 80 to 85, or any range or subrange therebetween. In aspects, the glass article 350 and/or 511 can comprise a CIE L* value of 80 or more, for example, from 80 to 96, from 85 to 92, from 90 to 92, or any range or subrange therebetween. Alternatively, the glass article 350 and/or 511 can comprise a CIE L* value of 80 or less, for example, from 50 to 80, from 60 to 75, 65 to 70, or any range or subrange therebetween.

In aspects, the glass article 350 and/or 511 can comprise an absolute value of a CIE a* (i.e., |a*|) value of 0.1 or more, 0.2 or more, 0.3 or more, 0.5 or more, 0.8 or more, 1 or more, 3 or more, 5 or more, 10 or more, 15 or more, 18 or more, 20 or more, 25 or more, or 30 or more. In aspects, the CIE a* value can be −35 or more, −20 or more, −18 or more, −15 or more, −10 or more, −5 or more, −3 or more, −1 or more, 0.1 or more, 0.3 or more, 0.5 or more, 0.8 or more, 1 or more, 5 or more, 8 or more, 10 or more, 18 or more, 20 or more, 25 or more, 65 or less, 40 or less, 25 or less, 20 or less, 15 or less, 10 or less, 8 or less, 5 or less, 3 or less, 1 or less, −0.1 or less, −0.3 or less, −0.5 or less, −0.8 or less, −1 or less, −3 or less, −5 or less, −8 or less, −10 or less, −15 or less, −18 or less, −20 or less, or −25 or less. In aspects, the CIE a* value (excluding values from −0.1 to 0.1) can range from −35 to 65, from −20 to 40, from −15 to 25, from −15 to 20, from −10 to 18, from −5 to 10, from −3 to 5, from −1 to 3, from −0.8 to 1, or any range or subrange therebetween. For example, the CIE a* value (excluding value from −0.1 to 0.1) can range from −35 to 60, −20 to 60, −10 to 25, from −5 to 25, or any range or subrange therebetween. Alternatively, the CIE a* value can range from −35 to −0.1, from −35 to −0.2, −20 to −0.3, from −20 to −0.5, from −18 to −1, from −15 to −1, from −10 to −1, from −8 to −1, from −5 to −1, or any range or subrange therebetween. Alternatively, the CIE a* value can range from 0.1 to 65, from 0.2 to 25, from 0.3 to 20, from 0.3 to 15, from 0.3 to 10, from 0.5 to 8, from 1 to 5, or any range or subrange therebetween. In aspects, the CIE a* value can be −3 or less, for example, in a range from −35 to −3, from −20 to −3, from −18 to −3, from −15 to −3, from −10 to −5, or any range or subrange therebetween.

In aspects, the glass article 350 and/or 511 can comprise an absolute value of a CIE b* (i.e., |b*|) value of 0.1 or more, 0.2 or more, 0.3 or more, 0.5 or more, 1 or more, 1.5 or more, 3 or more, 5 or more, 8 or more, 10 or more, 20 or more, 50 or more, 70 or more, or 80 or more. In aspects, the CIE b* value can be −90 or more, −85 or more, −75 or more, −50 or more, −35 or more, −20 or more, −5 or more, −1 or more, 0.1 or more, 0.2 or more, 0.3 or more, 0.5 or more, 1 or more, 3 or more, 5 or more, 8 or more, 10 or more, 20 or more, 50 or more, 70 or more, 120 or less, 90 or less, 82 or less, 75 or less, 50 or less, 35 or less, 20 or less, 8 or less, 5 or less, −0.1 or less, −0.2 or less, −0.3 or less, −0.5 or less, −1 or less, −5 or less, −10 or less, −20 or less, −35 or less, −50 or less, or −70 or less. In aspects, the CIE b* value (excluding from −0.1 to 0.1) can range from −90 to 120, from −85 to 75, from −50 to 50, from −35 to 35, from −20 to 20, from −5 to 8, from −1 to 5, from 0.1 to 5, from 0.2 to 3, from 0.3 to 1, or any range or subrange therebetween. For example, the CIE b* value can range from −20 to 5, from −10 to 5, from −5 to 5, from −5 to 3, from −5 to 1, from −5 to −0.1, from −5 to −0.2, from −3 to −0.3, from −1 to −0.5, or any range or subrange therebetween. Alternatively, the CIE b* value can range from 0.1 to 90, from 0.2 to 90, from 0.5 to 82, from 1 to 75, from 1 to 20, from 1 to 5, from 1.5 to 5, or any range or subrange therebetween. Alternatively, the CIE b* value can range from −90 to −0.1, from −85 to −0.2, from −50 to −0.5, from −20 to −1, from −10 to −1, from −1 to −5, or any range or subrange therebetween. In aspects, the CIE b* value can be 5 or more, for example, in a range from 5 to 120, from 5 to 90, from 5 to 75, from 5 to 50, from 5 to 35, from 5 to 25, from 5 to 20, from 5 to 8, or any range or subrange therebetween.

Unless otherwise indicated, transmittance data (total transmittance and diffuse transmittance) in the visible spectrum is measured with a Lambda 950 UV/Vis/NIR Spectrophotometer manufactured by PerkinElmer Inc. (Waltham, Massachusetts USA). The Lambda 950 apparatus was fitted with a 150 mm integrating sphere. Data was collected using an open beam baseline and a Spectralon® reference reflectance disk. For total transmittance (Total Tx), the sample is fixed at the integrating sphere entry point. The term “average transmittance,” as used herein with respect to the visible spectrum, refers to the average of transmittance measurements made within a given wavelength range with each whole numbered wavelength weighted equally. Unless otherwise indicated, as described herein, the “average transmittance” with respect to the visible spectrum is reported over the wavelength range from 380 nm to 750 nm (inclusive of endpoints). Unless otherwise specified, the average transmittance is indicated for article thicknesses from 0.4 mm to 5 mm, inclusive of endpoints. Unless otherwise specified, when average transmittance is indicated, this means that each thickness within the range of thicknesses from 0.4 mm to 5 mm has an average transmittance as specified. For example, colored glass articles having average transmittances of 10% to 92% over the wavelength range from 380 nm to 750 nm means that each thickness within the range of 0.4 mm to 5 mm (e.g., 0.6 mm, 0.9 mm, 2 mm, etc.) has an average transmittance in the range of 10% to 92% for the wavelength range from 380 nm to 750 nm.

In aspects, an “optically transparent material” or an “optically clear material” can have an average transmittance of 75% or more, 80% or more, 85% or more, or 90% or more, 92% or more, 93% or more, 94% or more, 95% or more, 96% or more in the wavelength range of 400 nm to 700 nm through a 0.7 mm thick piece of the material. The average transmittance in the wavelength range of 400 nm to 700 nm is calculated by measuring the transmittance of whole number wavelengths from 400 nm to 700 nm and averaging the measurements. In aspects, the glass article 350 and/or 511 can be optically transparent. In aspects, the glass article 350 and/or 511 can comprise an average transmittance (averaged over optical wavelengths from 400 nm to 700 nm) of 80% or more, 90% or more, 91% or more, 92.0% or more, 92.2% or more, 92.5% or more, 92.8% or more, 93.0% or more, 99% or less, 96% or less, 95% or less, or 94% or less. In aspects, the glass article 350 and/or 511 can comprise an average transmittance (averaged over optical wavelengths from 400 nm to 700 nm) can be in a range from 80% to 99%, from 90% to 96%, from 90% to 95%, from 91% to 95%, from 92.0% to 95%, from 92.2% to 94%, from 92.5% to 94%, from 92.8% to 93%, or any range or subrange therebetween. Alternatively, in aspects, the glass article 350 and/or 511 can be opaque. In aspects, the glass article 350 and/or 511 can comprise an average transmittance (averaged over optical wavelengths from 400 nm to 700 nm) of 75% or less, 66% or less, 50% or less, 40% or less, 33% or less, 25% or less, 10% or more, 15% or more, 20% or more, 25% or more, 30% or more, 35% or more, 40% or more, 45% or more 50% or more, or 66% or more. In aspects, the glass article 350 and/or 511 comprise an average transmittance (averaged over optical wavelengths from 400 nm to 700 nm) in a range from 10% to 75%, from 15% to 66%, from 20% to 50%, from 25% to 40%, from 30% to 33%, or any range or subrange therebetween.

In aspects, the color exhibited by glass article 350 and/or 511 can correspond to at least one 10 nm band with lower transmittance than the average transmittance over the visible spectrum (e.g., from 400 nm to 700 nm). In aspects, the glass article 350 and/or 511 can exhibit a total transmittance of at least one 10 nm band within the wavelength range of 380 nm to 750 nm that is 3% or more, 5% or more, 8% or more, 10% or more, 20% or more, 40% or more 50% or more, 60% or more, 70% or more, 80% or less, 78% or less, 75% or less, 72% or less, 70% or less, 68% or less, or 65% or less. In aspects, the glass article 350 and/or 511 can exhibit a total transmittance of at least one 10 nm band within the wavelength range of 380 nm to 750 nm in range from 3% to 80%, from 5% to 78%, from 8% to 75%, from 10% to 72%, from 20% to 70%, from 40% to 68%, from 50% to 65%, or any range or subrange therebetween.

As used herein, haze refers to reflectance haze that is measured through the first major surface 332 in accordance with ASTM D1003-21 at 0° relative to a direction normal to the first major surface 332. Haze is measured using a BYK Haze-Gard Dual (BYK Gardner). A CIE D65 illuminant is used as the light source for illuminating the glass article 350 and/or 511. Haze values reported herein are measured from a major surface of a substrate having a thickness of 0.7 mm. In further aspects, the haze of the glass article 350 and/or 511 can be 2% or less, 1% or less, 0.8% or less, 0.5% or less, or 0.3% or less. In further aspects, the haze of the glass article 350 and/or 511 can be in a range from 0.01% to 2%, from 0.05% to 2%, from 0.1% to 1%, from 0.1% to 0.8%, from 0.2% to 0.5%, or any range or subrange therebetween.

In aspects, the first major surface 332 and/or the second major surface 330 can be substantially free and/or free of any copper-containing salt (e.g., deposits). As used herein, copper concentration is determined by flame spectroscopy of the glass article. As discussed below, the glass article and/or natively colored glass article can comprise copper in a copper concentration of 0.01 wt % or more, 0.03 wt % or more, 0.06 wt % or more, 0.10 wt % or more, 0.2 wt % or more, 0.5 wt % or more, 5.0 wt % or less, 4.0 wt % or less, 3.0 wt % or less, 2.0 wt % or less, 1.0 wt % or less, 0.5 wt % or less, 0.2 wt % or less, 0.10 wt % or less, or 0.06 wt % or less. In aspects, the copper concentration of the glass article and/or natively colored glass article can be in a range from 0.01 wt % to 5 wt %, from 0.03 wt % to 5 wt %, from 0.03 wt % to 3.0 wt %, from 0.06 wt % to 2.0 wt %, from 0.10 wt % to 1.0 wt %, from 0.2 wt % to 0.5 wt %, or any range or subrange therebetween. In aspects, the copper concentration can be 0.5 wt % or less, for example, in a range from 0.01 wt % to 0.5 wt %, from 0.01 wt % to 0.2 wt %, from 0.03 wt % to 0.10 wt %, from 0.03 wt % to 0.06 wt %, or any range or subrange therebetween.

FIG. 5 illustrates a natively colored glass housing 500 comprising the glass article 511 and the reflector 501. In aspects, the reflector 501 comprises an opaque material. As used herein, opaque means that an average transmittance in the wavelength range of 400 nm to 700 nm through a 1.0 mm thick piece of a material is 10% or less. The average transmittance in the wavelength range of 400 nm to 700 nm is calculated by measuring the transmittance of whole number wavelengths from 400 nm to 700 nm and averaging the measurements. In aspects, the reflector comprises a CIE L* value of 70 or more. An exemplary material for the reflector is aluminum. In aspects, as shown in FIG. 5, the glass article 511 can be disposed on and/or contact a surface 503 of the reflector 501 can contact the glass article 511. Providing the reflector can increase a perceived brightness of the glass article.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other.

As shown in FIG. 5, the glass article 511 comprises a first major surface 513 and a second major surface 515 opposite the first major surface 513. In aspects, as shown, the first major surface 513 and/or the second major surface 515 can comprise planar surfaces, although other shapes and designs are possible in other aspects. A substrate thickness 517 of the glass article 511 is defined as an average distance between the first major surface 513 and the second major surface 515. In aspects, the substrate thickness 517 can be 10 micrometers (μm) or more, 30 μm or more, 50 μm or more, 80 μm or more, 100 μm or more, 150 μm or more, 200 μm or more, 400 μm or more, 500 μm or more, 600 μm or more, 700 μm or more, 800 μm or more, 5 millimeters (mm) or less, 4 mm or less, 3 mm or less, 2.5 mm or less, 2 mm or less, 1.5 mm or less, 1 mm or less, 800 μm or less, 700 μm or less, 600 μm or less, 500 μm or less, or 300 μm or less. In aspects, the substrate thickness 517 can be in a range from 10 μm to 5 mm, from 30 μm to 4 mm, from 50 μm to 3 mm, from 80 μm to 2.5 mm, from 100 μm to 2 mm, from 150 μm to 1.5 mm, from 200 μm to 1 mm, from 400 μm to 800 μm, from 500 μm to 700 μm, or any range or subrange therebetween. In aspects, the substrate thickness 517 can be 100 μm or more, for example, in a range from 100 μm to 5 mm, from 150 μm to 4 mm, from 200 μm to 3 mm, from 400 μm to 3 mm, from 500 μm to 2.5 mm, from 600 μm to 2.5 mm, from 700 μm to 2 mm, from 800 μm to 1.5 mm, or any range or subrange therebetween. In preferred aspects, the substrate thickness 517 can be from 10 μm to 5 mm, from 120 μm to 5 mm, or from 400 μm to 3 mm.

The glass article 511 and/or 350 comprises a glass-based material. In aspects, the glass-based material can comprise a pencil hardness of 8H or more, for example, 9H or more. As used herein, pencil hardness is measured using ASTM D 3363-20 with standard lead graded pencils. An elastic modulus (e.g., Young's modulus) and/or a Poisson's ratio can be measured using ISO 527-1:2019. Throughout the disclosure, the Young's modulus of the glass-based materials and ceramic-based materials are measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, the glass article 511 and/or 350 can comprise an elastic modulus in a range from 40 GPa to 140 GPa, from 50 GPa to 100 GPa, from 60 GPa to 80 GPa, or any range or subrange therebetween.

As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In one or more aspects, a glass-based material may comprise, in mole percent (mol %): SiO₂ from 40 mol % to 80 mol %, Al₂O₃ from 5 mol % to 30 mol %, B₂O₃ from 0 mol % to 10 mol %, ZrO₂ from 0 mol % to 5 mol %, P₂O₅ from 0 mol % to 15 mol %, TiO₂ from 0 mol % to 2 mol %, R₂O from 0 mol % to 20 mol %, and RO from 0 mol % to 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In further aspects, the glass-based material may comprise (in mol %) from 50 mol % to 75 mol % SiO₂, from 5 mol % to 20 mol % Al₂O₃, from 15 mol % to 20 mol % of at least one alkali metal oxide (R₂O), and at least one of B₂O₃ or P₂O₅. In further aspects, the glass-based material may comprise (in mol %) from 60 mol % to 65 mol % SiO₂, from 12 mol % to 17 mol % Al₂O₃, from 3 mol % to 6 mol % B₂O₃, from 13 mol % to 20 mol % of at least one alkali metal oxide (R₂O), from 0.5 mol % to 4 mol % CaO, from 0 mol % to 1 mol % ZnO, from 0 mol % to 1 mol % ZrO₂, and from 0.01 mol % to 0.25 mol % SnO₂. In further aspects, the glass-based material may comprise (in mol %) from 60 mol % to 65 mol % SiO₂, from 12 mol % to 17 mol % Al₂O₃, from 3 mol % to 6 mol % B₂O₃, from 10 mol % to 16 mol % of at least one alkali metal oxide (R₂O), from 3 mol % to 5 mol % CaO, from 0 mol % to 1 mol % ZrO₂, and from 0 mol % to 0.25 mol % SnO₂. In any of the aspects, the glass-based material can comprise from 0.2 mol % to 0.5 mol % ZrO₂. In aspects, a glass-based substrate may optionally further comprise from 0 mol % to 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇.

“Glass-ceramics” include materials produced through controlled crystallization of glass. In aspects, glass-ceramics have 1% to 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spodumene, cordierite, petalite, and/or lithium disilicate. The glass-ceramic substrates may be strengthened using the chemical strengthening processes. In one or more aspects, MAS-System glass-ceramic substrates may be strengthened in Li₂SO₄ molten salt, whereby an exchange of 2Li⁺ for Mg²⁺ can occur. In aspects, the glass article 511 and/or 350 can be a glass-ceramic comprising one or more crystalline phases. In further aspects, a total amount of the one or more crystalline phases, as a weight % (wt %) of the glass article 511 and/or 350, can be 10 wt % or less, 8 wt % or less, 6 wt % or less, 4 wt % or less, 4 wt % or less, 2 wt % or less, 1 wt % or less, 0.1 wt % or more, 0.5 wt % or more, or 1 wt % or more.

In aspects, the glass-based material can comprise a colorant selected from a group consisting of silver, gold, chromium, cobalt, nickel, cerium, copper, and combinations thereof. For example, the glass-based material can comprise titanium oxide, zirconia, iron oxide, cerium oxide, or combinations thereof. In further aspects, the glass-based material can comprise from 5 parts-per-million (ppm) to 15 ppm gold. In further aspects, a concentration of the colorant can be 10 ppm or more, 50 ppm or more, 100 ppm or more, 300 ppm or more, 500 ppm or more, 1,000 ppm or more, 2,000 ppm or more, 5,000 ppm or more, 10,000 ppm or more, 50,000 ppm or less, 30,000 ppm or less, 20,000 ppm or less, 10,000 ppm or less, 6,000 ppm or less, 4,000 ppm or less, or 2,000 ppm or less. In further aspects, a concentration of the colorant can range from 10 ppm to 50,000 ppm, from 50 ppm to 50,000 ppm, from 100 ppm to 30,000 ppm, from 300 ppm to 20,000 ppm, from 500 ppm to 10,000 ppm, from 1,000 ppm to 6,000 ppm, from 2,000 ppm to 4,000 ppm, or any range or subrange therebetween. In further aspects, as discussed above, the glass-based material can comprise copper within one or more of the copper concentrations discussed above.

Unless otherwise indicated, compositions are specified in mole percent (mol %). The terms “0 mol %” and “free,” when used to describe the concentration and/or absence of a particular constituent component in a glass composition, means that the constituent component is not present in the glass composition. With reference to compositions, the term “substantially free,” when used to describe the concentration and/or absence of a particular constituent component in a glass composition and the resultant colored glass article, means that the constituent component is not intentionally added to the glass composition and the resultant colored glass article. However, the glass composition and the resultant colored glass article may contain traces of the constituent component as a contaminant or tramp in amounts of less than 200 ppm unless specified otherwise herein. It is noted that the definition of “substantially free” is exclusive of gold (Au) which may be intentionally added to the glass composition in relatively small amounts, for example and without limitation, amounts less than 200 ppm (or the equivalent in mol %) to achieve a desired color in the resultant colored glass article. With reference to copper-containing residue on the surface, a “majority” of the surface being free refers to 50% or more of the surface not having the residue. With reference to the copper-containing residue, “substantially free” means that greater than 95% of the surface area does not have the residue.

The glass articles described herein can include aluminoborosilicate glass compositions and colored glass articles and comprise SiO₂, Al₂O₃, and B₂O₃. Additionally, the glass articles described herein include one or more colorants in a colorant package to impart a desired color to the resultant colored glass article. The glass articles described herein also include alkali oxides (e.g., Li₂O and Na₂O) to enable the ion-exchangeability of the colored glass articles. In aspects, the glass articles described herein may further include other components to improve colorant retention and produce colored glass articles having the desired color. In aspects, the difference between R₂O and Al₂O₃ (i.e. R₂O (mol %)-Al₂O₃ (mol %)) in the glass articles described herein may be adjusted to produce a desired observable color (e.g., pink, purple, red, orange, or blue). In aspects, the viscosity of the glass composition may be adjusted to prevent devitrification of the glass composition.

SiO₂ is the primary glass former in the glass articles described herein and may function to stabilize the network structure of the colored glass articles. The concentration of SiO₂ in the glass articles should be sufficiently high (e.g., 40 mol % or more) to enhance the chemical durability of the glass composition and, in particular, the resistance of the glass composition to degradation upon exposure to acidic solutions, basic solutions, and in water. The amount of SiO₂ may be limited (e.g., 80 mol % or less) to control the melting point of the glass composition, as the melting point of pure SiO₂ or high SiO₂ glasses is undesirably high. Thus, limiting the concentration of SiO₂ may aid in improving the meltability and the formability of the resultant colored glass article. In aspects, the glass article may comprise from 40 mol % to 80 mol % SiO₂ or from 50 mol % to 80 mol % SiO₂. In aspects, the glass article may comprise from 45 mol % to 67 mol % SiO₂ or from 53 mol % to 67 mol % SiO₂. In aspects, the concentration of SiO₂ in the glass article may be 40 mol % or more, 45 mol % or more, 50 mol % or more, 52 mol % or more, 53 mol % or more, 54 mol % or more, 55 mol % or more, 56 mol % or more, 57 mol % or more, 58 mol % or more, 60 mol % or more, 80 mol % or less, 75 mol % or less, 73 mol % or less, 71 mol % or less 70 mol % or less, 68 mol % or less, 67 mol % or less, 66 mol % or less, 65 mol % or less 64 mol % or less, 63 mol % or less, 62 mol % or less, 61 mol % or less, 60 mol % or less, or 59 mol % or less. In aspects, the concentration of SiO₂ in the glass article may be from 40 mol % to 70 mol %, 45 mol % to 70 mol %, from 50 mol % to 68 mol %, from 52 mol % to 68 mol %, from 53 mol % to 67 mol %, from 54 mol % to 67 mol %, from 55 mol % to 66 mol %, from 56 mol % to 65 mol %, from 57 mol % to 65 mol %, from 58 mol % to 65 mol %, from 60 mol % to 65 mol %, from 60 mol % to 64 mol %, from 60 mol % to 63 mol %, from 60 mol % to 62 mol %, or any range or subrange therebetween.

Like SiO₂, Al₂O₃ may also stabilize the glass network and additionally provides improved mechanical properties and chemical durability to the glass article. The amount of Al₂O₃ may also be tailored to control the viscosity of the glass composition. Al₂O₃ may be included such that the resultant glass article has the desired fracture toughness (e.g., 0.7 MPa·m^{1/2} or more). However, if the amount of Al₂O₃ is too high (e.g., 25 mol % or more), the viscosity of the glass melt may increase, thereby diminishing the formability of the glass article. In aspects, if the amount of Al₂O₃ is too high, the solubility of one or more colorants of the colorant package in the glass melt may decrease, resulting in the formation of undesirable crystal phases in the glass. For example and without limitation, when the colorant package includes Cr₂O₃, the solubility of Cr₂O₃ in the glass melt may decrease with increasing Al₂O₃ concentrations (e.g., concentrations of 17.5 mol % or more), leading to the precipitation of undesirable crystal phases. Without wishing to be bound by theory, it is hypothesized that similar behavior may occur with colorants other than Cr₂O₃. Accordingly, in aspects, the glass com article may comprise from 7 mol % to 25 mol % Al₂O₃, from 7 mol % to 20 mol % Al₂O₃, or from 8 mol % to 20 mol % Al₂O₃. In aspects, the glass article may comprise from 10 mol % to 20 mol % Al₂O₃, from 10 mol % to 17.5 mol % Al₂O₃, or from 12 mol % to 17.25 mol % Al₂O₃. In aspects, the glass article may comprise from 11 mol % to 19 mol % Al₂O₃ or from 14 mol % to 17 mol % Al₂O₃. In aspects, the concentration of Al₂O₃ in the glass article may be 7 mol % or more, 8 mol % or more, 9 mol % or more, 10 mol % or more, 11 mol % or more 12 mol % or more, 12.5 mol % or more, 13 mol % or more, 13.5 mol % or more, 14 mol % or more, 14.5 mol % or more, 15 mol % or more, 15.5 mol % or more, 16 mol % or more, 25 mol % or less, 23 mol % or less, 20 mol % or less, 19 mol % or less, 18 mol % or less, 17.5 mol % or less, 17.25 mol % or less, 17 mol % or less, 16.75 mol % or less, or 16 mol % or less. In aspects, the concentration of Al₂O₃ in the glass article may be from 7 mol % to 25 mol %, from 7 mol % to 23 mol %, from 8 mol % to 20 mol %, from 9 mol % to 19 mol %, from 10 mol % to 18 mol %, from 11 mol % to 17.5 mol %, from 12 mol % to 17.25 mol %, from 13 mol % to 17 mol %, from 14 mol % to 16.75 mol %, from 14.5 mol % to 16 mol %, or any range or subrange therebetween.

B₂O₃ decreases the melting point of the glass composition, which may improve retention of certain colorants in the glass, for example and without limitation, Au. B₂O₃ may also improve the damage resistance of the resultant colored glass article. In addition, B₂O₃ may be added to reduce the formation of non-bridging oxygen, the presence of which may reduce fracture toughness. The concentration of B₂O₃ should be sufficiently high (e.g., 1 mol % or more) to reduce the melting point of the glass composition, improve the formability, and increase the fracture toughness of the colored glass article. However, if B₂O₃ is too high (e.g., 15 mol % or more), the annealing point and strain point may decrease, which increases stress relaxation and reduces the overall strength of the colored glass article. In aspects, the glass article may comprise from 1 mol % to 15 mol % B₂O₃, from 1 mol % to 10 mol % B₂O₃, from 3 mol % to 10 mol % B₂O₃, or from 3.5 mol % to 9 mol % B₂O₃. In aspects, the glass article may comprise from 2 mol % to 12 mol % B₂O₃ or from 2 mol % to 8 mol % B₂O₃. In aspects, the concentration of B₂O₃ in the glass article may be 1 mol % or more, 2 mol % or more, 3 mol % or more, 3.5 mol % or more, 4 mol % or more, 4.5 mol % or more, 5 mol % or more, 5.5 mol % or more, 15 mol % or less, 12 mol % or less, 10 mol % or less, 9 mol % or less, 8 mol % or less, 7.5 mol % or less, 7 mol % or less, 6.5 mol % or less, or 6 mol % or less. In aspects, the concentration of B₂O₃ in the glass article may be from 1 mol % to 15 mol %, from 2 mol % to 12 mol %, from 3 mol % to 10 mol %, from 3.5 mol % to 9 mol %, from 4 mol % to 8 mol %, from 4.5 mol % to 7.5 mol %, from 5 mol % to 7 mol %, from 5.5 mol % to 6.5 mol %, or any range or subrange therebetween.

As described hereinabove, the glass articles may contain alkali oxides (e.g., Li₂O, Na₂O, and K₂O) to enable the ion-exchangeability of the glass articles. Li₂O aids in the ion-exchangeability of the glass article and also reduces the softening point of the glass composition, thereby increasing the formability of the glass articles. The addition of Li₂O facilitates the exchange of both Na⁺ and K⁺ cations into the glass for strengthening the glass and also facilitates producing a relatively high surface compressive stress and relatively deep depth of compression, improving the mechanical characteristics of the resultant colored glass article. In addition, Li₂O decreases the melting point of the glass composition, which may improve retention of colorants in the glass, for example and without limitation, Au. The concentration of Li₂O in the glass articles should be sufficiently high (e.g., 1 mol % or more) to reduce the melting point of the glass composition and achieve the desired maximum central tension (e.g., 40 MPa or more) following ion exchange. However, if the amount of Li₂O is too high (e.g., greater than 20 mol %), the liquidus temperature may increase, thereby diminishing the manufacturability of the colored glass article. In aspects, the glass article may comprise from 1 mol % to 20 mol % Li₂O or from 1 mol % to 20 mol % Li₂O. In aspects, the glass article may comprise from 3 mol % to 18 mol % Li₂O, from 7 mol % to 18 mol % Li₂O, from 8.8 mol % to 14 mol % Li₂O, or from 9 mol % to 13.5 mol % Li₂O. In aspects, the concentration of Li₂O in the glass article may be 1 mol % or more, 3 mol % or more, 5 mol % or more, 7 mol % or more, 7.5 mol % or more, 8 mol % or more, 8.5 mol % or more, 8.8 mol % or more, 9 mol % or more, 9.2 mol % or more, 9.4 mol % or more, 9.6 mol % or more, 9.8 mol % or more, 10 mol % or more, 11 mol % or more, 11.5 mol % or more, 12 mol % or more, 20 mol % or less, 18 mol % or less, 17 mol % or less, 16 mol % or less, 15 mol % or less, 14 mol % or less, 13.5 mol % or less, 13 mol % or less, 12.5 mol % or less, 12 mol % or less, 11.5 mol % or less, or 11 mol % or less. In aspects, the concentration of Li₂O in the glass article may be from 1 mol % to 20 mol %, from 3 mol % to 18 mol %, from 5 mol % to 17 mol %, from 7 mol % to 16 mol %, from 7.5 mol % to 15 mol %, from 8 mol % to 14 mol %, from 8.5 mol % to 13.5 mol %, from 8.8 mol % to 13 mol %, from 9 mol % to 12.5 mol %, from 9.2 mol % to 12.5 mol %, from 9.4 mol % to 12 mol %, from 9.6 mol % to 12 mol %, from 9.8 mol % to 11.5 mol %, from 10 mol % to 11 mol %, or any range or subrange therebetween.

Na₂O improves diffusivity of alkali ions in the glass and thereby reduces ion-exchange time and helps achieve the desired surface compressive stress (e.g., 300 MPa or more). The addition of Na₂O also facilitates the exchange of K⁺ cations into the glass for strengthening and improving the mechanical characteristics of the resultant colored glass article. Na₂O also improves the formability of the colored glass article. In addition, Na₂O decreases the melting point of the glass composition, which may improve retention of certain colorants in the glass, for example, Au. However, if too much Na₂O is added to the glass composition, the melting point may be too low. In aspects, the concentration of Li₂O present in the glass article may be greater than the concentration of Na₂O present in the glass article. In aspects, the glass article may comprise greater than 0 mol %, from 0.01 mol % to 15 mol % Na₂O, from 0.5 mol % to 15 mol % Na₂O, or from 1 mol % to 15 mol % Na₂O. In aspects, the glass article may comprise from 1 mol % to 12 mol % Na₂O or from 2 mol % to 10 mol % Na₂O. In aspects, the glass article may comprise from 0.01 mol % to 4 mol % Na₂O. In aspects, the glass article may comprise from 1.5 mol % to 8 mol % Na₂O or from 2 mol % to 7.5 mol % Na₂O. In aspects, the concentration of Na₂O in the glass article may be greater than 0 mol %, 0.01 mol % or more, 0.5 mol % or more, 1 mol % or more, 1.5 mol % or more, 2 mol % or more, 2.5 mol % or more, 3 mol % or more, 3.5 mol % or more, 4 mol % or more, 4.5 mol % or more, 15 mol % or less, 12 mol % or less, 10 mol % or less, 9 mol % or less, 8.5 mol % or less, 8 mol % or less, 7.5 mol % or less, 7 mol % or less, 6.5 mol % or less, 6 mol % or less, 5.5 mol % or less, 5 mol % or less, 4.5 mol % or less, or 4 mol % or less. In aspects, the concentration of Na₂O in the glass article may be from greater than 0 mol % to 15 mol %, from 0.01 mol % to 12 mol %, from 0.5 mol % to 12 mol %, from 1 mol % to 10 mol %, from 1.5 mol % to 9 mol %, from 2 mol % to 8.5 mol %, from 2.5 mol % to 8 mol %, from 3 mol % to 7.5 mol %, from 3.5 mol % to 7 mol %, from 4 mol % to 6.5 mol %, from 4.5 mol % to 6 mol %, or any range or subrange therebetween In aspects, the concentration of Na₂O in the glass article may be from 0.5 mol % to 10 mol %, from 1 mol % to 9 mol %, from 1 mol % to 8 mol %, from 1 mol % to 7 mol %, from 1 mol % to 6.5 mol %, from 1 mol % to 6 mol %, from 1 mol % to 5.5 mol %, from 1 mol % to 5 mol %, from 1.5 mol % to 4.5 mol %, from 2 mol % to 4 mol %, or any range or subrange therebetween.

K₂O, when included, promotes ion-exchange and may increase the depth of compression and decrease the melting point to improve the formability of the colored glass article. However, adding too much K₂O may cause the surface compressive stress and melting point to be too low. Accordingly, in aspects, the amount of K₂O added to the glass composition may be limited. In aspects, the glass article may optionally comprise from greater than 0 mol % to 3 mol % K₂O, from greater than 0 mol % to 1 mol % K₂O, from 0.01 mol % to 1 mol % K₂O, or from 0.1 mol % to 1 mol % K₂O. In aspects, the glass article may optionally comprise from 0.1 mol % to 0.5 mol % K₂O. In aspects, the concentration of K₂O in the glass article may be greater than 0 mol %, 0.01 mol % or more, 0.1 mol % or more, 0.2 mol % or more, 0.25 mol % or more, 0.3 mol % or more, 0.4 mol % or more, 0.5 mol % or more, 3 mol % or less, 2.5 mol % or less, 2 mol % or less, 1.5 mol % or less, 1 mol % or less, 0.75 mol % or less, 0.5 mol % or less, or 0.25 mol % or less. In aspects, the concentration of K₂O in the glass article may be from greater 0 mol % to 3 mol %, from 0.01 mol % to 2.5 mol %, from 0.1 mol % to 2 mol %, from 0.2 mol % to 1.5 mol %, from 0.25 mol % to 1 mol %, from 0.3 mol % to 0.75 mol %, from 0.4 mol % to 0.5 mol %, or any range or subrange therebetween.

R₂O, as used herein, is the sum (in mol %) of Li₂O, Na₂O, and K₂O present in the glass article (i.e., R₂O=Li₂O (mol %)+Na₂O (mol %)+K₂O (mol %). Like B₂O₃, the alkali oxides aid in decreasing the softening point and molding temperature of the glass composition, thereby offsetting the increase in the softening point and molding temperature of the glass composition due to higher amounts of SiO₂ in the glass composition, for example. The softening point and molding temperature may be further reduced by including combinations of alkali oxides (e.g., two or more alkali oxides) in the glass composition, a phenomenon referred to as the “mixed alkali effect.” However, it has been found that if the amount of alkali oxide is too high, the average coefficient of thermal expansion of the glass composition increases to greater than 100×10⁻⁷/° C., which may be undesirable. In aspects, the concentration of R₂O in the glass article can be from 1 mol % to 35 mol %, from 6 mol % to 25 mol %, or from 8 mol % to 23 mol %. In aspects, the concentration of R₂O in the glass article can be 2 mol % or more, 4 mol % or more, 6 mol % or more, 8 mol % or more, 10 mol % or more, 10.3 mol % or more, 11 mol % or more, 12 mol % or more 13 mol % or more, 14 mol % or more, 35 mol % or less, 30 mol % or less, 25 mol % or less, 23 mol % or less, 22 mol % or less, 21 mol % or less, 20 mol % or less, 19 mol % or less, 18 mol % or less, 17 mol % or less, 16 mol % or less, or 15 mol % or less. In aspects, the concentration of R₂O in the glass article can range from 2 mol % to 35 mol %, from 4 mol % to 30 mol %, from 6 mol % to 25 mol %, from 8 mol % to 23 mol %, from 8 mol % to 22 mol %, from 10 mol % to 21 mol %, from 10.3 mol % to 20 mol %, from 11 mol % to 19 mol %, from 12 mol % to 18 mol %, from 13 mol % to 17 mol %, from 14 mol % to 16 mol %, or any range or subrange therebetween.

In aspects, a difference between R₂O and Al₂O₃ (i.e. R₂O (mol %)-Al₂O₃ (mol %)) in the glass article may be adjusted to produce a desired observable color (e.g., pink, purple, red, orange, or blue). The analyzed R₂O—Al₂O₃ of the glass article, along with the added colorant package, may correlate with the observable color of the colored glass article after an optional heat treatment, as discussed herein. In aspects, R₂O—Al₂O₃ in the glass article may be from −5 mol % to 7 mol % or from −3 mol % to 2 mol %. In aspects, R₂O—Al₂O₃ in the glass article may be from −3 mol % to 6 mol % or from −1 mol % to 5 mol %. In aspects, R₂O—Al₂O₃ in the glass article may be from −5 mol % to 1.5 mol % or from −3 mol % to 1.5 mol %. In aspects, R₂O—Al₂O₃ in the glass article may be from 1.5 mol % to 7 mol % or from 1.5 mol % to 5 mol %. In aspects, R₂O—Al₂O₃ in the glass article may be −5 mol % or more, −4 mol % or more, −3 mol % or more, −2.5 mol % or more, −2 mol % or more, −1.5 mol % or more, 0.2 mol % or more, 0.5 mol % or more, 1 mol % or more, 1.5 mol % or more, 2 mol % or more, 7 mol % or less, 6.5 mol % or less, 6 mol % or less, 5.5 mol % or less, 5 mol % or less, 4.5 mol % or less, 4 mol % or less, 3.5 mol % or less, 3 mol % or less, 2.5 mol % or less, 2 mol % or less, 1.5 mol % or less, 1 mol % or less, or 0.5 mol % or less. In aspects, R₂O—Al₂O₃ in the glass article may be from −5 mol % to 7 mol %, from −4 mol % to 6.5 mol %, from −3 mol % to 6 mol %, from −2.5 mol % to 5.5 mol % from −2 mol % to 5 mol %, from −1.5 mol % to 4.5 mol %, from 0.2 mol % to 4 mol %, from 0.5 mol % to 3.5 mol %, from 1 mol % to 3 mol %, from 1.5 mol % to 2.5 mol %, or any range or subrange therebetween.

In aspects, the glass articles described herein further include MgO and/or ZnO to improve retention of colorants in the glass, such as Au or the like, for example, by lowering the melting point of the glass composition. Decreasing the melting point of the glass composition may help improve colorant retention because the glass compositions may be melted at relatively lower temperatures and the evaporation of colorants from the glass, such as gold, may be reduced. Without wishing to be bound by theory, it is also believed that partially replacing Li₂O and/or Na₂O with MgO and/or ZnO may also help improve retention of the colorants. Specifically, Li₂O and/or Na₂O is included in the batch glass composition as lithium carbonate and sodium carbonate, respectively. Upon melting the glass composition, carbonate gas is released from the glass composition. Colorants such as Au escape from the glass composition within the carbonate gas. Therefore, the improved colorant retention may be due to the reduced amount of carbonate. Further, it is believed that MgO and/or ZnO may improve the solubility of some colorants in the glass (e.g., Cr₂O₃), thereby avoiding the formation of undesirable crystal phases (e.g., Cr-spinel crystals) and expanding the color gamut that may be achieved by the resultant colored glass articles. As used herein, “color gamut” refers to the pallet of colors that may be achieved by the colored glass articles within the CIELAB color space. For example, in aspects where the colorant includes Cr₂O₃, the sum of MgO and ZnO present in the glass article (i.e., MgO (mol %)+ZnO (mol %)) may be from greater than 0 mol % to 6 mol % or 4.5 mol % or less. Without wishing to be bound by theory, it is hypothesized that similar behavior may occur with colorants other than Au and Cr₂O₃. In aspects, the sum (in mol %) of MgO and ZnO present in the glass article (i.e., MgO (mol %)+ZnO (mol %)) may be greater than 0 mol %, 0.1 mol % or more, 0.5 mol % or more, 1 mol % or more, 1.5 mol % or more, 2 mol % or more, 2.5 mol % or more, 3 mol % or more, 3.5 mol % or more, 7 mol % or less, 6 mol % or less, 5.5 mol % or less, 5 mol % or less, 4.5 mol % or less, 4.25 mol % or less, or 4 mol % or less. In aspects, the sum of MgO and ZnO in the glass may be from greater than 0 mol % to 8 mol %, from 0.1 mol % to 7 mol %, from 0.1 mol % to 6 mol %, from 0.5 mol % to 6 mol %, from 1 mol % to 5.5 mol %, from 1.5 mol % to 5 mol %, from 2 mol % to 4.5 mol %, from 2.5 mol % to 4.25 mol %, from 3 mol % to 4 mol %, or any range or subrange therebetween.

In addition to improving colorant retention, MgO lowers the viscosity of the glass compositions, which enhances the formability, the strain point, and the Young's modulus, and may improve ion-exchangeability. However, when too much MgO is added to the glass composition, the diffusivity of sodium and potassium ions in the glass composition decreases which, in turn, adversely impacts the ion-exchange performance (i.e., the ability to ion-exchange) of the resultant colored glass article. In aspects, the glass article may comprise from greater than 0 mol % to 8 mol % MgO or from 0 mol % to 4.5 mol % MgO. In aspects, the glass article may comprise from 0.5 mol % to 7 mol % MgO. In aspects, the concentration of MgO in the glass article may be greater than 0 mol %, 0.5 mol % or more, 1 mol % or more, 1.5 mol % or more, 2 mol % or more, 2.5 mol % or more, 8 mol % or less, 7 mol % or less, 6 mol % or less, 5.5 mol % or less, 5 mol % or less, 4.5 mol % or less, 4 mol % or less, 3.5 mol % or less, 3 mol % or less, 2.5 mol % or less, 2 mol % or less, 1.5 mol % or less, or 1 mol % or less. In aspects, the concentration of MgO in the glass article may be from greater than or equal to 0 mol % to 8 mol %, from 0.5 mol % to 7 mol %, from 0.5 mol % to 6 mol %, from 1 mol % to 5.5 mol %, from 1 mol % to 5 mol %, from 1.5 mol % to 4.5 mol %, from 1.5 mol % to 4 mol %, from 2 mol % to 3.5 mol %, from 2.5 mol % to 3 mol %, or any range or subrange therebetween. In aspects, the glass article may be substantially free or free of MgO.

In addition to improving colorant retention, ZnO lowers the viscosity of the glass compositions, which enhances the formability, the strain point, and the Young's modulus, and may improve ion-exchangeability. However, when too much ZnO is added to the glass composition, the diffusivity of sodium and potassium ions in the glass composition decreases which, in turn, adversely impacts the ion-exchange performance (i.e., the ability to ion-exchange) of the resultant colored glass article. In aspects, the glass article may comprise from greater than 0 mol % to 5 mol % ZnO, from greater than 0 mol % to 4.5 mol % ZnO, from 0.1 mol % to 4 mol % ZnO, from 0.25 mol % to 1.25 mol %, or from 0.5 mol % to 1 mol %. In aspects, the concentration of ZnO in the glass article may be greater than 0 mol %, 0.1 mol % or more, 0.25 mol % or more, 0.5 mol % or more, 0.7 mol % or more, 1 mol % or more, 1.5 mol % or more, 2 mol % or more, 5 mol % or less, 4.5 mol % or less, 4 mol % or less, 3.5 mol % or less, 3 mol % or less, 2.5 mol % or less, 2 mol % or less, 1.75 mol % or less, 1.5 mol % or less, 1.25 mol % or less, or 1 mol % or less. In aspects, the concentration of ZnO in the glass composition may be from greater than 0 mol % to 5 mol %, from 0.1 mol % to 4.5 mol %, from 0.25 mol % to 4 mol %, from 0.5 mol % to 3.5 mol %, from 0.75 mol % to 3 mol %, from 1 mol % to 2.5 mol %, from 1.5 mol % to 2 mol %, or any range or subrange therebetween. In aspects, the glass article may be substantially free or free of ZnO.

Like ZnO and the alkaline earth oxide MgO, other alkaline earth oxides, for example CaO, SrO and BaO, decrease the melting point of the glass composition. Accordingly, CaO, SrO, and/or BaO may be included in the glass articles to lower the melting point of the glass composition, which may help improve colorant retention.

In aspects, the glass articles described herein may further comprise CaO. CaO lowers the viscosity of a glass composition, which enhances the formability, the strain point and the Young's modulus, and may improve the ion-exchangeability. However, when too much CaO is added to the glass composition, the diffusivity of sodium and potassium ions in the glass composition decreases which, in turn, adversely impacts the ion-exchange performance (i.e., the ability to ion-exchange) of the resultant glass. In aspects, the concentration of CaO in the glass article may be 0 mol % or more, 0.25 mol % or more, 0.5 mol % or more, 0.75 mol % or more, 1 mol % or more, 7 mol % or less, 6.5 mol % or less, 6 mol % or less, 5.5 mol % or less, 5 mol % or less, 4.5 mol % or less, 4 mol % or less, 3.5 mol % or less, 3 mol % or less, 2.5 mol % or less, 2 mol % or less, 1.75 mol % or less, 1.5 mol % or less, 1.25 mol % or less, or 1 mol % or less. In aspects, the concentration of CaO in the glass article may be from greater than 0 mol % to 7 mol %, from greater than 0 mol % to 6.5 mol %, from 0.25 mol % to 6 mol %, from 0.25 mol % to 5.5 mol %, from 0.25 mol % to 5 mol %, from 0.5 mol % to 4.5 mol %, from 0.5 mol % to 4 mol %, from 0.5 mol % to 3.5 mol %, from 0.75 mol % to 3 mol %, from 0.75 mol % to 2.5 mol %, from 0.75 mol % to 2 mol %, from 1 mol % to 1.75 mol %, from 1 mol % to 1.5 mol %, or any range or subrange therebetween.

In aspects, the concentration of SrO in the glass article may be greater than 0 mol %, 0.25 mol % or more, 0.5 mol % or more, 0.75 mol % or more, 1 mol % or more, 2 mol % or less, 1.75 mol % or less, 1.5 mol % or less, 1.25 mol % or less, or 1 mol % or less. In aspects, the concentration of SrO in the glass article may be from greater than 0 mol % to 2 mol %, from 0.25 mol % to 1.75 mol %, from 0.5 mol % to 1.5 mol %, from 0.75 mol % to 1.25 mol %, from 0.75 mol % to 1 mol %, or any range or subrange therebetween. In aspects, the glass article may be substantially free or free of SrO.

In aspects, the concentration of BaO in the glass article may be greater than 0 mol %, 0.25 mol % or more, 0.5 mol % or more, 0.75 mol % or more, 1 mol % or more, 2 mol % or less, 1.75 mol % or less, 1.5 mol % or less, 1.25 mol % or less, or 1 mol % or less. aspects, the concentration of BaO in the glass article may be from greater than 0 mol % to 2 mol %, from 0.25 mol % to 1.75 mol %, from 0.5 mol % to 1.5 mol %, from 0.75 mol % to 1.25 mol %, from 0.75 mol % to 1 mol %, or any range or subrange therebetween. In aspects, the glass article may be substantially free or free of BaO.

R′O, as used herein, is the sum (in mol %) of MgO, ZnO, CaO, BaO, and SrO (i.e. R′O=MgO (mol %)+ZnO (mol %)+CaO (mol %)+BaO (mol %)+SrO (mol %)). In aspects, the concentration of R′O in the glass article may be greater than 0 mol %, 0.5 mol % or more, 1 mol % or more, 1.5 mol % or more, 2 mol % or more, 2.5 mol % or more, 8 mol % or less, 7.5 mol % or less, 7 mol % or less, 6.5 mol % or less, 6 mol % or less, 5.5 mol % or less, 5 mol % or less, 4.5 mol % or less, 4 mol % or less, or 3.5 mol % or less. In aspects, the concentration of R′O in the glass article may be from greater than 0 mol % to 8 mol %, from 0.5 mol % to 7.5 mol %, from 0.5 mol % to 7 mol %, from 1 mol % to 6.5 mol % from 1 mol % to 6 mol %, from 1.5 mol % to 5.5 mol %, from 1.5 mol % to 5 mol %, from 2 mol % to 4.5 mol %, from 2 mol % to 4 mol %, from 2.5 mol % to 3.5 mol %, or any range or subrange therebetween.

In aspects, a sum of R₂O, CaO, MgO, and ZnO (R₂O (mol %)+CaO (mol %)+MgO (mol %)+ZnO (mol %) may be 35 mol % or less, for example, from 1 mol % to 30 mol %, from 2 mol % to 30 mol %, from 3 mol % to 25 mol %, from 4 mol % to 25 mol %, from 5 mol % to 20 mol %, 6 mol % to 20 mol %, from 7 mol % to 15 mol %, from 8 mol % to 10 mol %, or any range or subrange therebetween.

In aspects, a sum of Al₂O₃, MgO, and ZnO present in the glass article (i.e., Al₂O₃ (mol %)+MgO (mol %)+ZnO (mol %)) may be from 12 mol % to 22 mol %. Without wishing to be bound by theory, it is believed that combinations of Al₂O₃, MgO, and ZnO within this range may aid in avoiding the formation of undesired crystal phases in the resultant colored glass articles. For example and without limitation, when the colorant package in the glass article includes Cr₂O₃, combinations of Al₂O₃, MgO, and ZnO within this range may avoid the formation of Cr-spinel crystals by increasing the solubility of the Cr₂O₃ colorant and thereby expanding the color gamut that may be achieved in the resultant colored glass articles. In aspects, a sum of Al₂O₃, MgO, and ZnO in the glass article may be from 13 mol % to 21.5 mol %. In aspects, the sum of Al₂O₃, MgO, and ZnO in the glass article may be 12 mol % or more, 13 mol % or more, 14 mol % or more, 15 mol % or more, 16 mol % or more, 22 mol % or less, 21.5 mol % or less, 21 mol % or less, 20.5 mol % or less, or 20 mol % or less. In aspects, the sum of Al₂O₃, MgO, and ZnO in the glass article may be from 12 mol % to 22 mol %, from 13 mol % to 21.5 mol %, from 14 mol % to 21 mol %, from 15 mol % to 20.5 mol %, from 16 mol % to 20 mol %, or any range or subrange therebetween.

In aspects, a sum of Al₂O₃, MgO, CaO, and ZnO present in the glass article (i.e., Al₂O₃ (mol %)+MgO (mol %)+CaO (mol %)+ZnO (mol %)) may be from 12 mol % to 24 mol %. Without wishing to be bound by theory, it is believed that combinations of Al₂O₃, MgO, CaO, and ZnO within this range may aid in avoiding the formation of undesired crystal phases in the glass article. In addition, a relatively high concentration of high field strength modifiers, for example Mg, Ca, and Zn cations, may also improve the mechanical properties, for example fracture toughness, elastic modulus, and drop test performance, of the resultant colored glass article. In aspects, a sum of Al₂O₃, MgO, CaO, and ZnO in the glass article may be from 12 mol % to 24 mol %. In aspects, the sum of Al₂O₃, MgO, CaO, and ZnO in the glass article may be 12 mol % or more, 13 mol % or more, 14 mol % or more, 15 mol % or more, 16 mol % or more, 24 mol % or less, 23 mol % or less, 22 mol % or less, 21.5 mol % or less, 21 mol % or less, 20.5 mol % or less, or 20 mol % or less. aspects, the sum of Al₂O₃, MgO, CaO, and ZnO in the glass article may be from 12 mol % to 24 mol %, from 13 mol % to 23 mol %, from 13 mol % to 22 mol %, from 14 mol % to 21.5 mol %, from 14 mol % to 21 mol %, from 15 mol % to 20.5 mol %, from 16 mol % to 20 mol %, or any range or subrange therebetween.

In aspects, the glass article may optionally include Cl, which may enable growth of particular crystal phases containing colorant. For example, when the colorant package included in the glass comprises Au, the inclusion of Cl may enable the growth of certain Au crystals. In aspects, the concentration of Cl in the glass article may be greater than 0 mol %, 0.1 mol % or more, 0.5 mol % or less, or 0.25 mol % or less. In aspects, the concentration of Cl in the glass article may be from greater than 0 mol % to 0.5 mol %, from 0.1 mol % to 0.25 mol %, or any range or subrange therebetween. In aspects, the glass article may be substantially free or free of Cl. In aspects where the colorant package comprises Ag, the glass article can include less than 100 ppm of halides, including Cl.

In aspects, the glass articles described herein may further comprise ZrO₂. Without wishing to be bound by theory, it is believed that ZrO₂ may act as a multivalent species that serves as redox couples to supply oxygen to certain colorants, for example Au, during relatively low-temperature heat treatment, which helps improve retention of the colorant. ZrO₂ may also act as an additional colorant, producing colored glass articles that may be, for example, red in color. In aspects, the glass article may comprise ZrO₂ in an amount of 0.01 mol % or more, 0.1 mol % or more, 0.2 mol % or more 0.25 mol % or more, 0.5 mol % or more, 0.75 mol % or more, 1 mol % or more, 2 mol % or less, 1.75 mol % or less, 1.5 mol % or less, 1 mol % or less, or 0.5 mol % or less. In aspects, the glass article may comprise ZrO₂ in an amount from 0.01 mol % to 2 mol %, from 0.1 mol % to 1.75 mol %, from 0.2 mol % to 1.5 mol %, from 0.25 mol % to 1.25 mol %, from 0.5 mol % to 1 mol %, from 0.75 mol % to 1 mol %, or any range or subrange therebetween.

In aspects, the glass compositions and the resultant colored glass articles described herein may further comprise Fe₂O₃, which may help improve colorant retention. Fe₂O₃ is a multivalent species that serves as redox couples to supply oxygen to certain colorants, for example Au, during relatively low-temperature heat treatment, which helps improve retention of the colorant. Fe₂O₃ may also act as a colorant, producing colored glass articles that may, for example, be pink or red in color. In aspects, the glass article may comprise Fe₂O₃ in an amount of greater than 0 mol %, 0.01 mol % or more, 0.05 mol % or more, 0.1 mol % or more, 1 mol % or more, 1 mol % or less, 0.75 mol % or less, 0.5 mol % or less, 0.25 mol % or less, or 0.1 mol % or less. In aspects, the glass article may comprise Fe₂O₃ in an amount from greater than 0 mol % to 1 mol %, from 0.01 mol % to 0.75 mol %, from 0.05 mol % to 0.5 mol %, from 0.1 mol % to 0.25 mol %, or any range or subrange therebetween. In aspects, the glass article may comprise Fe₂O₃ in an amount of 200 parts-per-million (ppm) or more, 250 ppm or more, 300 ppm or more, 350 ppm or more, 400 ppm or less, 1,000 ppm or less, 600 ppm or less, 550 ppm or less, 500 ppm or less, or 450 ppm or less. In aspects, the glass article can comprise Fe₂O₃ in an amount from 200 ppm to 1,000 ppm, from 300 ppm to 600 ppm, from 350 ppm to 550 ppm, from 400 ppm to 500 ppm, or any range or subrange therebetween. In aspects, the glass article may be substantially free or free of Fe₂O₃.

In aspects, the glass compositions and the resultant colored glass articles described herein may further comprise SnO₂, Sb₂O₃, and/or Bi₂O₃. Like MgO and ZnO, SnO₂, Sb₂O₃, and Bi₂O₃ may help lower the melting point of the glass composition. Accordingly, SnO₂, Sb₂O₃, and/or Bi₂O₃ may be included in the glass articles to lower the melting point and improve colorant retention. In aspects in which the colorant package includes Ag, SnO₂ also aids in the reduction of Ag in the glass leading to the formation of silver particles in the glass. Without wishing to be bound by theory, in aspects where the colorant package includes Au, it is believed that additions of SnO₂ may also aid in the reduction of Au in the glass, leading to the formation of gold particles. In aspects that include SnO₂ and/or Sb₂O₃, the SnO₂ and/or Sb₂O₃ may also function as a fining agent.

In aspects, the glass article may comprise SnO₂ in an amount of greater than 0 mol %, 0.01 mol % or more, 0.05 mol % or more, 0.1 mol % or more, 0.25 mol % or more, 1 mol % or less, 0.75 mol % or less, 0.5 mol % or less, 0.25 mol % or less, or 0.1 mol % or less. In aspects, the glass article may comprise SnO₂ in an amount from greater than 0 mol % to 1 mol %, from 0.01 mol % to 0.75 mol %, from 0.05 mol % to 0.5 mol %, from 0.1 mol % to 0.25 mol %, or any range or subrange therebetween. In aspects, the glass article may be substantially free or free of SnO₂.

In aspects, the concentration of Sb₂O₃ in the glass article may be greater than 0 mol %, 0.01 mol % or more, 0.05 mol % or more, 0.1 mol % or more, 1 mol % or less, 0.75 mol % or less, 0.5 mol % or less, 0.25 mol % or less, or 0.1 mol % or less. In aspects, the concentration of Sb₂O₃ in the glass article may be from greater than 0 mol % to 1 mol %, from 0.01 mol % to 0.75 mol %, from 0.05 mol % to 0.5 mol %, from 0.1 mol % to 0.25 mol %, or any range or subrange therebetween. In aspects, the glass article may be substantially free or free of Sb₂O₃. In aspects, the glass article can comprise Sb₂O₃ in an amount from 0.01 wt % to 0.5 wt %, from 0.02 wt % to 0.4 wt %, from 0.05 wt % to 0.3 wt %, from 0.1 wt % to 0.2 wt %, or any range or subrange therebetween.

In aspects, the concentration of Bi₂O₃ in the glass article may be greater than 0 mol %, 0.01 mol % or more, 0.05 mol % or more, 0.1 mol % or more, 1 mol % or less, 0.75 mol % or less, 0.5 mol % or less, 0.25 mol % or less, or 0.1 mol % or less. In aspects, the concentration of Bi₂O₃ in the glass article may be from greater than 0 mol % to 1 mol %, from 0.01 mol % to 0.75 mol %, from 0.05 mol % to 0.5 mol %, from 0.1 mol % to 0.25 mol %, or any range or subrange therebetween. In aspects, the glass article may be substantially free or free of Bi₂O₃.

In aspects, the concentration of SO₃ in the glass article may be 0.1 mol % or less, 0.01 mol % or less, or 0.001 mol % or less. In aspects, the glass article may be substantially free or free of SO₃.

In aspects, the glass articles described herein may further comprise a reduced concentration or be substantially free or free of P₂O₅. In aspects where P₂O₅ is included, the P₂O₅ may enhance the ion exchange characteristics of the resultant colored glass article. However, an increased concentration (i.e., greater than 1 mol %) of P₂O₅ may reduce the retention of one or more colorants in the colorant package. Without wishing to be bound by theory, it is believed that P₂O₅ may be more volatile than other glass network formers, for example SiO₂, which may contribute to reduced retention of colorants in the colorant package. In aspects, the concentration of P₂O₅ in the glass article may comprise be greater than 0 mol %, 0.1 mol % or more, 0.25 mol % or more, 1 mol % or less, 0.75 mol % or less, 0.5 mol % or less, or 0.25 mol % or less. In aspects, the concentration of P₂O₅ in the glass article may comprise be from greater than 0 mol % to 1 mol %, from 0.1 mol % to 0.75 mol %, from 0.25 mol % to 0.5 mol %, or any range or subrange therebetween. In aspects, the glass article may be substantially free or free of P₂O₅.

In aspects, the glass articles can comprise at least one colorant in a colorant package that functions to impart a desired color to the glass article. In aspects, the colorant package may comprise at least one of Au, Ag, Cr₂O₃, transition metal oxides (e.g., CuO, NiO, Co₃O₄, TiO₂, Cr₂O₃), rare earth metal oxides (e.g., CeO₂), and/or combinations thereof. In aspects, the glass articles may be from 0.01 mol % to 10 mol % of colorant (i.e., the sum of all colorants in the colorant package). In aspects, the concentration of the colorant package in the glass article may be 0.01 mol % or more, 0.03 mol % or more, 0.06 mol % or more, 0.1 mol % or more, 0.2 mol % or more, 0.3 mol % or more, 0.5 mol % or more, 1 mol % or more, 10 mol % or less, 9 mol % or less, 88 mol % or less, 7 mol % or less, 6 mol % or less, 5 mol % or less, 4.5 mol % or less, 4 mol % or less, 3.5 mol % or less, 3 mol % or less, 2.5 mol % or less, 2 mol % or less 1.5 mol % or less 1 mol % or less, 0.5 mol % or less. In aspects, the concentration of the colorant package in the glass article may be from 0.01 mol % to 10 mol %, from 0.01 mol % to 9 mol %, from 0.03 mol % to 8 mol %, from 0.03 mol % to 7 mol %, from 0.06 mol % to 6 mol %, from 0.06 mol % to 5 mol %, from 0.10 mol % to 4 mol %, from 0.10 mol % to 3 mol %, from 0.2 mol % to 2 mol %, from 0.2 mol % to 1.5 mol %, from 0.3 mol % to 1 mol %, from 0.3 mol % to 0.5 mol %, or any range or subrange therebetween. In aspects, the concentration of the colorant package in the glass article may be from 0.01 mol % to 1 mol %, from 0.03 mol % to 0.5 mol %, or from 0.0.6 mol % to 0.25 mol %.

In aspects, the colorant package in the glass compositions and the resultant colored glass articles may include colorants that comprise or consist of transition metal oxides, rare earth oxides, or combinations thereof, to achieve a desired color. In aspects, transition metal oxides and/or rare earth oxides may be included in the glass compositions as the sole colorant or in combination with other colorants. In aspects, colorants based on transition metal oxides and/or rare earth oxides may include NiO, Co₃O₄, Cr₂O₃, CuO, CeO₂, TiO₂, and/or combinations thereof. In aspects, colorants based on transition metal oxides and/or rare earth oxides may further include oxides of V, Mn, Fe, Cu, Zr, Nb, Mo, Tc, Ru, Rh, Pd, Cd, Hf, Ta, W, Re, Os, Ir, Pt, Pr, Nd, Sm, Eu, Gd, Tb, Dy, Ho, and Er.

In aspects, in addition to CuO, the glass article may comprise a concentration of NiO+Co₃O₄+Cr₂O₃+CuO+CeO₂+TiO₂ of greater than 0 mol %, 0.001 mol % or more, 0.01 mol % or more, 0.02 mol % or more, 0.1 mol % or more, 0.5 mol % or more, 0.7 mol % or more, 0.9 mol % or more, 5 mol % or less, 4 mol % or less, 3 mol % or less, 2.5 mol % or less, 2 mol % or less, 1.5 mol % or less, 1.3 mol % or less, 1 mol % or less, 0.75 mol % or less, 0.5 mol % or less, or 0.25 mol % or less. In aspects, the glass article may comprise a concentration of NiO+Co₃O₄+Cr₂O₃+CuO+CeO₂+TiO₂ can range from greater than 0 mol % to 5 mol %, from 0.001 mol % to 4 mol %, from 0.01 mol % to 3 mol %, from 0.02 mol % to 2.5 mol %, from 0.1 mol % to 2 mol %, from 0.5 mol % to 1.5 mol %, from 0.7 mol % to 1.2 mol %, from 0.9 mol % to 1.3 mol %, or any range or subrange therebetween. In aspects, the glass composition and resultant glass article may comprise 0 mol % of one or more of NiO, Co₃O₄, Cr₂O₃, CuO, CeO₂, and/or TiO₂.

In aspects, the glass article may comprise a concentration of TiO₂ of greater than 0 mol %, 0.01 mol % or more, 0.1 mol % or more, 0.2 mol % or more, 0.3 mol % or more, 2 mol % or less, 1.5 mol % or less, 1 mol % or less, 0.75 mol % or less, 0.5 mol % or less, or 0.4 mol % or less. In aspects, the glass article may comprise a concentration of TiO₂ from greater than 0 mol % to 2 mol %, from 0.01 mol % to 1.5 mol %, from 0.1 mol % to 1 mol %, from 0.2 mol % to 0.75 mol %, from 0.3 mol % to 0.5 mol %, from 0.3 mol % to 0.4 mol %, or any range or subrange therebetween.

In aspects, the glass article may comprise a concentration of CeO₂ of 0.1 mol % or more, 0.2 mol % or more, 0.3 mol % or more, 2 mol % or less, 1.5 mol % or less, 1 mol % or less, 0.75 mol % or less, 0.5 mol % or less, or 0.4 mol % or less. In aspects, the glass article may comprise a concentration of CeO₂ from 0.1 mol % to 2 mol %, from 0.2 mol % to 1.5 mol %, from 0.2 mol % to 1 mol %, from 0.3 mol % to 0.75 mol %, from 0.3 mol % to 0.5 mol, from 0.3 mol % to 0.4 mol %, or any range or subrange therebetween.

In aspects, the glass article may comprise a concentration of NiO of greater than 0 mol %, 0.01 mol % or more, 0.015 mol % or more, 0.02 mol % or more, 0.05 mol % or more, 0.1 mol % or more, 0.3 mol % or less, 0.25 mol % or less, 0.2 mol % or less, 0.05 mol % or less, 0.04 mol % or less, 0.035 mol % or less, 0.03 mol % or less, 0.025 mol % or less, 0.02 mol % or less, or 0.015 mol % or less. In aspects, the glass article may comprise a concentration of NiO can be from greater than 0 mol % to 0.05 mol %, from 0.01 mol % to 0.04 mol %, from 0.01 mol % to 0.035 mol %, from 0.015 mol % to 0.03 mol %, from 0.02 mol % to 0.025 mol %, or any range or subrange therebetween. In aspects, the glass article may comprise a concentration of NiO can be from greater than 0.01 mol % to 0.3 mol %, from 0.02 mol % to 0.3 mol %, from 0.05 mol % to 0.25 mol %, from 0.1 mol % to 0.25 mol %, from 0.15 mol % to 0.2 mol %, or any range or subrange therebetween.

In aspects, the glass article may comprise a concentration of CuO of greater than 0 mol %, 0.1 mol % or more, 0.15 mol % or more, 0.5 mol % or less, 0.4 mol % or less, 0.35 mol % or less, 0.3 mol % or less, 0.25 mol % or less, 0.2 mol % or less, or 0.15 mol % or less. In aspects, the glass article may comprise a concentration of CuO from greater than 0 mol % to 0.5 mol %, from 0.1 mol % to 0.4 mol % from 0.1 mol % to 0.35 mol %, from 0.15 mol % to 0.3 mol %, from 0.15 mol % to 0.25 mol %, from 0.15 mol % to 0.2 mol %, or any range or subrange therebetween.

In aspects, the glass article may comprise from greater than 0 mol % to 2 mol % Co₃O₄ as a colorant in addition to Cr₂O₃. In aspects, the concentration of Co₃O₄ in the glass article may be greater than 0 mol %, 0.001 mol % or more, 0.005 mol % or more, 0.01 mol % or more, 2 mol % or less, 1.5 mol % or less, 1 mol % or less, 0.5 mol % or less, 0.1 mol % or less, or 0.05 mol % or less. In aspects, the concentration of Co₃O₄ in the glass article may be from greater than 0 mol % to 2 mol %, from 0.001 mol % to 1.5 mol %, from 0.001 mol % to 1 mol %, from 0.005 mol % to 0.5 mol %, from 0.005 mol % to 0.1 mol %, from 0.01 mol % to 0.05 mol %, or any range or subrange therebetween.

In aspects, the glass article may comprise a concentration of Cr₂O₃ of greater than 0 mol %, 0.01 mol % or more, 0.015 mol % or more, 0.02 mol % or more, or 0.05 mol % or less, 0.04 mol % or less, 0.035 mol % or less, 0.035 mol % or less, 0.03 mol % or less, 0.025 mol % or less, 0.02 mol % or less, 0.015 mol % or less, or 0.01 mol % or less. In aspects, the glass article may comprise a concentration of Cr₂O₃ from greater than 0 mol % to 0.05 mol %, from 0.01 mol % to 0.04 mol %, from 0.01 mol % to 0.035 mol %, from 0.015 mol % to 0.03 mol %, from 0.02 mol % to 0.025 mol %, or any range or subrange therebetween.

In aspects, the colorant package in the glass compositions and the resultant colored glass articles may comprise or consist of Au as a colorant to achieve a desired color. In aspects, Au may be included in the glass compositions as the sole colorant or in combination with other colorants. As described herein, in aspects, the glass compositions and the resultant colored glass articles may be formulated to improve the retention of Au, thereby expanding the color gamut achievable in the resultant colored glass articles. In aspects, the glass article may comprise a concentration of Au of 0.0005 mol % or more, 0.001 mol % or more, 0.002 mol % or more, 0.005 mol % or more, 0.01 mol % or more, 1 mol % or less, 0.75 mol % or less, 0.5 mol % or less, 0.25 mol % or less, 0.1 mol % or less, or 0.05 mol % or less. In aspects, the glass article may comprise a concentration of Au from 0.0005 mol % to 1 mol %, from 0.001 mol % to 0.75 mol %, from 0.002 mol % to 0.5 mol %, from 0.005 mol % to 0.25 mol %, from 0.01 mol % to 0.1 mol %, from 0.01 mol % to 0.05 mol %, or any range or subrange therebetween. In aspects, the glass article may comprise a concentration of Au of 1 ppm or more, 5 ppm or more, 10 ppm or more, 15 ppm or more, 100 ppm or more, 500 ppm or more, 1,000 ppm or more, 1 mol % or less, 0.75 mol % or less, 0.5 mol % or less, 10,000 ppm or less, 2,000 ppm or less, 1,000 ppm or less, 500 ppm or less, 100 ppm or less, 50 ppm or less, or 20 ppm or less. In aspects, the glass article may comprise a concentration of Au from 1 ppm to 10,000 ppm, from 1 ppm to 2,000 ppm, from 5 ppm to 1,000 ppm, from 5 ppm to 500 ppm, from 10 ppm to 100 ppm, from 15 ppm to 50 ppm, or any range or subrange therebetween. A different color gamut may be achieved by including secondary colorants in addition to Au. For example, in aspects, the glass composition and resultant colored glass article may comprise greater than or equal to 0 mol % and less than or equal to 1 mol % of a cation “M”, wherein “M” is at least one of F, Cl, Br, Ti, V, Cr, Mn, Fe, Co, Ni, Cu, Se, Nb, Mo, Ru, Rh, Pd, Ag, Cd, In, Te, W, Ir, Pt, Ce, Pr, Nd, Sm, Eu, Gd, Tb, Dy, Ho, and Er.

In aspects, R₂O+R′O—Al₂O₃ in the glass article may be from 0.5 mol % to 6 mol % or from 1 mol % to 5.5 mol %. In aspects, R₂O+R′O—Al₂O₃ in the glass article may be 0.5 mol % or more, 1 mol % or more, 1.5 mol % or more, 2 mol % or more, 6 mol % or less, 5.5 mol % or less, 5 mol % or less, 4.5 mol % or less, 4 mol % or less, 3.5 mol % or less, 3 mol % or less, or 2.5 mol % or less. In aspects, R₂O+R′O—Al₂O₃ in the glass article may be from 0.5 mol % to 6 mol %, from 0.5 mol % to 5.5 mol %, from 1 mol % to 5 mol %, from 1 mol % to 4.5 mol %, from 1.5 mol % to 4 mol %, from 1.5 mol % to 3.5 mol %, from 2 mol % to 3 mol %, from 2 mol % to 2.5 mol %, or any range or subrange therebetween.

In aspects, the colorant package used in the glass compositions and the resultant colored glass articles may comprise or consist of Ag as a colorant to achieve a desired color. As described herein, in aspects, the glass compositions and the resultant colored glass articles may be formulated to improve the retention of Ag, thereby expanding the color gamut achievable in the resultant colored glass articles. In aspects, Ag may be included in the glass compositions in combination with other colorants. In aspects where Ag is utilized as a colorant in the glass composition, the color is created by the presence of anisotropic silver particles in the colored glass article that are formed from the reduction of silver ions in the glass composition. Accordingly, in aspects, the glass article may comprise a concentration of Ag from 0.01 mol % to 5 mol %. In aspects, the glass article may comprise a concentration of Ag of 0.01 mol % or more, 0.05 mol % or more, 0.1 mol % or more, 5 mol % or less, 2.5 mol % or less, 1 mol % or less, 0.75 mol % or less, 0.5 mol % or less, 0.25 mol % or less. In aspects, the concentration of Ag in the glass article may be from 0.01 mol % to 5 mol %, from 0.01 mol % to 2.5 mol %, from 0.05 mol % to 1 mol %, from 0.05 mol % to 0.75 mol %, from 0.1 mol % to 0.5 mol %, from 0.1 mol % to 0.25 mol %, or any range or subrange therebetween.

Conventionally, isotropic silver particles support a single localized surface plasmon resonance. Isotropic silver particles are the most energetically favorable to form because they have the lowest surface area to volume ratio and, as a result, they are the most common geometry observed in colored glass articles that comprise silver. In contrast, colored glass articles that comprise anisotropic silver particles can produce a much broader range of colors, for example pink, purple, blue, green, brown, and black. As used herein, anisotropic silver particles refer to silver particles having an aspect ratio greater than 1, where the aspect ratio is the ratio of a longest dimension of the particle to a shortest dimension of the particle (e.g., a ratio of the length of the particle to the width of the particle is greater than 1). This is in contrast to an isotropic silver particle in which the aspect ratio is 1. The broader color gamut produced in glasses having anisotropic silver particles is because anisotropic silver particles support two distinct plasmonic modes: a higher energy transverse mode, and a lower energy longitudinal mode. These two distinct plasmonic modes can be observed via absorption spectra of the colored glass articles, which typically have at least two distinct peaks when anisotropic silver particles are present in the glass. By varying the aspect ratio of anisotropic particles, the resonant absorption of these two plasmonic modes can be tuned and, as a result, the color shifted.

Throughout the disclosure, fracture toughness (K_{IC}) represents the ability of a glass composition to resist fracture. Fracture toughness is measured on a non-strengthened glass article, such as measuring the K_{IC} value prior to ion exchange (IOX) treatment of the glass article, thereby representing a feature of a glass substrate prior to IOX. The fracture toughness test methods described herein are not suitable for glasses that have been exposed to IOX treatment. Accordingly, where the fracture toughness of an ion exchanged article is referred to, it means the fracture toughness of a non-ion exchanged article with the same composition and microstructure (when present) as the center (i.e., a point located at least 0.5t from every surface of the article or substrate where t is the thickness of the article or substrate) of the ion exchanged article (which corresponds to the portion of the ion exchanged article least affected by the ion exchange process and, hence, a composition and microstructure comparable to a non-ion exchanged glass). Fracture toughness is measured by the chevron notched short bar method. The chevron notched short bar (CNSB) method is disclosed in Reddy, K. P. R. et al., “Fracture Toughness Measurement of Glass and Ceramic Materials Using Chevron-Notched Specimens,” J. Am. Ceram. Soc., 71 [6], C-310-C-313 (1988) except that Y*m is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

In aspects, the glass articles formed from the glass compositions described herein may have an increased fracture toughness such that the colored glass articles are more resistant to damage. In aspects, the glass article may have a K_{IC} fracture toughness as measured by a CNSB method, prior to ion exchange, of 0.7 MPa·m^{1/2} or more, 0.8 MPa·m^{1/2} or more, 0.9 MPa·m^{1/2} or more, or 1.0 MPa·m^{1/2} or more. In aspects, the glass article 350 and/or 511 formed from the glass compositions described herein may have an increased fracture toughness such that the colored glass articles are more resistant to damage. In aspects, the glass article 350 and/or 511 may have a K_{IC} fracture toughness as measured by the DCB method, prior to ion exchange, of 0.6 MPa·m^{1/2} or more, 0.7 MPa·m^{1/2} or more, 0.8 MPa·m^{1/2} or more, 0.9 MPa·m^{1/2} or more, 1.0 MPa·m^{1/2} or more.

Throughout the disclosure, the dielectric constant of the glass article is measured using a split post dielectric resonator (SPDR) at a frequency of 10 GHz. The dielectric constant was measured on samples of the glass article having a length of 3 inches (76.2 mm), a width of 3 inches (76.2 mm), and a thickness of less than 0.9 mm. In aspects, the glass article 350 and/or 511 comprises a dielectric constant Dk at 10 GHz of 6.4 or less, 6.3 or less, 6.2 or less, 6.1 or less, 6 or less, 5.6 or more, 5.7 or more, 5.8 or more, 5.9 or more, or 6.0 or more. In aspects, the glass article 350 and/or 511 comprises a dielectric constant Dk at 10 GHz in a range from 5.6 to 6.4, from 5.7 to 6.3, from 5.8 to 6.2, from 5.9 to 6.1, from 5.9 to 6, or any range or subrange therebetween. In aspects, the dielectric constant at frequencies from 10 GHz to 60 GHz (e.g., from 26 GHz to 40 GHz) can be within one or more of the above-mentioned ranges. Without wishing to be bound by theory, it is believed that the dielectric constant of the glass article measured at 10 GHz approximates the dielectric constant at frequencies from 10 GHz to 60 GHz. Accordingly, a dielectric constant reported for a colored glass article at a frequency of 10 GHz approximates the dielectric constant of the colored glass article at frequencies in a range from 10 GHz to 60 GHz, inclusive of endpoints.

The glass article 350 and/or 511 can comprise a glass-based substrate, and the first major surface 332 and/or second major surface 330 can comprise one or more compressive stress regions. In aspects, a compressive stress region may be created by chemically strengthening. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the glass article 350 and/or 511 can enable good impact and/or puncture resistance (e.g., resists failure for a pen drop height of 20 centimeters). Without wishing to be bound by theory, chemically strengthening the glass article 350 and/or 511 can enable small (e.g., smaller than 10 mm or less) bend radii because the compressive stress from the chemical strengthening can counteract the bend-induced tensile stress on the outermost surface of the substrate. A compressive stress region may extend into a portion of the first portion and/or second portion for a depth called the depth of compression. As used herein, depth of compression means the depth at which the stress in the chemically-strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than 400 μm, SCALP is used to measure the depth of compression and central tension (CT). Where the stress in the substrate and/or portion is generated by exchanging both potassium and sodium ions into the substrate and/or portion, and the article being measured is thicker than 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force-balanced and calibrated to the maximum central tension value provided by a SCALP measurement. As used herein, “depth of layer” (DOL) means the depth that the ions have exchanged into the substrate and/or portion (e.g., sodium, potassium). Through the disclosure, when the maximum central tension cannot be measured directly by SCALP (as when the article being measured is thinner than 400 μm) the maximum central tension can be approximated by a product of a maximum compressive stress and a depth of compression divided by the difference between the thickness of the substrate and twice the depth of compression, wherein the compressive stress and depth of compression are measured by FSM. Throughout the disclosure, an absolute value of compressive stress is reported as compressive stress, and an absolute value of central tensile stress is reported as central tensile stress.

In aspects, a first compressive stress region can extend from the first major surface 332 of the glass article 350 and/or 511 to a first depth of compression from the first major surface 332. In further aspects, the first compressive stress region can also comprise a first depth of layer of one or more alkali metal ions (e.g., potassium) associated with the first compressive stress region. In aspects, a second compressive stress region can extend from the second major surface 330 of the glass article 350 and/or 511 to a second depth of compression from the second major surface 330. In further aspects, the second compressive stress region can also comprise a second depth of layer of one or more alkali metal ions (e.g., potassium) associated with the first compressive stress region. As used herein, the depth of compression corresponds to a location (e.g., plane) where a stress in the glass article switches from compressive to tensile (or visa versa) corresponding to a boundary (i.e., depth of compression) of the corresponding compressive stress region. It is to be understood that the first compressive stress region and/or the second compressive stress region of the glass article 350 and/or 511 of the consumer electronic device 100 and/or 310 can also be present in other devices.

In aspects, the glass article 350 and/or 511 can comprise a first compressive stress region extending to a first depth of compression from the first major surface 332 and/or 513. In aspects, the glass article 350 and/or 511 can comprise a second compressive stress region extending to a second depth of compression from the second major surface 330 and/or 515. In aspects, the first depth of compression and/or the second depth of compression as a percentage of the substrate thickness 337 and/or 517 can be 5% or more, 10% or more, 12% or more, 15% or more, 30% or less, 25% or less, 22% or less, 20% or less, 17% or less, or 15% or less. In aspects, the first depth of compression and/or the second depth of compression as a percentage of the substrate thickness 337 and/or 517 can be in a range from 5% to 30%, from 10% to 25%, from 10% to 22%, from 12% to 20%, from 12% to 17%, from 15% to 17%, or any range or subrange therebetween. In aspects, the first depth of compression and/or the second depth of compression can be 10 μm or more, 20 μm or more, 30 μm or more, 40 μm or more, 50 μm or more, 60 μm or more, 500 μm or less, 200 μm or less, 150 μm or less, 100 μm or less, 90 μm or less, or 80 μm or less. In aspects, the first depth of compression and/or the second depth of compression can be in a range from 10 μm to 500 μm, from 20 μm to 200 μm, from 30 μm to 150 μm, from 40 μm to 100 μm, from 50 μm to 90 μm, from 60 μm to 80 μm, or any range or subrange therebetween.

In aspects, the glass article 350 and/or 511 can comprise a first depth of layer of one or more alkali-metal ions associated with the first compressive stress region, and/or the glass article 350 and/or 511 can comprise a second depth of layer of one or more alkali-metal ions associated with the second compressive stress region and the second depth of compression. As used herein, the one or more alkali-metal ions of a depth of layer of one or more alkali-metal ions can include sodium, potassium, rubidium, cesium, and/or francium. In aspects, the one or more alkali ions of the first depth of layer of the one or more alkali ions and/or the second depth of layer of the one or more alkali ions comprises potassium. In aspects, the first depth of layer and/or the second depth of layer, as a percentage of the substrate thickness 517, can be 1% or more, 5% or more, 10% or more, 12% or more, 15% or more, 25% or less, 20% or less, 17% or, 15% or less, or 10% or less. In aspects, the first depth of layer and/or the second depth of layer, as a percentage of the substrate thickness 517, can be in a range from 1% to 25%, from 5% to 20%, from 10% to 17%, from 12% to 15%, or any range or subrange therebetween. In aspects, the first depth of layer of the one or more alkali-metal ions and/or the second depth of layer of the one or more alkali-metal ions can be 1 μm or more, 10 μm or more, 15 μm or more, 20 μm or more, 25 μm or more, 30 μm or more, 200 μm or less, 150 μm or less, 100 μm or less, 60 μm or less, 45 μm or less, 30 μm or less, or 20 μm or less. In aspects, the first depth of layer of the one or more alkali-metal ions and/or the second depth of layer of the one or more alkali-metal ions can be in a range from 1 μm to 200 μm, from 1 μm to 150 μm, from 10 μm to 100 μm, from 15 μm to 600 μm, from 20 μm to 45 μm, from 20 μm to 30 μm, or any range or subrange therebetween.

In aspects, the first compressive stress region can comprise a maximum first compressive stress, and/or the second compressive stress region can comprise a maximum second compressive stress. In further aspects, the maximum first compressive stress and/or the maximum second compressive stress can be 100 MegaPascals (MPa) or more, 300 MPa or more, 400 MPa or more, 500 MPa or more, 600 MPa or more, 700 MPa or more, 1,500 MPa or less, 1,200 MPa or less, 1,000 MPa or less, or 800 MPa or less. In further aspects, the maximum first compressive stress and/or the maximum second compressive stress can be in a range from 100 MPa to 1,500 MPa, from 300 MPa to 1,200 MPa, from 400 MPa to 1,000 MPa, from 500 MPa to 1,000 MPa, from 600 MPa to 900 MPa, from 700 MPa to 800 MPa, or any range or subrange therebetween.

In aspects, the glass article 350 and/or 511 can comprise a tensile stress region. In further aspects, the tensile stress region can be positioned between the first compressive stress region and the second compressive stress region. In further aspects, the tensile stress region can comprise a maximum tensile stress. In even further aspects, the maximum tensile stress can be 10 MPa or more, 30 MPa or more, 50 MPa or more, 60 MPa or more, 80 MPa or more, 250 MPa or less, 200 MPa or less, 100 MPa or less, 80 MPa or less, or 60 MPa or less. In even further aspects, the maximum tensile stress can be in a range from 10 MPa to 250 MPa, from 30 MPa to 200 MPa, from 50 MPa to 100 MPa, from 60 MPa to 80 MPa, or any range or subrange therebetween.

As shown in FIGS. 3-5, the glass article 350 and/or 511 can comprise a first major surface 332 and a second major surface 330 opposite the first major surface 332. In aspects, the first major surface 332 can extend along a first plane, and/or the second major surface 330 can extend along a second plane. In further aspects, the second plane (second major surface 330) can be parallel to the first plane (first major surface 332). As used herein, a substrate thickness 337 of the glass article 350 and/or 511 is defined between the first major surface 332 and the second major surface 330 as an average distance therebetween. In aspects, the glass article 350 and/or 511 can be an ultra-thin substrate, meaning that the substrate thickness 337 is 100 micrometers or less. In aspects, the substrate thickness 337 can be 10 micrometers (μm) or more, 15 μm or more, 20 μm or more, 25 μm or more, 30 μm or more, 40 μm or more, 50 μm or more, 60 μm or more, 70 μm or more, 100 μm or less, 95 μm or less, 90 μm or less, 85 μm or less, 80 μm or less, 75 μm or less, 70 μm or less, 60 μm or less, 50 μm or less, 40 μm or less, 30 μm or less, or 25 μm or less. In aspects, the substrate thickness 337 can range from 10 μm to 100 μm, from 15 μm to 95 μm, from 20 μm to 80, from 25 μm to 75 μm, from 30 μm to 70 μm, from 40 μm to 60 μm, from 40 μm to 50 μm, or any range or subrange therebetween. In aspects, the substrate thickness 337 can be 50 μm or more, which can exhibit greater impact resistance and/or puncture resistance than even thinner substrates and reasonable foldability (e.g., at a parallel plate distance of 5 mm-discussed below), for example in a range from 50 μm to 100 μm, from 50 μm to 95 μm, from 50 μm to 90 μm, from 60 μm to 80 μm, from 70 μm to 75 μm, or any range or subrange therebetween. In aspects, the substrate thickness 337 can be 50 μm or less, which can exhibit increased foldability (e.g., at a parallel plate distance of 3 mm or less or 2 mm or less—discussed below) than thicker substrates, for example, in a range from 10 μm to 50 μm, from 15 μm to 50 μm, from 20 μm to 45 μm, from 25 μm to 40 μm, from 30 μm to 40 μm, or any range or subrange therebetween. In aspects, as shown, a local thickness of the glass article 350 and/or 511 can be substantially uniform (e.g., substantially equal to the substrate thickness 337) across the first major surface 332 and/or the second major surface 330.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other.

In aspects, although not shown, the natively colored glass housing can further comprise a coating disposed on the first major surface of the glass article, for example. For example, the coating can be an anti-reflective coating, an anti-glare coating, an easy-to-clean coating, a low-friction coating, an oleophobic coating, a diamond-like coating, a scratch-resistant, coating, an abrasion-resistant coating, a polymeric hard coating, or a combination thereof. A scratch-resistant coating may comprise an oxynitride, for example, aluminum oxynitride or silicon oxynitride with a thickness of 500 micrometers or more. In such aspects, the abrasion-resistant layer may comprise the same material as the scratch-resistant layer. In aspects, a low friction coating may comprise a highly fluorinated silane coupling agent, for example, an alkyl fluorosilane with oxymethyl groups pendant on the silicon atom. In such aspects, an easy-to-clean coating may comprise the same material as the low friction coating. In other aspects, the easy-to-clean coating may comprise a protonatable group, for example an amine, for example, an alkyl aminosilane with oxymethyl groups pendant on the silicon atom. In such aspects, the oleophobic coating may comprise the same material as the easy-to-clean coating. In aspects, a diamond-like coating comprises carbon and may be created by applying a high voltage potential in the presence of a hydrocarbon plasma.

In further aspects, a polymeric hard coating can comprise one or more of an ethylene-acid copolymer, a polyurethane-based polymer, an acrylate resin, and a mercapto-ester resin. Example aspects of ethylene-acid copolymers include ethylene-acrylic acid copolymers, ethylene-methacrylic acid copolymers, and ethylene-acrylic-methacrylic acid terpolymers (e.g., Nucrel, manufactured by DuPont), ionomers of ethylene acid copolymers (e.g., Surlyn, manufactured by DuPont), and ethylene-acrylic acid copolymer amine dispersions (e.g., Aquacer, manufactured by BYK). Example aspects of polyurethane-based polymers include aqueous-modified polyurethane dispersions (e.g., Eleglas®, manufactured by Axalta). Example aspects of acrylate resins that can be UV curable include acrylate resins (e.g., Uvekol® resin, manufactured by Allinex), cyanoacrylate adhesives (e.g., Permabond® UV620, manufactured by Krayden), and UV radical acrylic resins (e.g., Ultrabond windshield repair resin, for example, Ultrabond (45CPS)). Example aspects of mercapto-ester resins include mercapto-ester triallyl isocyanurates (e.g., Norland optical adhesive NOA 61). In further aspects, the polymeric hard coating can comprise ethylene-acrylic acid copolymers and ethylene-methacrylic acid copolymers, which may be ionomerized to form ionomer resins through neutralization of the carboxylic acid residue with typically alkali-metal ions, for example, sodium and potassium, and also zinc. Such ethylene-acrylic acid and ethylene-methacrylic acid ionomers may be dispersed in water and coated onto the substrate to form an ionomer coating. Alternatively, such acid copolymers may be neutralized with ammonia which, after coating and drying liberates the ammonia to reform the acid copolymer as the coating. By providing a coating comprising a polymeric coating, the glass article can comprise low energy fracture. In further aspects, the polymeric hard coating can comprise an optically transparent hard-coat layer. Suitable materials for an optically transparent polymeric hard-coat layer include but are not limited to a cured acrylate resin material, an inorganic-organic hybrid polymeric material, an aliphatic or aromatic hexafunctional urethane acrylate, a siloxane-based hybrid material, and a nanocomposite material, for example, an epoxy and urethane material with nanosilicate. As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. More specifically, suitable materials for an optically transparent polymeric (OTP) hard-coat layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In aspects, an OTP hard-coat layer may consist essentially of an organic polymer material, an inorganic-organic hybrid polymeric material, or aliphatic or aromatic hexafunctional urethane acrylate. In aspects, an OTP hard-coat layer may consist of a polyimide, an organic polymer material, an inorganic-organic hybrid polymeric material, or aliphatic or aromatic hexafunctional urethane acrylate. In aspects, an OTP hard-coat layer may include a nanocomposite material. In aspects, an OTP hard-coat layer may include a nano-silicate and at least one of epoxy or urethane materials. Suitable compositions for such an OTP hard-coat layer are described in U.S. Pat. Pub. No. 2015/0110990, which is hereby incorporated by reference in its entirety by reference thereto. As used herein, “organic polymer material” means a polymeric material comprising monomers with only organic components. In aspects, an OTP hard-coat layer may comprise an organic polymer material manufactured by Gunze Limited and having a hardness of 9H, for example Gunze's “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. In aspects, the inorganic-organic hybrid polymeric material may include polymerized monomers comprising an inorganic silicon-based group, for example, a silsesquioxane polymer. A silsesquioxane polymer may be, for example, an alkyl-silsesquioxane, an aryl-silsesquioxane, or an aryl alkyl-silsesquioxane having the following chemical structure: (RSiO_{1.5})ₙ, where R is an organic group for example, but not limited to, methyl or phenyl. In aspects, an OTP hard-coat layer may comprise a silsesquioxane polymer combined with an organic matrix, for example, SILPLUS manufactured by Nippon Steel Chemical Co., Ltd. In aspects, an OTP hard-coat layer may comprise 90 wt % to 95 wt % aromatic hexafunctional urethane acrylate, e.g., PU662NT (Aromatic hexafunctional urethane acrylate) manufactured by Miwon Specialty Chemical Co.) and 10 wt % to 5 wt % photo-initiator (e.g., Darocur 1173 manufactured by Ciba Specialty Chemicals Corporation) with a hardness of 8H or more. In aspects, an OTP hard-coat layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate.

In aspects, although not shown, a coating can be disposed over the second major surface 330 of the glass article 350 and/or 511. In even further aspects, a coating thickness of the coating can be 0.1 μm or more, 1 μm or more, 5 μm or more, 10 μm or more, 15 μm or more, 20 μm or more, 25 μm or more, 40 μm or more, 50 μm or more, 60 μm or more, 70 μm or more, 80 μm or more, 90 μm or more, 200 μm or less, 100 μm or less, or 50 μm or less, 30 μm or less, 25 μm or less, 20 μm or less, 20 μm or less, 15 μm or less, or 10 μm or less. In further aspects, the coating thickness of the coating can range from 0.1 μm to 200 μm, from 1 μm to 100 μm, from 10 μm to 100 μm, from 20 μm to 100 μm, from 30 μm to 100 μm, from 40 μm to 100 μm, from 50 μm to 100 μm, from 60 μm to 100 μm, from 70 μm to 100 μm, from 80 μm to 100 μm, from 90 μm to 100 μm, from 0.1 μm to 50 μm, from 1 μm to 50 μm, from 10 μm to 50 μm, or any range or subrange therebetween.

Throughout the disclosure, refractive index is measured in accordance with ASTM E1967-19, where the first wavelength comprises 589 nm. In aspects, the first refractive index of the glass article 350 and/or 511 may be 1.4 or more, 1.45 or more, 1.48 or more, 1.49 or more, 1.50 or more, 1.6 or less, 1.57 or less, or 1.55 or less, 1.53 or less, or 1.52 or less. In aspects, the first refractive index of the glass article 350 and/or 511 can range from 1.4 to 1.6, from 1.45 to 1.57, from 1.48 to 1.55, from 1.49 to 1.53, from 1.50 to 1.52, or any range or subrange therebetween.

In aspects, the glass article, natively colored glass housing, and/or consumer electronic device can be foldable. As used herein, “foldable” includes complete folding, partial folding, bending, flexing, or multiple capabilities. As used herein, the terms “fail,” “failure,” and the like refer to breakage, destruction, delamination, or crack propagation. A foldable apparatus achieves a parallel plate distance of “X,” or withstands a parallel plate distance of “X”, has a parallel plate distance of “X,” or comprises parallel plate distance of “X” if it resists failure when the foldable apparatus is held at parallel plate distance of “X” for 10 minutes at 25° C. and 50% relative humidity. Likewise, a foldable apparatus achieves a parallel plate distance of “X,” or has a parallel plate distance of “X,” or comprises a parallel plate distance of “X” if it resists failure when the foldable apparatus is held at a parallel plate distance of “X” for 10 minutes at 50° C. and 50% relative humidity. In aspects, the foldable substrate and/or the foldable apparatus can be rollable. As used herein, a foldable substrate or a foldable apparatus is “rollable” if it can achieve a threshold parallel plate distance over a length of the corresponding foldable substrate and/or foldable apparatus that is the greater of 10 mm or 10% of the length of the corresponding foldable substrate and/or foldable apparatus. Throughout the disclosure, the “survival rate” or % of samples that can withstand a parallel plate distance of X mm refers to the percentage of at least 20 samples that withstand bending to the parallel distance of X mm.

As used herein, the “parallel plate distance” of a foldable apparatus and/or foldable glass article is measured with the following test configuration and process using a parallel plate apparatus that comprises a pair of parallel rigid stainless-steel plates. When measuring the “parallel plate distance”, the consumer electronic device, glass article, and/or natively colored glass housing is placed between the pair of parallel rigid stainless-steel plates as is (without modification). For determining a “parallel plate distance”, the distance between the parallel plates is reduced at a rate of 1 millimeter per second (mm/sec) until the parallel plate distance is equal to the “parallel plate distance” to be tested. Then, the parallel plates are held at the “parallel plate distance” to be tested for 10 minutes at 85° C. and 85% relative humidity. As used herein, the “minimum parallel plate distance” is the smallest parallel plate distance that the foldable apparatus can withstand without failure under the conditions and configuration described above.

In aspects, the consumer electronic device 100 and/or 310 and/or the glass article 350 and/or 511 can achieve a parallel plate distance of 20 mm or less, 10 mm or less, 7 mm or less, 5 mm or less, 3 mm or less, 2 mm or less, or 1 mm or less. In aspects, the consumer electronic device 100 and/or 310 and/or the glass article 350 and/or 511 can comprise a minimum parallel plate distance of 5 mm or less, 4 mm or less, 3 mm or less, 2 mm or less, or 1 mm or less. In aspects, the consumer electronic device 100 and/or 310 and/or the glass article 350 and/or 511 can comprise a minimum parallel plate distance ranging from 0.5 mm to 5 mm, from 0.5 mm to 4 mm, from 0.5 mm to 3 mm, from 0.5 mm to 2 mm, from 1 mm to 2 mm, or any range or subrange therebetween.

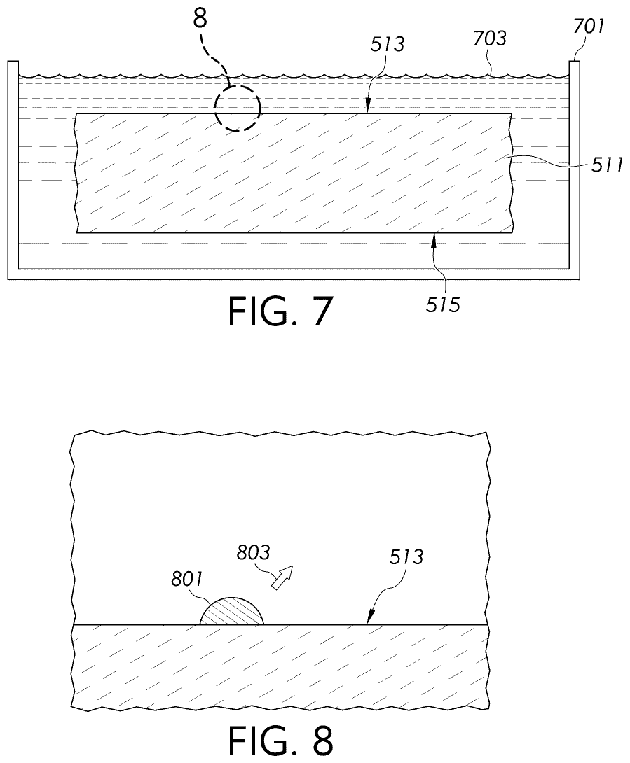

Aspects of methods of chemically strengthening the glass article 350 and/or 511 (e.g., in methods of making the consumer electronic device 100 and/or 310) illustrated in FIGS. 1-5, in accordance with aspects of the disclosure, will be discussed with reference to the flow chart in FIG. 6 and example method steps illustrated in FIGS. 7-11.

In a first step 601 of methods of the disclosure, as shown in FIG. 7, methods can start with providing a glass article 511. In aspects, the glass article 511 may be provided by purchase or otherwise obtaining a substrate or by forming the glass article. In aspects, the glass article 511 can comprise a glass-based material. In further aspects, glass-based material can be provided by forming them with a variety of ribbon forming processes, for example, slot draw, down-draw, fusion down-draw, up-draw, press roll, redraw, or float. In further aspects, glass-based material comprising ceramic crystals can be provided by heating a glass-based material to crystallize one or more ceramic crystals. The glass article 511 may comprise a first major surface 513 and a second major surface 515 opposite the first major surface 513. In further aspects, a thickness of the glass article 511 (defined as an average distance between the first major surface 513 and the second major surface 515) can be within one or more of the ranges discussed above and/or may be within 5 μm of the final thickness (e.g., substrate thickness 337) (i.e., greater than the final thickness by from 0.1 μm to 5 μm or from 0.5 μm to 4 μm). In further aspects, the first major surface 513 and/or the second major surface 515 can extend along a plane. In aspects, the glass article 511 can have a composition within one or more of the ranges discussed above for the glass-based substrate (e.g., glass article 350 and/or 511). In aspects, the glass article can exhibit CIE L*, a*, and/or b* values within one or more of the corresponding ranges discussed above. In aspects, at the end of step 601, the glass article 511 can be substantially unstrengthened. As used herein, substantially unstrengthened refers to a substrate comprising either no depth of layer, no depth of compression, a depth of layer in a range from 0% to 5% of the substrate thickness, or a depth of compression in a range from 0% to 5% of the substrate thickness. In aspects, as discussed above, the glass article 511 can comprise a copper concentration within one or more of the corresponding ranges discussed above (e.g., from 0.01 wt % to 0.5 wt %, from 0.01 wt % to 0.2 wt %, from 0.03 wt % to 0.10 wt %, from 0.03 wt % to 0.06 wt %, or any range or subrange therebetween).

After step 601, methods can proceed to step 603 comprising contacting at least the first major surface 513 with a molten salt solution 703 maintained at a first temperature for a first period of time to develop at least a compressive stress region, as shown in FIG. 7. In aspects, as shown in FIG. 7, the molten salt solution 703 can be contained in a molten salt bath 701. In aspects, as shown in FIG. 7, the contacting at least the first major surface 513 with the molten salt solution 703 can comprise immersing the glass article 511 in the molten salt solution 703, for example with both the first major surface 513 and the second major surface 515 in contact with the molten salt solution 703, although only a portion of the glass article (e.g., first major surface) may contact the molten salt solution in other aspects. Chemically strengthening the glass article 511 by ion exchange can occur when a first cation within a depth of a surface of a glass article 511 is exchanged with a second cation within a molten salt solution 703 that has a larger radius than the first cation. For example, a lithium cation within the depth of the surface of the glass article 511 can be exchanged with a sodium cation or potassium cation within the molten salt solution 703. Similarly, a sodium cation within the depth of the surface of the glass article 511 can be exchanged with a potassium cation within the molten salt solution 703 to develop compressive stress within the glass article 511. Consequently, the surface of the glass article 511 is placed in compression and thereby chemically strengthened by the ion exchange process since the lithium cation has a smaller radius than the radius of the exchanged sodium cation or potassium cation within the molten salt solution 703.

In aspects, the first temperature of the molten salt solution 703 can be 350° C. or more, 360° C. or more, 370° C. or more, 380° C. or more, 390° C. or more, 400° C. or more, 530° C. or less, 500° C. or less, 470° C. or less, 450° C. or less, 430° C. or less, 410° C. or less, 400° C. or less, 390° C. or less, or 380° C. or less. In aspects, the first temperature of the molten salt solution 703 can be in a range from 350° C. to 530° C., from 350° C. to 500° C., from 360° C. to 470° C., from 360° C. to 450° C., from 370° C. to 430° C., from 380° C. to 410° C., from 390° C. to 400° C., or any range or subrange therebetween. In aspects, the first period of time that the glass article 511 (e.g., first major surface 513) is in contact with the molten salt solution 703 can be 10 minutes or more, 15 minutes or more, 20 minutes or more, 30 minutes or more, 45 minutes or more, 60 minutes or more, 90 minutes or more, 8 hours or less, 4 hours or less, 2 hours or less, 1.5 hours or less, 1.0 hour or less, 45 minutes or less, or 30 minutes or less. In aspects, the first period of time that the glass article 511 (e.g., first major surface 513) is in contact with the molten salt solution 703 can be in a range from 10 minutes to 8 hours, from 15 minutes to 4 hours, from 20 minutes to 2 hours, from 30 minutes to 1.5 hours, from 45 minutes to 1.0 hour, or any range or subrange therebetween. In aspects, the first period of time that the glass article 511 (e.g., first major surface 513) is in contact with the molten salt solution 703 can be 30 minutes or less, for example, in a range from 5 minutes to 30 minutes, from 10 minutes to 20 minutes, from 10 minutes to 15 minutes, or any range or subrange therebetween.

In aspects, the molten salt solution 703 can comprise a nitrite salt, a sulfate salt, or combinations thereof that can be used in combination with nitrate salts or other salts. As used herein, “nitrite” refers to NO₂⁻ while “nitrate” refers to NO₃⁻; and “sulfate” refers to SO₄²⁻. In further aspects, the nitrite salt can be an alkali metal nitrite, for example, lithium nitrite, sodium nitrite, or potassium nitrite. An exemplary aspect of the nitrite salt is sodium nitrite (NaNO₂). In further aspects, the nitrite salt can be used in combination with nitrate salts (e.g., the molten salt solution can comprise both sodium nitrite NaNO₂ and sodium nitrate NaNO₃). Additionally or alternatively, the nitrite salt can comprise an alkaline earth metal nitrite (e.g., magnesium nitrite Mg(NO₂)₂, calcium nitrite Ca(NO₂)₂). Providing an alkaline earth metal nitrite can provide a higher concentration of nitrite per mole of the salt than an alkali metal nitrite. In further aspects, a concentration of the nitrite salt, based on a total weight of the molten salt solution, can be 0.5 wt % or more, 0.8 wt % or more, 1.0 wt % or more, 1.2 wt % or more, 1.5 wt % or more, 1.7 wt % or more, 2.0 wt % or more, 2.2 wt % or more, 2.5 wt % or more, 3.0 wt % or more, 10 wt % or less, 8 wt % or less, 6 wt % or less, 5.0 wt % or less, 4.5 wt % or less, 4.0 wt % or less, 3.5 wt % or less, 3.0 wt % or less, 2.5 wt % or less, or 2.0 wt % or less. In further aspects, a concentration of the nitrite salt, based on a total weight of the molten salt solution, can be in a range from 0.5 wt % to 10 wt %, from 0.5 wt % to 8 wt %, from 0.8 wt % to 6 wt %, from 1.0 wt % to 5.0 wt %, from 1.5 wt % to 5.0 wt %, from 2.0 wt % to 5.0 wt %, from 2.0 wt % to 4.5 wt %, from 2.5 wt % to 4.5 wt %, from 2.5 wt % to 4.0 wt %, from 3.0 wt % to 3.5 wt %, or any range or subrange therebetween. In exemplary aspects, a concentration of the nitrite salt, based on a total weight of the molten salt solution, can be in a range from 0.5 wt % to 10 wt %, from 1.0 wt % to 5 wt %, or from 2.0 wt % to 5 wt %. As discussed below, the Examples demonstrate that the ranges recited in this paragraph for the concentration of the nitrite salt can achieve a glass article (containing copper) that has a surface substantially free of copper-containing salt in accordance with the methods of the presence disclosure.

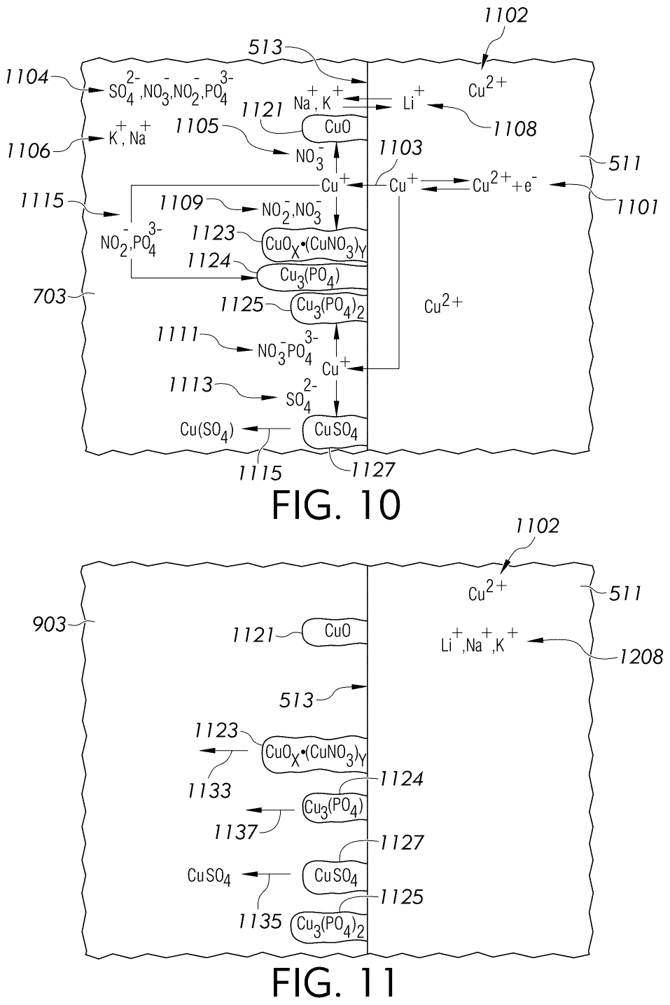

Without wishing to be bound by theory, it is believed that copper ions in the glass article can predominately be in the 2+ oxidation state, and that the copper ions are reduced to the 1+ oxidation state before diffusing out of the glass article since ions with a 1+ oxidation state have greater mobility than ions with a 2+ oxidation state in the glass article. Providing the nitrite salt can preserve the copper ions (outside of the glass article) in the 1+ oxidation state at a surface of the glass article and/or in the molten salt solution. In aspects, during contact with the molten salt solution, a copper-containing salt can be formed at the surface of the glass article, where the copper-containing salt has copper in a 1+ oxidation state. For example, with reference to FIG. 10, reaction 1101 shows the reduction of copper ions 1102 in the 2+ oxidation state in the glass article 511 to the 1+ oxidation state. Reaction 1103 shows that the copper ion in the 1+ oxidation state can diffuse out of the glass article 511 towards the molten salt solution 703. It is to be understood that the reaction 1103 can be coupled with the diffusion of an alkali metal ion 1106 (e.g., sodium, potassium) into the glass article 511, for example, as indicated by the left half of reaction 1108 (e.g., exchanging copper in the glass article for sodium or potassium in the molten salt solution). At the first major surface 513 of the glass article 511, the copper ion in the 1+ oxidation state can be oxidized by nitrate ions in the molten salt solution to form a CuO precipitate (deposit 1121), as indicated by reaction 1105. It is believed that this reaction is largely irreversible in the molten salt solution, and CuO is insoluble in water, which makes it hard to remove CuO precipitates in a subsequent rinsing step (e.g., discussed below with reference to FIG. 11). Alternatively, when the molten salt solution 703 comprises a nitrite salt (e.g., producing nitrite ions), a complex of copper oxide(s) (e.g., Cu(I)₂O and/or Cu(II)O) and/or copper nitrate (e.g., Cu(I)NO₃) as indicated by deposit 1123 can be formed by a reaction 1109 between the copper and the nitrite ions and optionally nitrate ions. It is believed that the complex (deposit 1123) is more readily dissolved in a rinsing step than CuO (e.g., discussed below with reference to FIG. 11) such that the amount of copper-containing salt on the glass article can be reduced and/or removed (e.g., eliminated) after a rinsing step. Similarly, the presence of the nitrite salt (e.g., producing nitrite ions) can form other copper-containing salts that preserve the copper ion in the 1+ oxidation state, for example, reaction 1115 shows that nitrite in combination with another anion (e.g., phosphate) can form the deposit 1124 having copper phosphate with copper in the 1+ oxidation state (Cu(I)₃PO₄) that is more readily dissolved in water than CuO or copper phosphate with copper in the 2+ oxidation state (Cu(II)₃(PO₄)₂) such that the copper-containing salt in the 1+ oxidation state (e.g., Cu(I)₃PO₄) can be removed in a subsequent rinsing step (discussed below with reference to FIG. 11). For example, the solubility product constant (Ksp) for copper phosphate with copper in the 1+ oxidation state is greater than the Ksp for copper phosphate with copper in the 2+ oxidation state by about 30 orders of magnitude (10³⁰). Consequently, providing the nitrite salt in the molten salt solution can facilitate the production of glass articles with reduced and/or no copper-containing salt on the surface and/or low haze.

In aspects, the molten salt solution 703 can comprise a sulfate salt, for example an alkali metal sulfate (e.g., lithium sulfate, sodium sulfate, or potassium sulfate). An exemplary aspect of the sulfate salt is sodium sulfate (NaSO₄). In further aspects, the sulfate salt can be used in combination with nitrate salts (e.g., the molten salt solution can comprise both sodium sulfate NaSO₄ and sodium nitrate NaNO₃). In further aspects, a concentration of the sulfate salt, based on a total weight of the molten salt solution, can be 2.0 wt % or more, 2.2 wt % or more, 2.5 wt % or more, 2.7 wt % or more, 3.0 wt % or more, 3.5 wt % or more, 4.0 wt % or more, 10 wt % or less, 9 wt % or less, 8 wt % or less, 7 wt % or less, 6 wt % or less, 5.0 wt % or less, 4.5 wt % or less, 4.0 wt % or less, 3.5 wt % or less, or 3.0 wt % or less. In further aspects, a concentration of the sulfate salt, based on a total weight of the molten salt solution, can be in a range from 2.0 wt % to 10 wt %, from 2.2 wt % to 9 wt %, from 2.5 wt % to 8 wt %, from 2.5 wt % to 7 wt %, from 2.7 wt % to 6 wt %, from 3.0 wt % to 5.0 wt %, from 3.0 wt % to 4.5 wt %, from 3.5 wt % to 4.0 wt %, or any range or subrange therebetween. In exemplary aspects, a concentration of the sulfate salt, based on a total weight of the molten salt solution, can be in a range from 2.0 wt % to 10 wt %, from 2.5 wt % to 8 wt %, or from 3.0 wt % to 5 wt %. As discussed below, the Examples demonstrate that the ranges recited in this paragraph for the concentration of the sulfate salt can achieve a glass article (containing copper) that has a surface substantially free of copper-containing salt in accordance with the methods of the presence disclosure.

Providing the sulfate salt can form copper sulfate that is more easily dissolved in the molten salt solution and/or subsequent rinsing. In aspects, as discussed above, during contact with the molten salt solution, a copper-containing salt can be formed at the surface of the glass article. As discussed above with reference to FIG. 10, the molten salt solution can have anions 1104 including nitrates, nitrites, sulfates, and phosphates as well as alkali metal ions 1106 (e.g., cations) including sodium and potassium. As shown, copper ions 1102 in the 2+ oxidation state in the glass article 511 can be reduced to the to the 1+ oxidation state (reaction 1101) followed by diffusion (e.g., ion exchange) of the copper ion in the 1+ oxidation state out of the glass article 511 towards the molten salt solution 703 (reaction 1103) while an alkali metal ion 1106 (e.g., sodium, potassium) diffuses into the glass article 511 (left half of reaction 1108). The ion exchange (of alkali meta ions (e.g., Li+) in reaction 1108 and/or copper ions in reaction 1103) can produce a chemically strengthened glass article having a mixture of alkali metal ions 1208 as shown in FIG. 11. At the first major surface 513 of the glass article 511, the copper ion in the 1+ oxidation state can be oxidized by nitrate ions in the molten salt solution to form a CuO precipitate (deposit 1121), as indicated by reaction 1105. It is believed that this reaction is largely irreversible in the molten salt solution, and CuO is insoluble in water, which makes it hard to remove CuO precipitates in a subsequent rinsing step (e.g., discussed below with reference to FIG. 11). Alternatively, when the molten salt solution 703 comprises a sulfate salt (e.g., producing sulfate ions), copper sulfate (CuSO₄) as indicated by deposit 1127 can be formed by a reaction 1113 between the copper and sulfate ions. It is believed that copper sulfate is more readily dissolved in the molten salt solution and in a subsequent rinsing step than CuO (e.g., discussed below with reference to FIG. 11) such that the amount of copper-containing salt on the glass article can be reduced and/or removed (e.g., eliminated) after the chemical strengthening and/or after a subsequent rinsing step. Consequently, providing the sulfate salt in the molten salt solution can facilitate the production of glass articles with reduced and/or no copper-containing salt on the surface and/or low haze.

For comparison, FIG. 10 also shows reaction 1111 between the copper ion in the 1+ oxidation state with a phosphate ion in the molten salt solution to form copper phosphate (Cu₃PO₄) in deposit 1125. The copper phosphate is less soluble than either the copper complex in deposit 1123 (from nitrite salts in the molten salt solution) or copper sulfate in deposit 1127 (from sulfate salts in the molten salt solution). Without wishing to be bound by theory, it is believed that phosphate ions in the molten salt solution can naturally increase if the same molten salt solution is used to chemically strengthen repeated batches of glass articles.

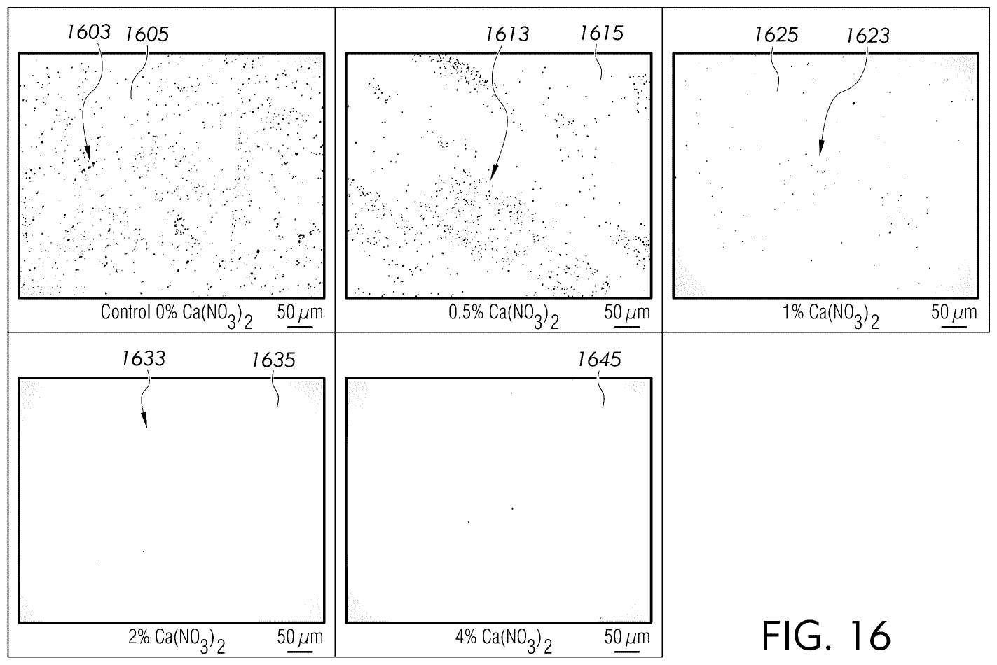

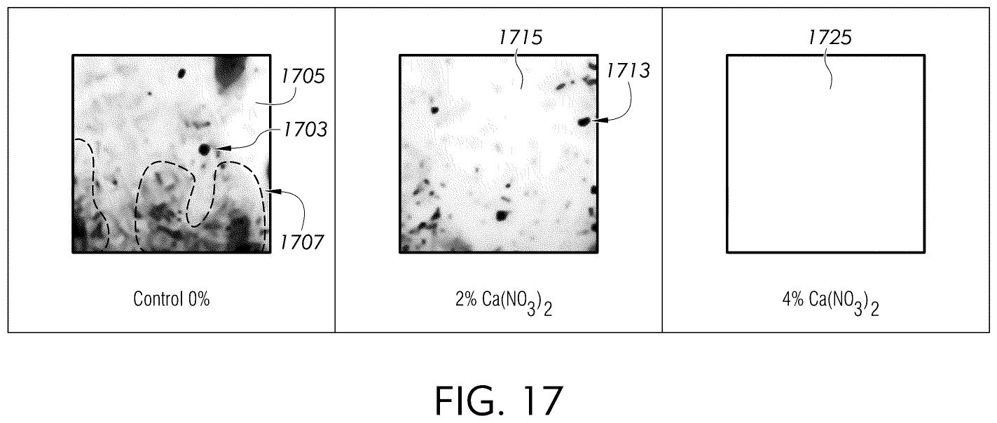

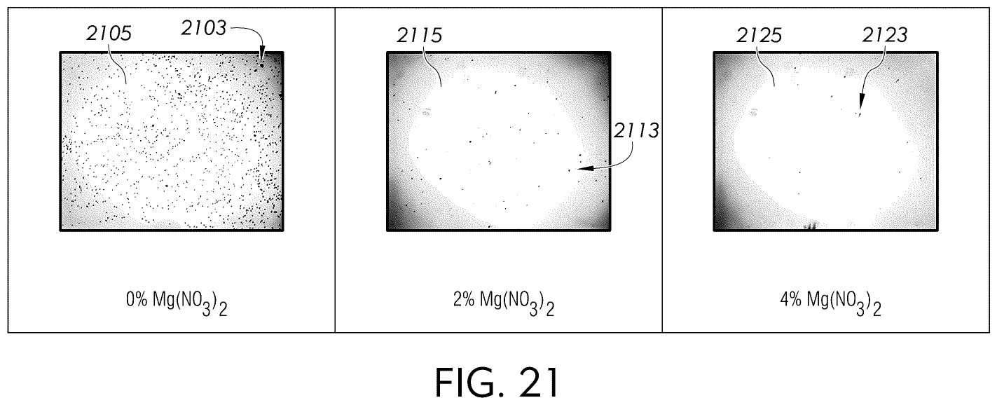

Additionally or alternatively, in aspects, the molten salt solution 703 can comprise a salt of an alkaline earth metal. It is to be understood that the alkaline earth metal can be part of the salt with any anion (e.g., nitrate, nitrite, sulfate, chloride, carbonate). In further aspects, the alkaline earth metal in the salt of the alkaline earth metal can be magnesium or calcium. For example, as discussed in the Examples below, the salt can be magnesium nitrate Mg(NO₃)₂ and/or calcium nitrate Ca(NO₃)₂. In further aspects, a concentration of the salt of the alkaline earth metal, based on a total weight of the molten salt solution, can be 1.0 wt % or more, 1.5 wt % or more, 2.0 wt % or more, 2.2 wt % or more, 2.5 wt % or more, 3.0 wt % or more, 3.5 wt % or more, 4.0 wt % or more, 5.0 wt % or more, 6.0 wt % or more, 7.0 wt % or more, 8.0 wt % or less, 7.5 wt % or less, 7.0 wt % or less, 6.5 wt % or less, 6.0 wt % or less, 5.5 wt % or less, 5.0 wt % or less, 4.5 wt % or less, 4.0 wt % or less, 3.5 wt % or less, 3.0 wt % or less, or 2.5 wt % or less. In further aspects, a concentration of the salt of the alkaline earth metal, based on a total weight of the molten salt solution, can be in a range from 1.0 wt % to 8.0 wt %, from 1.5 wt % to 7.5 wt %, from 2.0 wt % to 7.0 wt %, from 2.5 wt % to 6.5 wt %, from 3.0 wt % to 6.0 wt %, from 3.5 wt % to 5.0 wt %, from 4.0 wt % to 4.5 wt %, or any range or subrange therebetween. In even further aspects, a concentration of the salt of the alkaline earth metal, based on a total weight of the molten salt solution, can be in a range from 1.0 wt % to 8.0 wt %, from 1.5 wt % to 6.0 wt %, from 2.0 wt % to 4.0 wt %, from 2.5 wt % to 3.5 wt %, from 2.5 wt % to 3.0 wt %, or any range or subrange therebetween. In still further aspects, the salt of the alkaline earth metal can be a calcium salt, where the concentration of the salt of the alkaline earth metal can be within one of the ranges in the previous sentences. As demonstrated in FIGS. 16-17 with calcium nitrate as the salt, a noticeable decrease in the copper-containing residue on the surface occurs going from none or 0.5 wt % of the salt of the alkaline earth metal to 1.0 wt % of the salt of the alkaline earth metal; further improves the surface quality to the extent that the surface is either free and/or substantially free of a copper-containing residue (especially any such residue visible with the naked eye) for 2.0 wt % and 4.0 wt % of the salt of the alkaline earth metal. In exemplary aspects, a concentration of the sulfate salt, based on a total weight of the molten salt solution, can be in a range from 1.0 wt % to 8.0 wt %, from 2.0 wt % to 4.0 wt %, or from 2.5 wt % to 3.5 wt %. As demonstrated in FIG. 21, a higher concentration of the salt of the alkaline earth metal oxide can be used to achieve comparable results, where the salt is a magnesium salt—as opposed to having a larger alkaline metal oxide. For example, when the salt of the alkaline earth metal is a magnesium salt, the concentration of the magnesium salt can be from 4.0 wt % to 6.0 wt %, from 4.5 wt % to 5.5 wt %, from 5.0 wt % to 5.5 wt %, or any range or subrange therebetween.

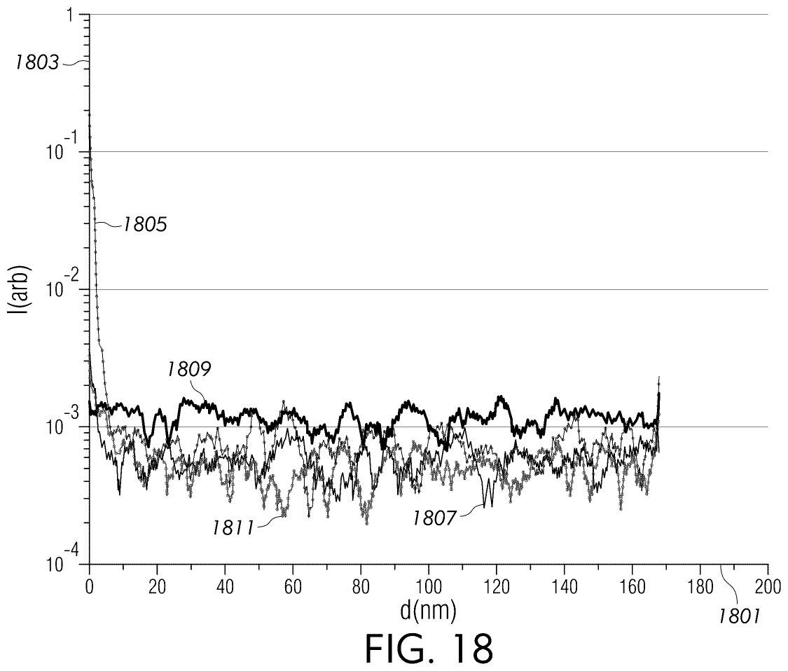

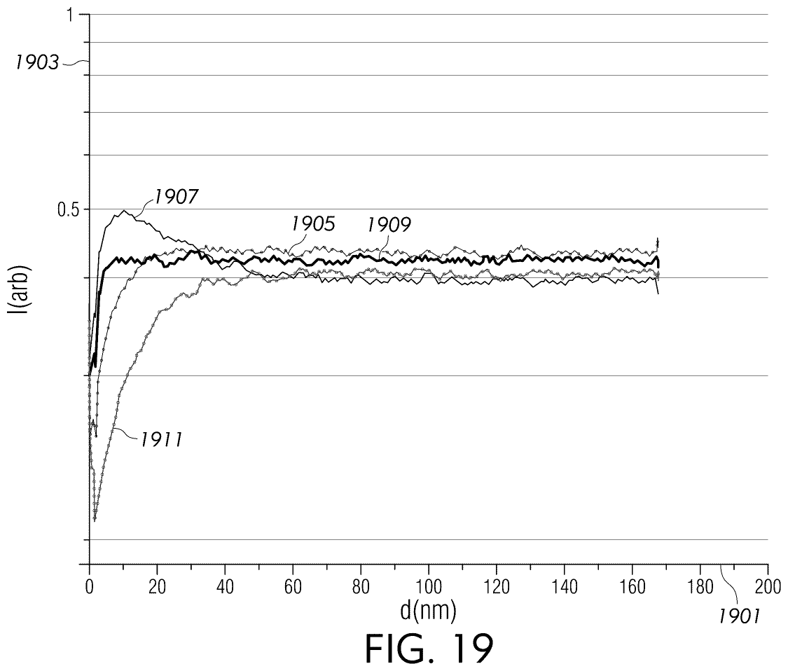

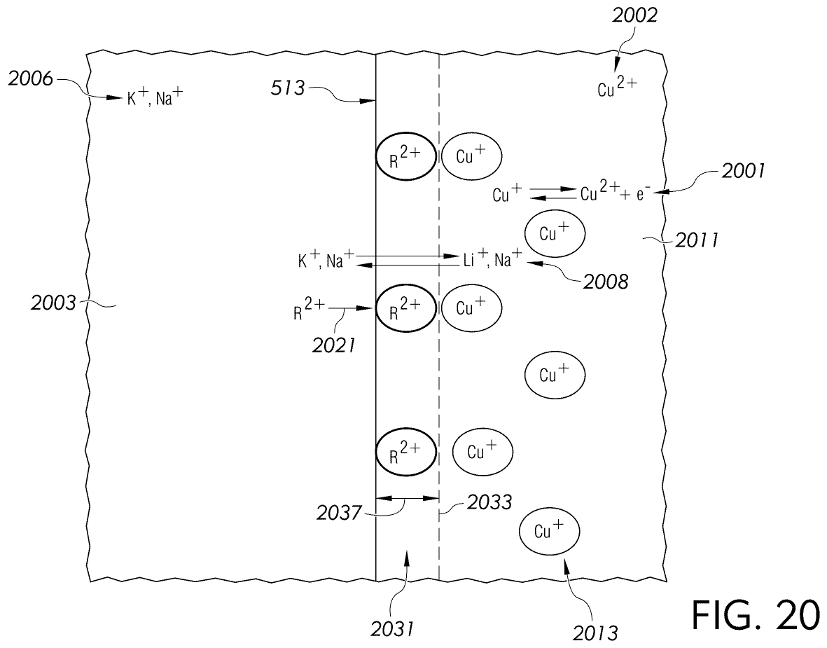

Providing the alkaline earth metal salt in the molten salt solution can prevent and/or inhibit the formation of copper-containing residues on the surface. Without wishing to be bound by theory, it is believed that the alkaline earth metal can be exchanged into a near-surface portion of the copper-containing glass article, where the alkaline earth metal can inhibit diffusion of copper therethrough. For example, with reference to FIG. 20, the molten salt solution 2003 can comprise alkali earth metal salts (e.g., producing sodium and/or potassium cations 2006—Na⁺, K⁺) in addition to the alkaline earth metal salt (e.g., producing alkaline earth metal cations—R²⁺—see reaction 2021). As shown, the alkaline earth metal can diffuse into the glass article 2011 through the first major surface 513 as indicated by reaction 2021. For example, the alkaline earth metal can be ion-exchanged with a pair of alkali metal cations, a near-surface divalent cation, and/or near-surface copper cations. However, the diffusion of the alkaline earth metal into the glass article 2011 can be limited to a near-surface region 2031 having a depth indicated by dashed line 2033 extending to a distance 2037 (e.g., 40 nm or less, 30 nm or less, 20 nm or less 10 nm or less, or 5 nm or less—from 0.1 nm to 40 nm, from 0.5 nm to 30 nm, from 1 nm to 20 nm, from 2 nm to 10 nm, from 3 nm to 5 nm, or any range or subrange therebetween) from the first major surface 513. After the alkaline earth metal cation R²⁺ enters the near-surface region 2031 of the glass article 2011, the alkaline earth metal cation R²⁺ can be restrained by the glass-based network and/or other cations in the glass article due to the high field strength and/or larger size of the alkaline earth metal cation R²⁺. Then, these alkaline earth metal cations R²⁺ in the near surface region can prevent and/or inhibit migration of copper ions 2002 and/or 2013 (Cu²⁺ and/or Cu⁺) due to electrostatic repulsion (due to the 2+ oxidation state of the alkaline earth metal cation R²⁺) and/or the size (e.g., ionic radius) of the alkaline earth metal cation R²⁺. As discussed above, copper ions 2002 in the 2+ oxidation state in the glass article 2011 can be reduced to the to the 1+ oxidation state as copper ions 2013 (see reaction 2001). Both oxidation states of the copper have a relatively large ionic radius with the 1+ oxidation state having a larger ionic radius than the 2+ oxidation state. This means that the alkaline earth metal oxide in the near-surface region 2031 can (selectively) inhibit diffusion of these copper ions (especially Cu⁺) due to the size of the ionic radius. In contrast, the ionic radius of alkali metal ions (e.g., Li⁺, Na⁺, K⁺) is comparatively small relative to copper ions. This allows ion-exchange between the alkali metal (cations) in the glass article 2011 (e.g., Li⁺, Na⁺) and the alkali metal cations 2006 in the molten salt solution 2003 (e.g., Na⁺, K⁺), as indicated by arrow 2008, to occur essentially unobstructed due to their comparatively small ionic radius. In this way, the alkaline earth metal salt in the molten salt solution can selectively prevent and/or inhibit diffusion of copper from within the glass article to the surface (after the corresponding alkaline earth metal cations enter the near-surface region) without impairing ion-exchange of alkali metals. As discussed below, the concentration profiles of copper and calcium (when the alkaline earth metal salt is calcium nitrate) shown in FIGS. 18-19 show that excess calcium (relative to the bulk composition and the control condition shown in curve 1905 in FIG. 19) is limited to a near-surface region of less than 40 nm (see curve 1907 in FIG. 19) while the copper concentration is lower than a control condition (compare curve 1807 and curve 1805 in FIG. 18). In aspects, the alkaline earth metal in the alkaline earth metal salt can have an ionic radius greater than or equal to calcium.

In further aspects, the molten salt solution 703 comprises a potassium salt and/or a sodium salt. In even further aspects, a portion of the potassium salt and/or the sodium salt can include a nitrite and/or a sulfate in addition to nitrates (or other anions). For example, the molten salt solution can comprise be or more or more potassium nitrate (KNO₃), sodium nitrate (NaNO₃), and/or lithium nitrate (LiNO₃) in addition to the nitrite salt (e.g., NaNO₂, KNO₂) and/or the sulfate salt (e.g., Na₂SO₄, K₂SO₄). In further aspects, a concentration of the potassium salt(s) (e.g., potassium nitrate, potassium nitrite, and/or potassium sulfate) in the molten salt solution can be 80 wt % or more, 85 wt % or more, 86 wt % or more (e.g., 86.0 wt % or more), 87 wt % or more (e.g., 87.0 wt % or more), 88 wt % or more (e.g., 88.0 wt % or more), 89 wt % or more (e.g., 89.0 wt % or more), 90 wt % or more (e.g., 90.0 wt % or more), 91 wt % or more (e.g., 91 wt % or more), 92 wt % or more, 93 wt % or more, 94 wt % or more, 95 wt % or more, 98 wt % or less, 95 wt % or less, 93 wt % or less, 92 wt % or less (e.g., 92.0 wt % or more), 91 wt % or less (e.g., 91.0 wt % or more), 90 wt % or less (e.g., 90.0 wt % or more), 89 wt % or less (e.g., 89.0 wt % or more), 88 wt % or less (e.g., 88.0 wt % or more), 87 wt % or less, 86 wt % or less, or 85 wt % or less. In further aspects, a concentration of the potassium salt(s) (e.g., potassium nitrate, potassium nitrite, and/or potassium sulfate) in the molten salt solution can be in a range from 80 wt % to 98 wt %, from 80 wt % to 95 wt %, from 85 wt % to 93 wt %, from 85 wt % to 92 wt %, from 86 wt % to 91 wt %, from 87 wt % to 90 wt %, from 88 wt % to 89 wt %, or any range or subrange therebetween. In further aspects, a concentration of the second potassium salt (e.g., potassium nitrate) in the molten salt solution can be 85 wt % or more, for example in a range from 85.0 wt % to 92 wt %, from 86.0 wt % to 92.0 wt %, from 87.0 wt % to 92.0 wt %, from 88.0 wt % to 91.0 wt %, from 89.0 wt % to 91.0 wt %, from 89.0 wt % to 90.0 wt %, or any range or subrange therebetween. In preferred aspects, a concentration of the second potassium salt (e.g., potassium nitrate) in the molten salt solution can be in a range from 85 wt % to 92 wt % or from 88 wt % to 91 wt %.

In further aspects, a concentration of the sodium salt(s) (e.g., sodium nitrate, sodium nitrite, and/or sodium sulfate) in the molten salt solution can be 5 wt % or more, 7 wt % or more, 8 wt % or more, 9 wt % or more, 10 wt % or more, 11 wt % or more, 12 wt % or more, 13 wt % or more, 14 wt % or more, 20 wt % or less, 17 wt % or less, 15 wt % or less, 14 wt % or less, 13 wt % or less, 12 wt % or less, 11 wt % or less, 10 wt % or less, or 9 wt % or less. In further aspects, a concentration of the sodium salt(s) (e.g., sodium nitrate, sodium nitrite, and/or sodium sulfate) in the molten salt solution can be in a range from 5 wt % to 20 wt %, from 7 wt % to 17 wt %, from 8 wt % to 15 wt %, from 9 wt % to 14 wt %, from 10 wt % to 13 wt %, from 11 wt % to 12 wt %, or any range or subrange therebetween. In further aspects, a concentration of the sodium salt(s) (e.g., sodium nitrate, sodium nitrite, and/or sodium sulfate) in the molten salt solution can be 15 wt % or less, for example, in a range from 8 wt % to 15 wt %, from 8 wt % to 14 wt %, from 9 wt % to 13 wt %, from 9 wt % to 12 wt %, from 10 wt % to 11 wt %, or any range or subrange therebetween. In preferred aspects, a concentration of the sodium salt(s) (e.g., sodium nitrate, sodium nitrite, and/or sodium sulfate) in the molten salt solution can be from 8 wt % to 15 wt % or from 9 wt % to 12 wt %. In further aspects, the molten salt solution can optionally comprise (by superaddition) silicic acid, for example, from greater than 0 wt % to 2 wt %, from greater than 0 wt % to 1 wt %, from 0.2 wt % to 1.0 wt %, from 0.5 wt % to 0.7 wt %, or any range or subrange therebetween.

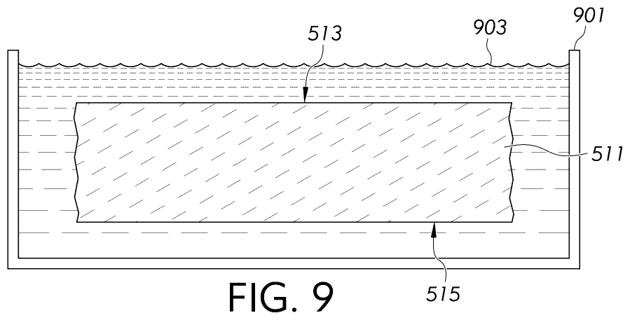

After and/or at the end of step 603, the chemically-strengthened glass article can comprise (e.g., as a result of the chemical strengthening treatment described above) a first compressive stress region extending to a first depth of compression from the first major surface 513 and a first depth of layer of one or more alkali metal ions (e.g., potassium) associated with the first compressive stress region and/or the glass article 511 can comprise a second compressive stress region extending to a second depth of compression from the second major surface 515 and a second depth of layer of one or more alkali metal ions (e.g., potassium) associated with the second compressive stress region. In further aspects, a maximum first compressive stress of the first compressive stress region and/or a maximum second compressive stress of the second compressive stress region can be within one or more of the ranges discussed above for the maximum first compressive stress. In further aspects, a maximum first compressive stress of the first compressive stress region and/or a maximum second compressive stress of the second compressive stress region can be 400 MPa or more, 500 MPa or more, 600 MPa or more, 700 MPa or more, 800 MPa or more, 1,500 MPa or less, 1,300 MPa or less, 1,200 MPa or less, 1,100 MPa or less, 1,000 MPa or less, 900 MPa or less, or 800 MPa or less. In further aspects, a maximum first compressive stress of the first compressive stress region and/or a maximum second compressive stress of the second compressive stress region can be in a range from 400 MPa to 1,500 MPa, from 500 MPa to 1,300 MPa, from 600 MPa to 1,200 MPa, from 600 MPa to 1,100, from 700 MPa to 1,000 MPa, from 800 MPa to 900 MPa, or any range or subrange therebetween. Also, as discussed above with reference to FIG. 10, one or more copper-containing salts (e.g., deposit 1121, 1123, 1125, and/or 1127) can be formed at the first major surface 513 of the glass article 511 during the chemical strengthening. As shown in FIG. 8, the copper-containing salt 801 can be formed at and/or on the first major surface 513 of the glass article 511. However, as discussed above, the copper-containing salt 801 can dissolve in the molten salt solution (as indicated by arrow 803) and/or dissolve or otherwise be washed away during a subsequent rinsing discussed below with reference to FIGS. 9 and 11.

In aspects, after step 603, methods can proceed to step 605 comprising rinsing the glass article 511 with a solution 903, as shown in FIG. 9. In further aspects, the solution 903 can be contained in a bath 901 and/or the glass article 511 can be immersed in the solution 903 (e.g., with the first major surface 513 and the second major surface 515 in contact with the solution 903). In further aspects, the solution 903 can remove (e.g., dissolve and/or displace) deposits (e.g., copper-containing salt 801 see FIG. 8) formed on the glass article 511 in step 603. In aspects, the solution 903 can be agitated (e.g., ultrasonicated) to further facilitate removal of deposits (e.g., copper-containing salt 801). In further aspects, the solution 903 can be water (e.g., purified, filtered, deionized, and/or distilled), an alkaline detergent solution, or combinations thereof. As used herein, a pH of a solution is measured in accordance with ASTM E70-90 at 25° C. with standard solutions extending to a pH of at least 14. In even further aspects, the alkaline detergent solution (e.g., solution 903) can comprise an alkaline detergent and a pH of 11 or more, 12 or more, 12.5 or more, 12.8 or more, 14 or less, 13.5 or less, or 13.2 or less. In aspects, the alkaline detergent solution (e.g., solution 903) can comprise a pH ranging from 11 to 14, from 12 to about 14, from 12.5 to 13.5, from 12.8 to 13.2, or any range or subrange therebetween. In aspects, the alkaline detergent solution (e.g., solution 903) can comprise an alkaline detergent in a concentration from 0.5 wt % or more, 1 wt % or more, 1.5 wt % or more, 2 wt % or more, 4 wt % or less, 3 wt % or less, or 2.5 wt % or less. In aspects, the alkaline detergent solution (e.g., solution 903) can comprise an alkaline detergent in a concentration ranging from 0.5 wt % to 4 wt %, from 1 wt % to 4 wt %, from 1.5 wt % to 3 wt %, from 2 wt % to 3 wt %, from 2.5 wt % to 3 wt %, or any range or subrange therebetween. An exemplary aspect of an alkaline detergent solution includes SemiClean KG (Yokohama Oils & Fats Industry Co.). Exemplary aspects of sonication include ultrasonication and megasonication. Without wishing to be bound by theory, sonication (e.g., ultrasonication, megasonication) can help remove contaminants (e.g., particles, oils) from a surface by forming microscale bubbles as the surface, by increasing circulation of the alkaline detergent solution through agitation, and/or by loosening contaminants through vibration directly. In aspects, the alkaline detergent solution and/or water can be substantially free of a rheology modifier. As used herein, a rheology modifier is a component other than a solvent or a listed component (e.g., acid, hydroxide-containing base, H₂SiF₆, fluoride-containing compound) that modifies the viscosity of the solution or the shear-dependent behavior (e.g., dilatant, thixotropic). Example aspects of rheology modifiers that the solution can be substantially free of include one or more of cellulose, a cellulose derivative (e.g., ethyl cellulose, methyl cellulose, and AQUAZOL (poly 2 ethyl-2 oxazine)), a hydrophobically modified ethylene oxide urethane modifier (HUER), and an ethylene acrylic acid.

In further aspects, the solution 903 can comprise a rinsing temperature and/or be in contact with the glass article 511 for a rinsing period of time. In further aspects, sonication can be applied for at least half of the rinsing period of time, for example, the entire first period of time. In further aspects, the rinsing period of time can be 5 minutes or more, 8 minutes or more, 10 minutes or more, 15 minutes or more, 60 minutes or less, 40 minutes or less, 30 minutes or less, 20 minutes or less, 10 minutes or less, or 8 minutes or less. In further aspects, the rinsing period of time can range from 5 minutes to 60 minutes, from 8 minutes to 40 minutes, from 10 minutes to 30 minutes, from 15 minutes to 20 minutes, or any range or subrange therebetween. Providing a rinsing period of time of at least 2 minutes can effectively remove copper-containing salt deposits from the surface. Providing a rinsing period of time of less than 60 minutes can keep a chance of damage or breakage within acceptable ranges. In aspects, the first temperature can be 20° C. or more, 25° C. or more, 30° C. or more, 35° C. or more, 65° C. or less, 50° C. or less, 40° C. or less, or 35° C. or less. In aspects, the first temperature can range from 20° C. to 65° C., from 20° C. to 50° C., from 20° C. to 40° C., from 25° C. to 35° C., from 30° C. to 35° C., or any range or subrange therebetween.

In aspects, the rinsing in step 605 can remove copper-containing salts formed in the chemical strengthening of step 603 when the molten salt solution comprises a nitrite salt and/or a sulfate salt. In further aspects, a fraction of the first major surface 513 of the glass article that is free of the copper-containing salt (and other copper-containing residue) at the end of step 605 (and/or at the end of step 603) can be greater than or equal to 50% (i.e., a majority), greater than or equal to 66%, greater than or equal to 75%, greater than or equal to 80%, greater than or equal to 85%, greater than or equal 90%, greater than or equal to 92%, greater than or equal 95%, greater than or equal 96%, greater than or equal 96%, greater than or equal 97%, greater than or equal 98%, or greater than or equal 99%. In further aspects, the first major surface 513 of the glass article 511 can be substantially free of the copper-containing salt at the end of step 605 (or even at the end of step 603 in some aspects). As discussed above, “substantially free” in this context means that greater than 95% of the surface area does not have the copper-containing salt or other copper-containing residue. Also, as discussed above, the reflectance haze of the first major surface 513 (at the end of step 605 or even at the end of step 603) can be within any of the corresponding ranges discussed above (e.g., 2% or less, from 0.01% to 2%, from 0.05% to 2%, from 0.1% to 1%, from 0.1% to 0.8%, from 0.2% to 0.5%, or any range or subrange therebetween). In further aspects, the rinsing can remove copper-containing salts with copper in the 1+ oxidation state (e.g., deposit 1123 and/or 1124 shown in FIG. 10 when the molten salt solution comprises a nitrite salt) and/or other salts (e.g., copper sulfate shown as deposit 1127 in FIG. 10). For example, with reference to FIG. 11, the copper oxide (CuO) with copper in the 2+ oxidation state (e.g., formed in the absence of a nitrite salt and/or a sulfate salt) in deposit 1121 is not dissolved or otherwise removed by the solution 903 in step 605. Likewise, copper phosphate with copper in the 2+ oxidation state (e.g., Cu(II)₃(PO₄)₂) is not readily removed by the solution 903 in step 605. However, the complex including copper ions in the 1+ oxidation state in deposit 1125 (e.g., formed in the presence of a nitrite salt in the molten salt solution) can be dissolved and/or otherwise removed by the solution 903 in step 605, as indicated by arrow 1133. Similarly, copper sulfate (e.g., CuSO₄) in deposit 1127 (e.g., formed in the presence of a sulfate salt) can be dissolved and/or otherwise removed by the solution 903 in step 605, as indicated by arrow 1135. Likewise, copper phosphate (e.g., Cu₃PO₄) in the 1+ oxidation state in deposit 1124 (e.g., formed in the presence of a nitrite salt) can be dissolved and/or otherwise removed by the solution 903 in step 605, as indicated by arrow 1137.

After step 603 or 605, methods can proceed to step 607 comprising assembling a consumer electronic device and/or natively colored glass housing from the glass article. After step 603, 605, and/or 607, the method can be complete at step 609. At the end of step 603, 605, and/or 607, and/or 609, the glass article 350 and/or 511 can be similar to or identical to the glass article 350 and/or 511 shown in FIGS. 3-4. In aspects, methods can proceed along the steps discussed above, for example, sequentially through steps 601, 603, 605, 607, and 609. In aspects, methods can follow arrow 602 from step 603 to step 607 if the glass article 511 is to be assembled in a consumer electronic device and/or natively colored glass housing without rinsing the glass article 511 in step 605, for example if the first major surface 513 of the glass article 511 is substantially free and/or free of the copper-containing salt at the end of step 603. In aspects, methods can follow arrow 604 from step 603 to step 609 if methods are complete at the end of step 603 if methods are complete at the end of step 603, for example if the first major surface 513 of the glass article 511 is substantially free and/or free of the copper-containing salt at the end of step 603. In aspects, methods can follow arrow 606 from step 605 to step 609 if methods are complete at the end of step 605 if methods are complete at the end of step 603. Any of the above options may be combined to make a chemically-strengthened glass article, natively colored glass housing, and/or consumer electronic device in accordance with aspects of the disclosure.

### Examples

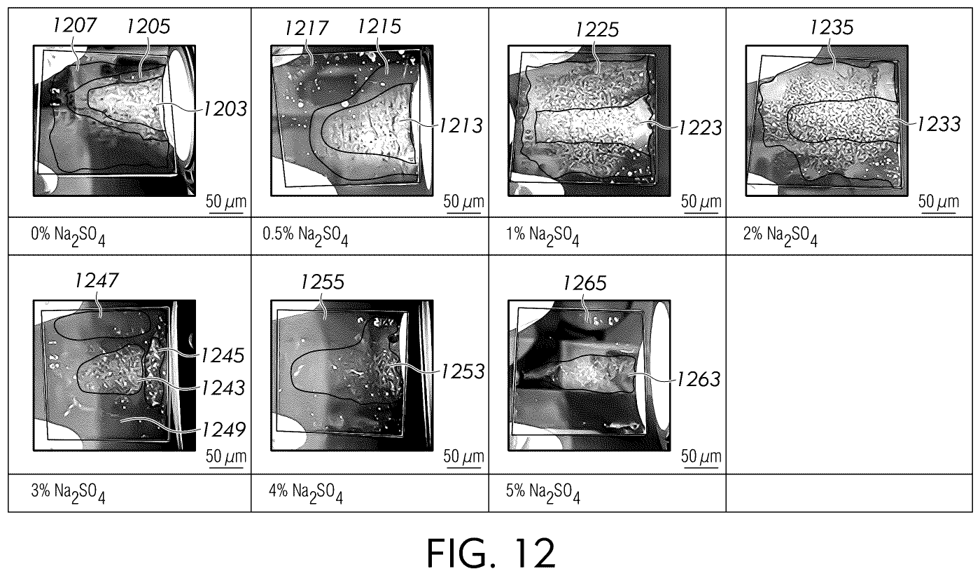

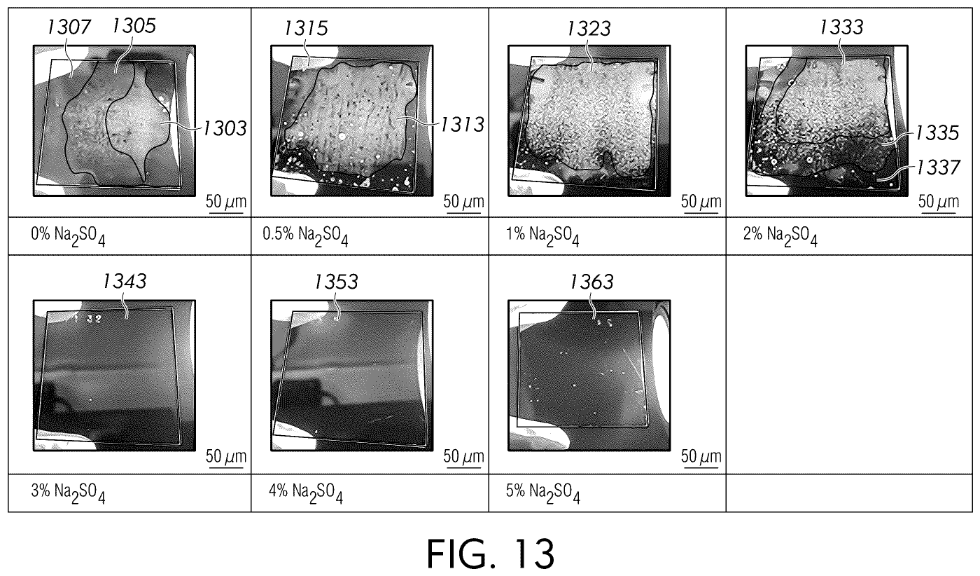

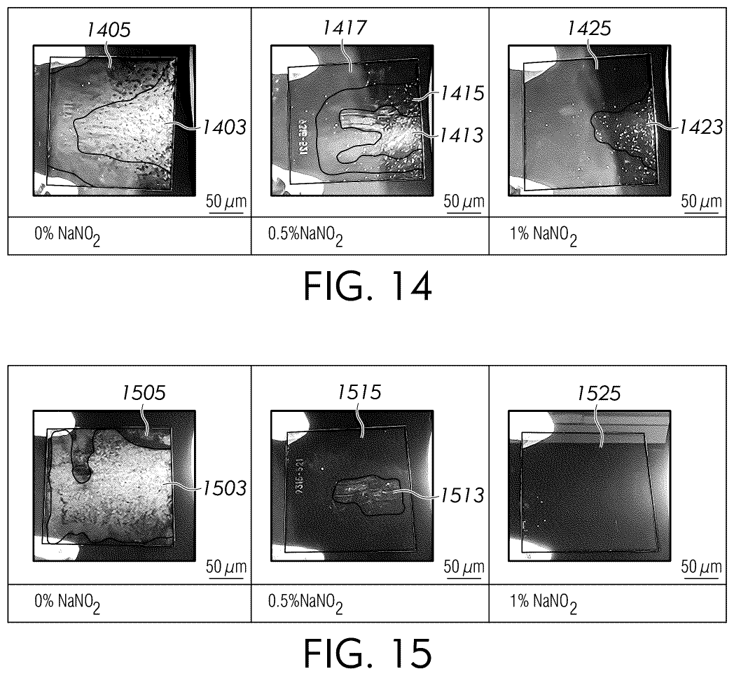

Various aspects will be further clarified by the following examples. FIGS. 12-15 present results using various amounts of a sulfate salt or a nitrite salt in a molten salt solution with images shown (immediately) after the chemical strengthening in the molten salt solution (FIGS. 12 and 14) and after a subsequent rinsing (FIGS. 13 and 15). For both sets of examples, with various amounts of a sulfate salt or a nitrite salt), the base composition for the molten salt solution was 89.4 wt % potassium nitrate (KNO₃), 10.5 wt % sodium nitrate (NaNO₃), and 0.1 wt % lithium nitrate (LiNO₃) with 0.5 wt % silicic acid added by superaddition. The sulfate salt or nitrite salt was added by substituting sodium nitrate with sodium sulfate or sodium nitrite, respectively, to maintain the wt % ratio of potassium salts to sodium salts in the molten salt solution. To simulate an aged molten salt solution (e.g., after chemically strengthening multiple batches of glass articles), 1.0 wt % lithium nitrate (LiNO₃) and 1.2 wt % trisodium phosphate (Na₃PO₄) were added by superaddition to the molten salt solution composition stated above in this paragraph. Unless otherwise stated, the glass article samples were immersed in the “aged” molten salt solution maintained at 380° C. for 8 hours. Subsequent rinsing was performed with an alkaline detergent solution (i.e., Semiclean KG). The glass article samples comprised a composition consisting essentially of 61.3 mol % SiO₂, 15.0 mol % AlO₃, 5.9 mol % B₂O₃, 12.2 mol % Li₂O, 3.9 mol % Na₂O, 0.4 mol % K₂O, 0.7 mol % CaO and about 0.6 mol % colorants including 0.16 mol % CuO. These glass article samples exhibited a purple color. In FIGS. 12-15, any haziness, cloudiness, or discoloration was attributed to the presence of copper-containing salts. The degree of copper-containing salts on the surface is generally indicated using contours in FIGS. 12-15. The bright white portions in the images are specular reflections of light sources rather than deposits.

FIGS. 12-13 present results using various amounts of a sulfate salt (i.e., sodium sulfate, Na₂SO₂) in the molten salt solution with FIG. 12 presenting images of samples after chemical strengthening in the molten salt solution but before rinsing while FIG. 13 presents images of samples after rinsing (following chemical strengthening in the molten salt solution) with an alkaline detergent solution (i.e., Semiclean KG). As shown in FIGS. 12-13, a control molten salt solution (0 wt % sodium sulfate) and example molten salt solutions with 0.5 wt %, 1.0 wt %, 2.0 wt %, 3.0 wt %, 4.0 wt %, or 5.0 wt % sodium sulfate (substituted for corresponding wt % of sodium nitrate) were tested.

In FIG. 12, the amount of copper-containing salts decreased as the concentration of the sulfate salt (sodium sulfate) increased. Notably, the image of samples treated with a molten salt solution having from 3 wt % or more (e.g., 3 wt % to 5 wt %) of the sulfate salt (sodium sulfate) had limited deposits that were generally at the center of the glass article samples. In contrast, the control sample treated with no sulfate salt and the sample treated with 0.5 wt % of the sulfate salt have deposits over most of the surface with some deposits seen in region 1207 or 1217, more deposits seen in region 1205 or 1215, and very high levels of deposits seen in region 1203 or 1213. For samples treated with 1.0 wt % or 2.0 wt % of the sulfate salt, virtually the entire surface had deposits, but the intensity of the deposits was generally lower than the control sample and the sample treated with 0.5 wt % of the sulfate salt. For example, the samples treated with 1.0 wt % or 2.0 wt % of the sulfate salt have region 1225 or 1235 with some deposits and region 1223 or 1233 with more deposits. As mentioned above, samples treated with a molten salt solution having from 3 wt % or more (e.g., 3 wt % to 5 wt %) of the sulfate salt (sodium sulfate) had limited deposits that were generally at the center of the glass article samples. For example, region 1249, 1255, and 1265 was generally free of deposits with limited deposits in regions 1243, 1245, 1247, 1253, and 1263. This demonstrates that providing greater than 2.0 wt % (e.g., from greater than 2.0 wt % to 10 wt %, from 2.5 wt % to 8 wt %, or from 3.0 wt % to 5.0 wt %) of the sulfate salt reduces the amount of copper-containing salt on the surface (and/or the area of the surface covered by the copper-containing salt) at the end of chemical strengthening the glass article with the molten salt solution.

In FIG. 13 (after rinsing), the trends from FIG. 12 are maintained, but the samples treated with 3 wt % or more (e.g., 3 wt % to 5 wt %) of the sulfate salt (sodium sulfate) were essentially free of copper-containing salt (as indicated by region 1343, 1353, and 1363). In contrast, the control sample and the other samples treated with 2.0 wt % or less of the sulfate salt had the majority of the surface covered with copper-containing salts. For example, the control sample had some deposits in region 1307, more deposits in region 1305, and very high levels of deposits in region 1303. The samples treated with 0.5 wt % and 2.0 wt % of sulfate had region 1315 and 1335 with some copper-containing salt and region 1313 and 1333 with more copper-containing salt (and the sample treated with 2.0 wt % of the sulfate salt had region 1337 with low levels of the copper-containing salt. The sample treated with 1.0 wt % of the sulfate salt generally had high levels of the copper-containing salt in region 1323. This demonstrates that providing greater than 2.0 wt % (e.g., from greater than 2.0 wt % to 10 wt %, from 2.5 wt % to 8 wt %, or from 3.0 wt % to 5.0 wt %) of the sulfate salt can produce glass articles that are substantially free and/or free of copper-containing salt on the surface (and/or substantially none of the surface covered by the copper-containing salt) after rinsing following the chemical strengthening of the glass article with the molten salt solution.

FIGS. 14-15 present results using various amounts of a nitrite salt (i.e., sodium nitrite, NaNO₂) in the molten salt solution with FIG. 14 presenting images of samples after chemical strengthening in the molten salt solution but before rinsing while FIG. 13 presents images of samples after rinsing (following chemical strengthening in the molten salt solutions) with an alkaline detergent solution (i.e., Semiclean KG). As shown in FIGS. 14-15, a control molten salt solution (0 wt % sodium sulfate) and example molten salt solutions with 0.5 wt % and 2.0 wt % sodium nitrite (substituted for corresponding wt % of sodium nitrate) were tested.

In FIG. 14, the amount of copper-containing salts decreased as the concentration of the nitrite salt (sodium nitrite) increased. Notably, the image of samples treated with a molten salt solution having from 0.5 wt % or more (e.g., 2 wt %) of the nitrite salt (sodium nitrite) had limited deposits that were generally at the center of the glass article samples. In contrast, the control sample treated with no nitrite salt had deposits over most of the surface with deposits seen in region 1405 and very high levels of deposits seen in region 1403. For the sample treated with 0.5 wt % of the sulfate salt, region 1417 had substantially no deposits, region 1415 had some deposits, and region 1413 had more deposits, but the concentration of the deposits in this sample is much lower than for the control sample. For the sample treated with 2.0 wt % of the sulfate salt, the majority of the surface was substantially free of deposits (region 1425) while region 1423 has some deposits that were much less noticeable than the sample treated with 0.5 wt % of the sulfate salt. This demonstrates that providing 0.5 wt % or more (e.g., from greater than 0.5 wt % to 10 wt %, from 1.0 wt % to 5 wt %, or from 2.0 wt % to 5.0 wt %) of the nitrite salt reduces the amount of copper-containing salt on the surface (and/or the area of the surface covered by the copper-containing salt) at the end of chemical strengthening the glass article with the molten salt solution.

In FIG. 15 (after rinsing), the trends from FIG. 14 are maintained, but the samples treated with 0.5 wt % or more (e.g., 0.5 wt % and 2.0 wt %) of the nitrite salt (sodium nitrite) were essentially free of copper-containing salt (as indicated by region 1515 and 1525). The sample treated with 2.0 wt % of the nitrite salt had no noticeable deposits while the sample treated with 0.5 wt % of the nitrite salt had only some deposits remaining in region 1513. In contrast, the control sample had the majority of the surface covered with copper-containing salt with some deposits in region 1505 and very high levels of deposits in region 1503. This demonstrates that providing 0.5 wt % or more (e.g., from greater than 0.5 wt % to 10 wt %, from 1.0 wt % to 5.0 wt %, of from 2.0 wt % to 5.0 wt %) of the nitrite salt can produce glass articles that are substantially free and/or free of copper-containing salt on the surface (and/or substantially none of the surface covered by the copper-containing salt) after rinsing following the chemical strengthening of the glass article with the molten salt solution.

FIGS. 16-17 and 21 present results using an alkaline earth metal salt in the molten salt solution. The base composition for the molten salt solution for these examples was 81.2 wt % potassium nitrate (KNO₃), 15.6 wt % sodium nitrate (NaNO₃), 2.0 wt % lithium nitrate (LiNO₃), and 1.2 wt % trisodium phosphate (Na₃PO₄) with 0.5 wt % silicic acid added by superaddition. As above, the lithium nitrate and trisodium phosphate are included to simulate an aged molten salt solution. For FIGS. 16-17, either 0 wt %, 0.5 wt %, 1.0 wt %, 2.0 wt %, or 4.0 wt % of calcium nitrate (Ca(NO₃)₂) was added by superaddition to this base composition of the molten salt solution. Then, the copper-containing glass article was immersed in the corresponding molten salt solution maintained at 380° C. for 9.5 hours. Images in FIGS. 16-17 were taken of the resulting articles when the copper-containing glass was removed from the molten salt solution. In FIG. 16, the images were taken under brightfield illumination whereas the copper-containing glass articles were edge lit for FIG. 17 with enlarged portions of the image shown. For the control (0%) condition 1605 and 1705, many large particles 1603 and 1703 are visible on the surface. Although not shown, characterization of these particles confirmed that these particles contained copper. Also, as shown in FIG. 17, the control condition had a large hazy area 1707 that also included many particles. In FIG. 16, the 0.5 wt % (0.5%) condition 1615 still has a lot of particles 1613 in clusters on the surface, but the 0.5 wt % Ca(NO₃)₂ added here did reduce the amount of the surface covered by the particle and particle size relative to the control. Going to the 1.0 wt % (1%) condition 1625 shown in FIG. 16 has a few particles 1623 that is dramatically decreased from the control (0%) condition 1605 and the 0.5 wt % (0.5%) condition 1615. Increasing the amount of Ca(NO₃)₂ to 2.0 wt %, the 2% condition 1635 has less than a handful of particles 1633. Further increasing the amount of Ca(NO₃)₂ to 4.0 wt %, the 4% condition 1645 has virtually no particles on the surface. The few particles see in the 4% condition were analyzed and it was determined that these particles were due to organic contamination and did not contain copper. In few of this information, the 4% condition 1645 (4.0 wt % Ca(NO₃)₂) was free of copper-containing residue. Also, it is likely that the few particles 1633 seen in the 2% condition 1635 (2.0 wt % Ca(NO₃)₂) are free of copper-containing residue and are instead organic contamination. It is believed that more careful handling and environmental control could avoid the organic contamination see in the 4% (and likely 2%) condition(s). Consequently, including at least 1.0 wt % of the alkaline earth metal salt (e.g., Ca(NO₃)₂) can dramatically decrease the formation of copper-containing residue on the copper-containing glass article and at least 2.0 wt % of the alkaline earth metal salt (e.g., from 2.0 wt % to 4.0 wt % Ca(NO₃)₂) can produce an copper-containing glass article that is free of copper-containing residue.

Returning to the edge-lit images in FIG. 17, the 2% condition 1715 (2.0 wt % Ca(NO₃)₂) has several particles 1713 but much less than the those seen the control (0%) condition 1705. Also, the 2% condition 1715 does not have the hazy area 1707 seen in the control (0%) condition 1705. Increasing the amount of Ca(NO₃)₂ to 4.0 wt %, the 4% condition 1725 has no visible particles nor haze. Here, greater than or equal to 2.0 wt % of the alkali earth metal salt (e.g., from 2.0 wt % to 4.0 wt % Ca(NO₃)₂) produces a dramatic reduction in particles (e.g., copper-containing residue) such that there are few or even no particles see on the surface.

As discussed above, it is believed that the field strength and/or ionic radius of the calcium ion in Ca(NO₃)₂ is responsible to the decrease in copper-containing residue (e.g., particles). Based on the theory and mechanism discussed above, it is expected that larger alkaline earth metal ions (e.g., strontium, barium) associated with corresponding alkaline earth metal salts would have the same or an even more pronounced effect on inhibiting the formation of copper-containing residue. However, smaller alkaline earth metal ions (e.g., magnesium) would not necessarily be expected to be as effective due to the smaller ionic radius for magnesium relative to calcium.

FIG. 21 shows the results of using a magnesium salt in the molten salt solution as the alkaline earth metal salt. The base composition for the molten salt solution was the same as for FIGS. 16-17. Here, either 0 wt %, 2 wt %, or 4 wt % of magnesium nitrate Mg(NO₃)₂ was added to this base composition by superaddition. As for FIG. 16, the copper-containing glass article was immersed in the corresponding molten salt solution maintained at 380° C. for 9.5 hours and the images were taken immediately thereafter under brightfield illumination. As shown, the control (0%) condition 2105 has many particles 2103 over much of the surface area. Adding 2.0 wt % of the magnesium nitrate Mg(NO₃)₂, the 2.0 wt % (2%) condition 2115 has several particles 2113 but there are dramatically fewer particles than in the control condition 2105. Further increasing the amount of magnesium nitrate Mg(NO₃)₂ to 4.0 wt %, the 4.0 wt % (4%) condition 2125 condition has only a few particles 2123, which is even less than the number of particles 2113 seen in the 2.0 wt % condition. Based on this trend, it is believed that essentially no particles would appear for 4.0 wt % or more of magnesium nitrate Mg(NO₃)₂ (e.g., from 4.0 wt % to 8.0 wt %). This demonstrates that magnesium salts can still reduce the amount of copper-containing residue, although larger concentrations of the magnesium may be needed to achieve results comparable to those see with calcium salts.

FIGS. 18-19 show relative (unnormalized) concentration profiles based on detected intensity (I—in arbitrary units (arb)) on the vertical axis 1803 or 1903 (i.e., y-axis) as a function of distance (d) from the first major surface of the glass article on the horizontal axis 1801 or 1901 (i.e., x-axis) in nanometers (nm). FIG. 18 shows relative concentration profiles of copper while FIG. 19 shows relative concentration profiles for calcium—corresponding to the alkaline earth metal salt added to the molten salt solution in some conditions. The concentration profiles were measured using secondary-ion mass spectroscopy (SIMS). Curves 1809 and 1909 correspond to the copper-containing glass article before any chemical strengthening treatment. Curves 1805 and 1905 correspond to the copper-containing glass article after chemical strengthening in a molten salt solution having the base composition discussed above with reference to FIGS. 16-17 and 21 (i.e., without any—0 wt % alkaline earth metal salt). Curves 1807 and 1907 correspond to the copper-containing glass article after chemical strengthening using a molten salt solution having 2.0 wt % calcium nitrate Ca(NO₃)₂ added to the base composition (including lithium nitrate and trisodium phosphate) discussed above with reference to FIGS. 16-17 and 21. Curves 1811 corresponds to the copper-containing glass article after chemical strengthening using the molten salt solution having 2.0 wt % calcium nitrate Ca(NO₃)₂ added to a molten salt solution with 1 wt % lithium nitrate and no trisodium phosphate (i.e., 83 wt % KNO₃, 16 wt % NaNO₃, 1 wt % LiNO₃ having silicic acid and the Ca(NO₃)₂ added by superaddition). Curves 1911 corresponds to the copper-containing glass article after chemical strengthening using the molten salt solution having no (0 wt %) calcium nitrate Ca(NO₃)₂ added to a molten salt solution with 1 wt % lithium nitrate and no trisodium phosphate (i.e., 83 wt % KNO₃, 16 wt % NaNO₃, 1 wt % LiNO₃ having silicic acid added by superaddition).

As shown in FIG. 18, the copper concentration curve 1809 has a substantially constant copper concentration for the non-chemically strengthened copper-containing glass article. However, chemically strengthening the copper-containing glass article produces the copper concentration curve 1805 with a near surface spike. Since the only source of copper during the chemical strengthening is in the copper-containing glass article, this spike must have been formed by copper diffusing towards the first major surface (from within the glass-based article), which provides the foundation for the formation of the copper containing residue. In contrast, copper concentration curves 1807 and 1811 with 2.0 wt % calcium nitrate Ca(NO₃)₂ added to either the “fresh” or “aged” molten salt solution significantly reduces the near surface spike seen in copper concentration curve 1805. Compared to the 2 order of magnitude increase seek at the surface for curve 1805 (relative to curve 1809), the less than 1 order of magnitude increase seen in curves 1807 and 1811 is essentially negligible. This demonstrates that the addition of 2.0 wt % calcium nitrate Ca(NO₃)₂ to the molten salt solution reduces the copper concentration near the surface, which is associated with reduced copper-containing residue being formed on the surface (see FIGS. 16-17).

As shown in FIG. 19, the calcium concentration curve 1909 has a substantially constant calcium concentration for the non-chemically strengthened copper-containing glass article. The dip in the 5 nm or so near the surface is attributed to surface effects related to formation of the copper-containing glass article. Chemically strengthening the copper-containing glass article without any calcium nitrate produces the calcium concentration curve 1905 with a decrease in concentration within about 40 nm from the surface (even relative to curve 1909). Using a “fresh” molten salt solution (still without any calcium nitrate) produces calcium concentration curve 1911 with an even more pronounced depletion near the surface extending to a depth of 50 nm from the surface. In contrast, calcium concentration curve 1907 with 2.0 wt % calcium nitrate Ca(NO₃)₂ added to either the “aged” molten salt solution does not have this calcium depletion (see in curve 1905) relative to curve 1909. In fact, curve 1907 exhibits an enrichment in calcium near the surface (i.e. less than 40 nm deep). This near-surface enrichment in calcium is consistent with the theory and mechanism discussed herein on how the alkaline earth metal salt inhibits formation of copper-containing residue on the surface. This near-surface enrichment is relatively shallow (e.g., less than 40 nm) such that an short etching treatment (in either a hydroxide-containing solution or an acidic solution) would be expected to remove the near-surface region enriched in the alkaline earth metal (e.g., calcium) such that properties of the etched article should be unaffected by the alkaline earth metal salt in the molten salt solution (other than the absence of a copper-containing residue or associated haze).

The above observations can be combined to provide glass articles and natively colored glass housings including the same that contain copper (e.g., greater than 0.01 wt %, from 0.3 wt % to 5.0 wt %, or from 0.06 wt % to 3.0 wt %) that can be chemically strengthened with low reflectance haze (e.g., 2.0 wt % or less) and/or without copper-containing deposits on the surface. Producing glass articles and natively colored glass housings without copper-containing deposits on the surface and/or low reflectance haze can be more aesthetically pleasing to a user of a consumer electronic device (than hazy articles or articles with copper-containing deposits).

The glass-based material of the glass article can provide good dimensional stability, good impact resistance, good crack resistance, good puncture resistance, and/or good flexural strength. The glass article can include a compressive stress region (e.g., be chemically strengthened), which can provide improved crack resistance, puncture resistance, impact resistance, and/or improved flexural strength. Minimizing the combination of R₂O, CaO, MgO, and ZnO in the glass composition may provide the resultant colored glass article with a desirable dielectric constant, for example when the colored glass article is used as a portion of a housing for an electronic device. Providing a dielectric constant for frequencies from 10 GHz to 60 GHz from 5.6 to 6.4 can allow wireless communication through the glass article. Providing a glass article comprising a glass-based material and/or a ceramic-based material can have good dimensional stability, reduced incidence of mechanical instabilities, and/or good impact and puncture resistance.

Methods of the present disclosure comprise chemically strengthening the copper-containing glass article with a molten salt solution including a nitrite salt and/or a sulfate salt (that can be used in combination with nitrate salts and/or other alkali metal salts). Providing a molten salt solution with a concentration of the nitrite salt, based on a total weight of the molten salt solution, can be in a range from 0.5 wt % to 10 wt %, from 1.0 wt % to 5 wt %, or from 2.0 wt % to 5 wt % can achieve a glass article (containing copper) that has a surface substantially free of copper-containing salt in accordance with the methods of the presence disclosure. The results shown in FIG. 12 demonstrate that providing greater than 2.0 wt % (e.g., from greater than 2.0 wt % to 10 wt %, from 2.5 wt % to 8 wt %, or from 3.0 wt % to 5.0 wt %) of the sulfate salt reduces the amount of copper-containing salt on the surface (and/or the area of the surface covered by the copper-containing salt) at the end of chemical strengthening the glass article with the molten salt solution. The results shown in FIG. 13 demonstrate that providing greater than 2.0 wt % (e.g., from greater than 2.0 wt % to 10 wt %, from 2.5 wt % to 8 wt %, or from 3.0 wt % to 5.0 wt %) of the sulfate salt can produce glass articles that are substantially free and/or free of copper-containing salt on the surface (and/or substantially none of the surface covered by the copper-containing salt) after rinsing following the chemical strengthening of the glass article with the molten salt solution.

Without wishing to be bound by theory, it is believed that copper ions in the glass article can predominately be in the 2+ oxidation state, and that the copper ions are reduced to the 1+ oxidation state before diffusing out of the glass article since ions with a 1+ oxidation state have greater mobility than ions with a 2+ oxidation state in the glass article. Providing the nitrite salt can preserve the copper ions (outside of the glass article) in the 1+ oxidation state at a surface of the glass article and/or in the molten salt solution. In aspects, during contact with the molten salt solution, a copper-containing salt can be formed at the surface of the glass article, where the copper-containing salt has copper in a 1+ oxidation state. At the first major surface of the glass article, the copper ion in the 1+ oxidation state can be oxidized by nitrate ions in the molten salt solution to form a CuO precipitate. It is believed that this reaction is largely irreversible in the molten salt solution, and CuO is insoluble in water, which makes it hard to remove CuO precipitates in a subsequent rinsing step. Alternatively, when the molten salt solution comprises a nitrite salt (e.g., producing nitrite ions), a complex of copper oxide(s) (e.g., Cu(I)₂O and/or Cu(II)O) and/or copper nitrate (e.g., Cu(I)NO₃) can be formed between the copper and the nitrite ions and optionally nitrate ions; and it is believed that the complex is more readily dissolved in a rinsing step than CuO such that the amount of copper-containing salt on the glass article can be reduced and/or removed (e.g., eliminated) after a rinsing step. Similarly, the presence of the nitrite salt (e.g., producing nitrite ions) can form other copper-containing salts that preserve the copper ion in the 1+ oxidation state, for example, nitrite in combination with another anion (e.g., phosphate) can form copper phosphate with copper in the 1+ oxidation state (Cu(I)₃PO₄) that is more readily dissolved in water than CuO or copper phosphate with copper in the 2+ oxidation state (Cu(II)₃(PO₄)₂) such that the copper-containing salt in the 1+ oxidation state (e.g., Cu(I)₃PO₄) can be removed in a subsequent rinsing step Consequently, providing the nitrite salt in the molten salt solution can facilitate the production of glass articles with reduced and/or no copper-containing salt on the surface and/or low haze.

Providing a molten salt solution with a concentration of the sulfate salt, based on a total weight of the molten salt solution, can be in a range from 2.0 wt % to 10 wt %, from 2.5 wt % to 8 wt %, or from 3.0 wt % to 5 wt % can achieve a glass article (containing copper) that has a surface substantially free of copper-containing salt in accordance with the methods of the presence disclosure. The results shown in FIG. 14 demonstrate that providing 0.5 wt % or more (e.g., from greater than 0.5 wt % to 10 wt %, from 1.0 wt % to 5 wt %, or from 2.0 wt % to 5.0 wt %) of the nitrite salt reduces the amount of copper-containing salt on the surface (and/or the area of the surface covered by the copper-containing salt) at the end of chemical strengthening the glass article with the molten salt solution. The results shown in FIG. 15 demonstrate that providing greater than 0.5 wt % (e.g., from greater than 0.5 wt % to 10 wt %, from 1.0 wt % to 5.0 wt %, or 2.0 wt % to 5.0 wt %) of the nitrite salt can produce glass articles that are substantially free and/or free of copper-containing salt on the surface (and/or substantially none of the surface covered by the copper-containing salt) after rinsing following the chemical strengthening of the glass article with the molten salt solution.

Providing the sulfate salt can form copper sulfate that is more easily dissolved in the molten salt solution and/or subsequent rinsing. In aspects, as discussed above, during contact with the molten salt solution, a copper-containing salt can be formed at the surface of the glass article. As discussed above, copper ions in the 2+ oxidation state in the glass article can be reduced to the to the 1+ oxidation state followed by diffusion (e.g., ion exchange) of the copper ion in the 1+ oxidation state out of the glass article towards the molten salt solution while an alkali metal ion (e.g., sodium, potassium) diffuses into the glass article. At the first major surface of the glass article, the copper ion in the 1+ oxidation state can be oxidized by nitrate ions in the molten salt solution to form a CuO precipitate. It is believed that this reaction is largely irreversible in the molten salt solution, and CuO is insoluble in water, which makes it hard to remove CuO precipitates in a subsequent rinsing step. Alternatively, when the molten salt solution comprises a sulfate salt (e.g., producing sulfate ions), copper sulfate (CuSO₄) can be formed between the copper and sulfate ions. It is believed that copper sulfate is more readily dissolved in the molten salt solution and in a subsequent rinsing step than CuO such that the amount of copper-containing salt on the glass article can be reduced and/or removed (e.g., eliminated) after the chemical strengthening and/or after a subsequent rinsing step. Consequently, providing the sulfate salt in the molten salt solution can facilitate the production of glass articles with reduced and/or no copper-containing salt on the surface and/or low haze.

In aspects, subsequent rinsing of the chemically strengthened glass article can remove copper-containing salts formed in the chemical strengthening of the glass article when the molten salt solution comprises a nitrite salt and/or a sulfate salt. In further aspects, the first major surface of the glass article can be substantially free of the copper-containing salt after the rinsing (or even after the chemical strengthening in some aspects). Also, as discussed above, the reflectance haze of the first major surface (after the rinsing or even after the chemically strengthening in some aspects) can be within any of the corresponding ranges discussed above (e.g., 2% or less, from 0.01% to 2%, from 0.05% to 2%, from 0.1% to 1%, from 0.1% to 0.8%, from 0.2% to 0.5%, or any range or subrange therebetween). In further aspects, the rinsing can remove copper-containing salts with copper in the 1+ oxidation state and/or other salts (e.g., copper sulfate). For example, the copper oxide (CuO) with copper in the 2+ oxidation state (e.g., formed in the absence of a nitrite salt and/or a sulfate salt) is not dissolved or otherwise removed by the rinsing. Likewise, copper phosphate with copper in the 2+ oxidation state (e.g., Cu(II)₃(PO₄)₂) is not readily removed by rinsing. However, the complex including copper ions in the 1+ oxidation state (e.g., formed in the presence of a nitrite salt in the molten salt solution) can be dissolved and/or otherwise removed by the rinsing. Similarly, copper sulfate (e.g., CuSO₄) (e.g., formed in the presence of a sulfate salt) can be dissolved and/or otherwise removed by the rinsing.

Methods of the present disclosure can comprise chemically strengthening the copper-containing glass article with a molten salt solution including a salt of an alkaline earth metal (in addition to salts of alkali earth metals), which can reduce formation of copper-containing residue on the surface of the copper-containing glass article. Without wishing to be bound by theory, it is believed that the alkaline earth metal can be exchanged into a near-surface portion of the copper-containing glass article, where the alkaline earth metal can inhibit diffusion of copper therethrough. As demonstrated in the examples herein, an amount of the salt of the alkaline earth metal from 1.0 wt % to 8.0 wt % (e.g., from 2.0 wt % to 4.0 wt %) can significantly reduce or entirely eliminate the formation of copper-containing residues on the surface of the glass article that can be detected with the naked eye.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A method of chemically strengthening a substrate comprising:
contacting a surface of the substrate with a molten salt solution maintained at a temperature from about 350° C. to about 530° C. for a first period of time from about 10 minutes to about 8 hours, the molten salt solution comprises, based on a total weight of the molten salt solution, one or more of:
from greater than 0.5 wt % to 10 wt % of a nitrite salt;
from 2.0 wt % to 10 wt % of a sulfate salt; or
combinations thereof,
wherein the substrate comprises a glass-based material or a ceramic-based material, and the substrate comprises a copper concentration of about 0.01 wt % or more of 100 wt % of the substrate.

2. The method of claim 1, wherein the molten salt solution comprises from greater than 0.5 wt % to 10 wt % of the sulfate salt.

3. The method of claim 1, wherein the nitrite salt comprises an alkali metal nitrite.

4. The method of claim 1, wherein the nitrite salt comprises an alkaline earth metal nitrite.

5. The method of claim 1, wherein a concentration of the nitrite salt in the molten salt solution is from 1.0 wt % to 5 wt %.

6. The method of claim 2, wherein the contacting the surface of the substrate with the molten salt solution produces a copper-containing salt at the surface of the substrate, and the copper-containing salt has copper in a 1+ oxidation state.

7. The method of claim 1, wherein the molten salt solution comprises from 2.0 wt % to 10 wt % of the sulfate salt.

8. The method of claim 7, wherein the sulfate salt comprises an alkali metal sulfate.

9. The method of claim 8, wherein the contacting the surface of the substrate with the molten salt solution produces copper sulfate at the surface of the substrate.

10. The method of claim 1, wherein, after contacting the surface of the substrate with the molten salt solution, the substrate comprises a compressive stress region extending from the surface to a depth of compression, a maximum compressive stress of the compressive stress region is 400 MegaPascals or more.

11. The method of claim 1, wherein the molten salt solution comprises:
from 85 wt % to about 92 wt % of a potassium salt;
from 8 wt % to about 15 wt % of a sodium salt; and
from 0 wt % to about 1 wt % silicic acid,
wherein at least a portion of the potassium salt or the sodium salt comprises the nitrite salt or the sulfate salt.

12. The method of any one of claim 1, further comprising rinsing the substrate, wherein the rinsing removes a copper-containing salt at the surface of the substrate formed during the contacting the surface of the substrate with the molten salt solution.

13. The method of claim 1, wherein the substrate exhibits a CIE L* value of about 50 or more, an absolute value of a CIE a* value of the substrate is about 0.1 or more, and an absolute of the CIE b* value of the substrate is about 0.1 or more.

14. The method of claim 1, wherein the copper concentration in the substrate is from 0.03 wt % to 5.0 wt %.

15. A substrate comprising:
a thickness defined between a first major surface and a second major surface opposite the first major surface, the substrate comprises a glass-based material or a ceramic-based material, and the substrate comprises a copper concentration of about 0.01 wt % or more of 100 wt % of the substrate; and
a compressive stress region extending from the surface to a depth of compression, a maximum compressive stress of the compressive stress region is 400 MegaPascals or more,
wherein the first major surface of the substrate is substantially free of copper-containing salt.

16. A natively colored glass housing for an electronic device comprising:
the substrate of claim 15, the substrate comprises a substrate thickness from 10 micrometers to 5 millimeters;
circuitry comprising an antenna that transmits signals within a range of 26 GHz to 300 GHz;
the substrate at least partially surrounding the circuitry; and
a structure formed as an integral portion of the substrate, wherein the structure comprises a perimeter demarcating a second thickness of the structure that differs from the thickness of the substrate by at least 150 μm,
wherein the antenna is positioned and oriented such that the signals are transmitted through the structure of the substrate.

17. A method of chemically strengthening a substrate comprising:
contacting a surface of the substrate with a molten salt solution maintained at a temperature from 350° C. to 530° C. for a first period of time from 10 minutes to 8 hours, the molten salt solution comprises, based on a total weight of the molten salt solution, 1.0 wt % to 8.0 wt % of an alkaline earth metal salt, wherein the substrate comprises a glass-based material or a ceramic-based material, and the substrate comprises a copper concentration of about 0.01 wt % or more of 100 wt % of the substrate.

18. The method of claim 17, wherein the amount of the alkaline earth metal salt is from 2.0 wt % to 4.0 wt %.

19. The method of claim 17, wherein, after the contacting, a majority of the surface is substantially free of copper-containing salt.

20. The method of claim 17, wherein, after the contacting, a reflectance haze of the surface of the substrate is 2% or less.
